(19) United States
(12) Patent Application Publication
(10) Pub. No.: US 2012/0019803 A1
(43) Pub. Date: Jan. 26, 2012

(54) CLEANING METHOD, LIQUID IMMERSION MEMBER, IMMERSION EXPOSURE APPARATUS, DEVICE FABRICATING METHOD, PROGRAM, AND STORAGE MEDIUM

(75) Inventors: Tadashi HOSHINO, Ageo-shi (JP); Ryo TANAKA, Saitama-shi (JP)

(73) Assignee: NIKON CORPORATION, Tokyo (JP)

(21) Appl. No.: 13/184,251

(22) Filed: Jul. 15, 2011

Related U.S. Application Data
(60) Provisional application No. 61/367,044, filed on Jul. 23, 2010.

(51) Int. Cl. G03B 27/52

(52) U.S. Cl. 355/77; 355/18

(57) ABSTRACT

A liquid immersion member in an immersion exposure apparatus, which exposes a substrate with exposure light which transits an exposure liquid, has a first recovery port, which is capable of recovering the exposure liquid and that is disposed at least partly around an optical member and an optical path of the exposure light that passes through the exposure liquid between the optical member and the substrate. A cleaning method of cleaning the liquid immersion member comprises: supplying a cleaning liquid to a recovery passageway of the liquid immersion member, wherethrough the exposure liquid recovered via the first recovery port from a space, which the first recovery port faces, flows. The liquid immersion member has a first discharge port, which is for discharging the exposure liquid from the recovery passageway, and a second discharge port, which is for discharging a gas from the recovery passageway and hinders the discharge of the exposure liquid more than the first discharge port does.

### CROSS-REFERENCE TO RELATED APPLICATION

This application is a non-provisional application claiming priority to and the benefit of U.S. provisional application No, 61/367,044, filed Jul. 23, 2010. The entire contents of which are incorporated herein by reference.

### BACKGROUND

1. Field of the Invention

The present invention relates to a cleaning method, a liquid immersion member, an immersion exposure apparatus, a device fabricating method, a program, and a storage medium.

2. Description of Related Art

In the process of fabricating microdevices, such as semiconductor devices and electronic devices, using an immersion exposure apparatus that exposes a substrate with exposure light through an exposure liquid is known, as disclosed in, for example, U.S. Patent Application Publication No. 2008/0273181 and U.S. Patent Application Publication No. 2009/0195761.

### SUMMARY

In an immersion exposure apparatus, if a member that contacts the exposure liquid becomes contaminated, then, for example, exposure failures might occur and, as a result, defective devices might be produced. Consequently, it is preferable to satisfactorily clean any member that contacts the exposure liquid.

An object of the aspects of the present invention is to provide a cleaning method that can satisfactorily clean, for example, a member that contacts an exposure liquid. Another object of the aspects of the present invention is to provide both a liquid immersion member and an immersion exposure apparatus that can prevent exposure failures from occurring. Yet another object of the aspects of the present invention is to provide a device fabricating method, a program, and a storage medium that can prevent defective devices from being produced.

A first aspect of the present invention provides a method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, that method comprises: supplying a cleaning liquid to a recovery passageway of the liquid immersion member, wherethrough the exposure liquid recovered via the first recovery port from a space, which the first recovery port faces, flows; wherein, the liquid immersion member has a first discharge port, which is for discharging the exposure liquid from the recovery passageway, and a second discharge port, which is for discharging a gas from the recovery passageway and hinders the discharge of the exposure liquid more than the first discharge port does.

A second aspect of the present invention provides a method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, that method comprises: supplying a cleaning liquid to a recovery passageway of the liquid immersion member, wherethrough the exposure liquid recovered via the first recovery port from a space, which the first recovery port faces, flows; wherein, the liquid immersion member has a first discharge port, which is for discharging, from the recovery passageway, a fluid that includes the exposure liquid and that has a higher percentage of the exposure liquid than of a gas and a second discharge port, which is for discharging, from the recovery passageway, a fluid that includes the gas and that has a lower percentage of the exposure liquid than of the gas.

A third aspect of the present invention provides a method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, that method comprises: supplying a cleaning liquid to a recovery passageway of the liquid immersion member, wherethrough the exposure liquid recovered via the first recovery port from a space, which the first recovery port faces, flows; wherein, the liquid immersion member comprises a discharge part, which separately discharges the exposure liquid and a gas from the recovery passageway; and the discharge part has a first discharge port, which is for discharging the exposure liquid from the recovery passageway, and a second discharge port, which is for discharging the gas from the recovery passageway.

A fourth aspect of the present invention provides a device fabricating method that comprises: cleaning at least part of the liquid immersion member using the cleaning method according to any one aspect of the first through third aspects; exposing the substrate with the exposure light that transits the exposure liquid; and developing the exposed substrate.

A fifth aspect of the present invention provides a liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, that comprises: a first recovery port, which is capable of recovering the exposure liquid; a recovery passageway, wherethrough the exposure liquid recovered via the first recovery port from a space, which the first recovery port faces, flows; a first discharge port, which is for discharging the exposure liquid from the recovery passageway; a second discharge port, which is for discharging a gas from the recovery passageway and hinders the discharge of the exposure liquid more than the first discharge port does; and a supply port, which supplies a cleaning liquid to the recovery passageway.

A sixth aspect of the present invention provides a liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, that comprises: a first recovery port, which is capable of recovering the exposure liquid; a recovery passageway, wherethrough the exposure liquid recovered via the first recovery port from a space, which the first recovery port faces, flows; a first discharge port, which is for discharging, from the recovery passageway, a fluid that includes the exposure liquid and that has a higher percentage of the exposure liquid than of a gas; a second discharge port, which is for discharging, from the recovery passageway, a fluid that includes the gas and that has a lower percentage of the exposure liquid than of the gas; and a supply port, which supplies a cleaning liquid to the recovery passageway.

A seventh aspect of the present invention provides a liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, that comprises: a first recovery port, which is capable of recovering the exposure liquid; a recovery passageway, wherethrough the exposure liquid recovered via the first recovery port from a space, which the first recovery port faces, flows; a discharge part, which has a first discharge port for discharging the exposure liquid from the recovery passageway and a second discharge port for discharging a gas from the recovery passageway, that separately discharges the exposure liquid and the gas from the recovery passageway; and a supply port, which supplies a cleaning liquid to the recovery passageway.

An eighth aspect of the present invention provides an immersion exposure apparatus, which exposes a substrate with exposure light that transits an exposure liquid, that comprises: a liquid immersion member according to any one aspect of fifth through seventh aspects.

A ninth aspect of the present invention provides an immersion exposure apparatus, which exposes a substrate with exposure light that transits an exposure liquid, that comprises: an optical member, which has an emergent surface wherefrom the exposure light emerges; a liquid immersion member that is disposed at least partly around an optical path of the exposure light which passes through the exposure liquid between the optical member and the substrate and that has a first recovery port, which is capable of recovering the exposure liquid, a recovery passageway, wherethrough the exposure liquid recovered via the first recovery port from the space that the first recovery port faces flows, a first discharge port, which is for discharging the exposure liquid from the recovery passageway, and a second discharge port, which is for discharging a gas from the recovery passageway and hinders the discharge of the exposure liquid more than the first discharge port does; and a supply port, which supplies cleaning liquid to the recovery passageway.

A tenth aspect of the present invention provides an immersion exposure apparatus, which exposes a substrate with exposure light that transits an exposure liquid, that comprises: an optical member, which has an emergent surface wherefrom the exposure light emerges; a liquid immersion member that is disposed at least partly around an optical path of an exposure light which passes through the exposure liquid between the optical member and the substrate and that has a first recovery port, which is capable of recovering the exposure liquid, a recovery passageway, wherethrough the exposure liquid recovered via the first recovery port from the space that the first recovery port faces flows, a first discharge port, which is for discharging, from the recovery passageway, a fluid that includes the exposure liquid and that has a higher percentage of the exposure liquid than of the gas, and a second discharge port, which is for discharging, from the recovery passageway, a fluid that includes the gas and that has a lower percentage of the exposure liquid than of the gas; and a supply port, which supplies cleaning liquid to the recovery passageway.

An eleventh aspect of the present invention provides an immersion exposure apparatus, which exposes a substrate with exposure light that transits an exposure liquid, that comprises: an optical member, which has an emergent surface wherefrom the exposure light emerges; a liquid immersion member that is disposed at least partly around an optical path of an exposure light which passes through the exposure liquid between the optical member and the substrate and that has a first recovery port, which is capable of recovering the exposure liquid, a recovery passageway, wherethrough the exposure liquid recovered via the first recovery port from the space that the first recovery port faces flows, and a discharge part, which has a first discharge port for discharging the exposure liquid from the recovery passageway and a second discharge port for discharging a gas from the recovery passageway, that separately discharges the exposure liquid and the gas from the recovery passageway; and a supply port, which supplies cleaning liquid to the recovery passageway.

A twelfth aspect of the present invention provides a device fabricating method that comprises: exposing a substrate using an immersion exposure apparatus according to any one aspect of the eighth through eleventh aspects; and developing the exposed substrate.

A thirteenth aspect of the present invention provides a program that causes a computer to control an immersion exposure apparatus, which exposes a substrate with exposure light that transits an exposure liquid, and that comprises the steps of: forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, a first discharge port, which is for discharging the exposure liquid from the recovery passageway, and a second discharge port, which is for discharging a gas from the recovery passageway and hinders the discharge of the exposure liquid more than the first discharge port does, such that an optical path of the exposure light between the substrate and an optical member, wherefrom the exposure light can emerge, is filled with the exposure liquid; exposing the substrate with the exposure light, which transits the exposure liquid in the immersion space; recovering at least some of the exposure liquid from the space above the substrate via the first recovery port of the liquid immersion member; and when an exposure is not being performed, supplying a cleaning liquid to the recovery passageway.

A fourteenth aspect of the present invention provides a program that causes a computer to control an immersion exposure apparatus, which exposes a substrate with exposure light that transits an exposure liquid, and that comprises the steps of: forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, a first discharge port, which is for discharging, from the recovery passageway, a fluid that includes the exposure liquid and that has a higher percentage of the exposure liquid than of the gas, and a second discharge port, which is for discharging, from the recovery passageway, a fluid that includes the gas and that has a lower percentage of the exposure liquid than of the gas, such that an optical path of the exposure light between the substrate and an optical member, wherefrom the exposure light can emerge, is filled with the exposure liquid; exposing the substrate with the exposure light, which transits the exposure liquid in the immersion space; recovering at least some of the exposure liquid from the space above the substrate via the first recovery port of the liquid immersion member; and when an exposure is not being performed, supplying a cleaning liquid to the recovery passageway.

A fifteenth aspect of the present invention provides a program that causes a computer to control an immersion exposure apparatus, which exposes a substrate with exposure light that transits an exposure liquid, and that comprises the steps of: forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, and a discharge part, which has a first discharge port for discharging the exposure liquid from the recovery passageway and a second discharge port for discharging a gas from the recovery passageway, that separately discharges the exposure liquid and the gas from the recovery passageway, such that an optical path of the exposure light between the substrate and an optical member, wherefrom the exposure light can emerge, is filled with the exposure liquid; exposing the substrate with the exposure light, which transits the exposure liquid in the immersion space; recovering at least some of the exposure liquid from the space above the substrate via the first recovery port of the liquid immersion member; and when an exposure is not being performed, supplying a cleaning liquid to the recovery passageway.

A sixteenth aspect of the present invention provides a computer readable storage medium whereon the program according to any one aspect of the thirteenth through fifteenth aspects is stored.

According to the aspects of the present invention, any member that contacts an exposure liquid and the like can be cleaned satisfactorily. In addition, according to the aspects of the present invention, it is possible to prevent exposure failures from occurring and thereby to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 is a partial side cross sectional view of the liquid immersion member according to the first embodiment.

FIG. 4 is a schematic drawing for explaining one example of the operation of the liquid immersion member according to the first embodiment.

FIG. 5 is a schematic drawing for explaining one example of the operation of the liquid immersion member according to the first embodiment.

FIG. 6 is a flow chart for explaining one example of the operation of the exposure apparatus according to the first embodiment.

FIG. 7 is a flow chart for explaining one example of a cleaning sequence according to the first embodiment.

FIG. 8 is a diagram for explaining one example of the cleaning sequence according to the first embodiment.

FIG. 9 is a diagram for explaining one example of the cleaning sequence according to the first embodiment.

FIG. 10 is a partial side cross sectional view of the liquid immersion member according to the first embodiment.

FIG. 11 is a diagram that shows one example of the exposure apparatus according to a second embodiment.

FIG. 12 is a diagram that shows one example of the exposure apparatus according to a third embodiment.

FIG. 13 is a flow chart for explaining one example of the cleaning sequence according to the third embodiment.

FIG. 14 is a diagram for explaining one example of the cleaning sequence according to the third embodiment.

FIG. 15 is a diagram for explaining one example of the cleaning sequence according to a fourth embodiment.

FIG. 16 is a diagram for explaining one example of the cleaning sequence according to the fourth embodiment.

FIG. 17 is a diagram for explaining one example of the cleaning sequence according to the fourth embodiment.

FIG. 18 is a diagram for explaining one example of the cleaning sequence according to a fifth embodiment.

FIG. 19 is a diagram for explaining one example of the cleaning sequence according to a sixth embodiment.

FIG. 20 is a diagram for explaining one example of the cleaning sequence according to the sixth embodiment.

FIG. 21 is a diagram for explaining one example of the cleaning sequence according to a seventh embodiment.

FIG. 22 is a diagram for explaining one example of the cleaning sequence according to the seventh embodiment.

FIG. 23 is a diagram for explaining one example of the cleaning sequence according to the seventh embodiment.

FIG. 24 is a flow chart for explaining one example of a microdevice fabricating process.

FIG. 25 is a schematic drawing for explaining one example of a state which the liquid is discharged via the first discharge ports according to the first embodiment.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

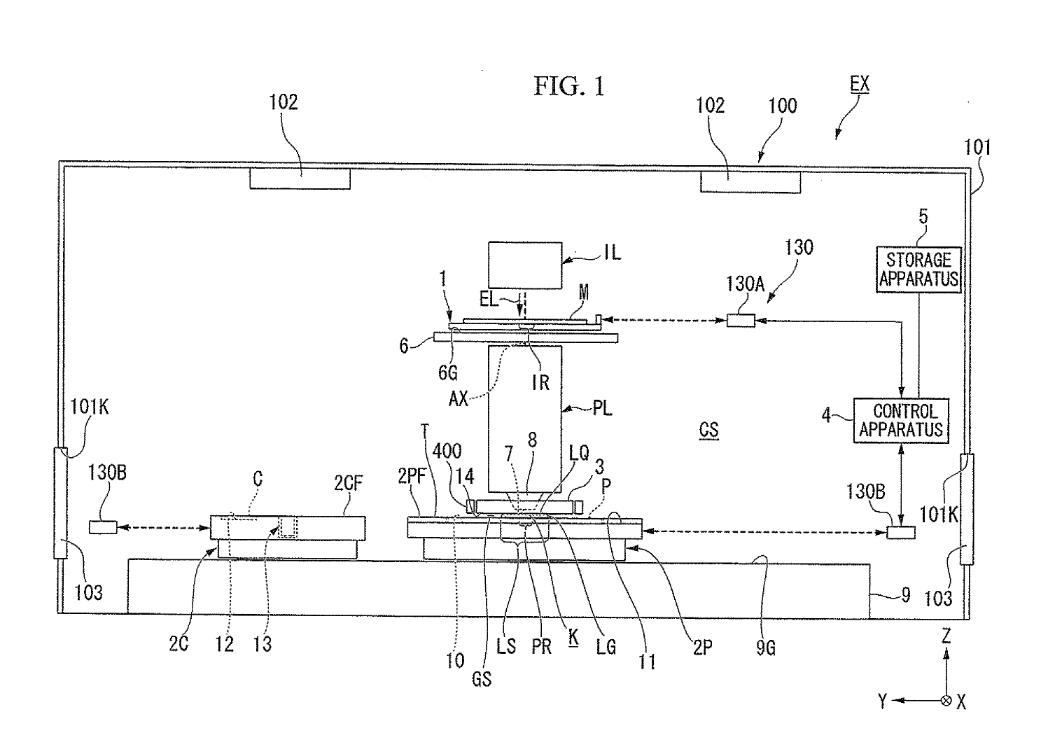

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that transits an exposure liquid LQ. In the present embodiment, an immersion space LS is formed so that at least part of an optical path K of the exposure light EL is filled with the exposure liquid LQ. An immersion space LS refers to a portion (i.e., a space or an area) that is filled with liquid LQ. The substrate P is exposed with the exposure light EL, which transits the exposure liquid LQ in the immersion space LS. In the present embodiment, water (pure water) is used as the exposure liquid LQ.

In addition, the exposure apparatus EX of the present embodiment comprises a substrate stage and a measurement stage as disclosed in, for example, U.S. Pat. No. 6,897,963 and European Patent Application Publication No. 1713113.

In FIG. 1, the exposure apparatus EX comprises: a movable mask stage 1 that holds a mask M; a movable substrate stage 2P that holds the substrate P; a movable measurement stage 2C that does not hold the substrate P and whereon a measuring member C (i.e., a measuring instrument) that measures the exposure light EL is mounted; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space LS by holding the exposure liquid LQ between itself and the substrate P such that the optical path K of the exposure light EL radiated to the substrate P is filled with the exposure liquid LQ; a recovery member 400, which is disposed at least partly around the liquid immersion member 3 and is capable of recovering the exposure liquid LQ; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

In addition, the exposure apparatus EX comprises: a chamber member 101, which forms an internal space CS wherein at least the projection optical system PL, the liquid immersion member 3, the recovery member 400, the substrate stage 2P, and the measurement stage 2C are disposed; and a chamber apparatus 100 that comprises air conditioning apparatuses 102, which adjust the environment (i.e., the temperature, the humidity, the pressure, and the cleanliness level) of the internal space CS, and open-close mechanisms 103, which open and close openings 101K that are formed in the chamber member 101.

The mask M may be a reticle on which a device pattern to be projected to the substrate P is formed. The mask M may be a transmissive mask comprising a transparent plate, such as a glass plate, and the pattern, which is formed on the transparent plate using a shielding material, such as chrome. Furthermore, a reflective mask can also be used as the mask M.

The substrate P is a substrate for fabricating devices. The substrate P comprises, for example, a base material, such as a semiconductor wafer, and a photosensitive film, which is formed on the base material. The photosensitive film comprises a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 6G of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions along the guide surface 6G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system. PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 7 wherefrom the exposure light EL emerges and travels toward an image plane of the projection optical system PL. The emergent surface 7 belongs to a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In the present embodiment, the emergent surface 7 faces the −Z direction and is parallel to the XY plane. Furthermore, the emergent surface 7, which faces the −Z direction, may be a convex or a concave surface. The optical axis of the last optical element 8 is parallel to the Z axis. In the present embodiment, the exposure light EL that emerges from the emergent surface 7 proceeds in the −Z direction.

In the state wherein it holds the substrate P, the substrate stage 2P is capable of moving on a guide surface 9G of a base member 9, which includes the projection area PR. In the state wherein the measuring member C (i.e., the measuring instrument) is mounted thereon, the measurement stage 2C is capable of moving on the guide surface 9G of the base member 9, which includes the projection area PR. The substrate stage 2P and the measurement stage 2C each move by the operation of a drive system, which comprises a planar motor as disclosed in, for example, U.S. Pat. No. 6,452,292. Each planar motor comprises a slider, which is disposed on the corresponding stage, namely, the substrate stage 2P or the measurement stage 2C, and a stator, which is disposed on the base member 9. In the present embodiment, the substrate stage 2P and the measurement stage 2C are each capable of moving in six directions on the guide surface 9G, namely, the X axial, Y axial, Z axial, θX, θY, and θZ directions, by the operation of its corresponding drive system. Furthermore, the drive systems that move the substrate stage 2P and the measurement stage 2C do not have to comprise planar motors. For example, the drive systems may comprise linear motors.

The substrate stage 2P comprises a substrate holding part 10, which releasably holds the substrate P. In the present embodiment, the front surface (i.e., the upper surface) of the substrate P held by the substrate holding part 10 and an upper surface 2PF of the substrate stage 2P disposed around the substrate P are disposed within the same plane (i.e., they are flush with one another). The upper surface 2PF is flat. In the present embodiment, the front surface (i.e., the upper surface) of the substrate P, which is held by the substrate holding part 10, and the upper surface 2PF of the substrate stage 2P are substantially parallel to the XY plane.

Furthermore, the upper surface 2PF of the substrate stage 2P and the front surface (i.e., the upper surface) of the substrate P held by the substrate holding part 10 do not have to be disposed within the same plane; furthermore, the front surface of the substrate P or the upper surface 2PF, or both, may be nonparallel to the XY plane. In addition, the upper surface 2PF does not have to be flat. For example, the upper surface 2PF may include a curved surface.

In the present embodiment, the substrate stage 2P comprises a cover member holding part 11, which releasably holds a cover member T, as disclosed in, for example, U.S. Patent Application Publication No. 2007/0177125 and U.S. Patent Application Publication No. 2008/0049209. In the present embodiment, the upper surface 2PF of the substrate stage 2P includes an upper surface of the cover member T held by the cover member holding part 11.

Furthermore, the cover member T does not have to be releasable. In such a case, the cover member holding part 11 could be omitted. In addition, the upper surface 2PF of the substrate stage 2P may include the front surface of any sensor, measuring member, or the like installed on the substrate stage 2P.

The measurement stage 2C comprises a measuring member holding part 12, which releasably holds the measuring member C. In the present embodiment, the front surface (i.e., the upper surface) of the measuring member C held by the measuring member holding part 12 and an upper surface 2CF of the measurement stage 2C disposed around the measuring member C are disposed within the same plane (i.e., they are flush with one another). The upper surface 2CF is flat. In the present embodiment, the front surface (i.e., the upper surface) of the measuring member C held by the measuring member holding part 12 and the upper surface 2CF of the measurement stage 2C are substantially parallel to the XY plane.

In the present embodiment, the measuring member C installed on the measurement stage 2C may be a member that constitutes part of, for example, an aerial image measuring system as disclosed in U.S. Patent Application Publication No. 2002/0041377 and the like, a luminous flux intensity nonuniformity measuring system as disclosed in U.S. Pat. No. 4,465,368 and the like, a fiducial member as disclosed in U.S. Pat. No. 5,493,403 and the like, an irradiance measuring system as disclosed in U.S. Patent Application Publication No. 2002/0061469 and the like, or a wavefront aberration measuring system as disclosed in European Patent No. 1079223 and the like.

Furthermore, the front surface (i.e., the upper surface) of the measuring member C held by the measuring member holding part 12 and the upper surface 2CF of the measurement stage 2C do not have to be disposed within the same plane; furthermore, the front surface of the measuring member C or the upper surface 2CF, or both, may be nonparallel to the XY plane. In addition, the upper surface 2CF does not have to be flat. For example, the upper surface 2CF may include a curved surface. In addition, the measuring member C does not have to be releasable. In this case, the measuring member holding part 12 could be omitted.

In the present embodiment, the measurement stage 2C comprises an ultrasonic wave generating apparatus 13, which is capable of generating ultrasonic vibration, as disclosed in, for example, U.S. Patent Application Publication No. 2009/0251672. The ultrasonic wave generating apparatus 13 comprises a rod member and an oscillator, which vibrates the rod member.

In the present embodiment, an interferometer system 130, which comprises laser interferometer units 130A, 130B, measures the positions of the mask stage 1, the substrate stage 2P, and the measurement stage 2C. The laser interferometer unit 130A is capable of measuring the position of the mask stage 1 using measurement mirrors, which are disposed on the mask stage 1. The laser interferometer unit 130B is capable of measuring the position of the substrate stage 2P using measurement mirrors, which are disposed on the substrate stage 2P. In addition, the laser interferometer unit 130B is capable of measuring the position of the measurement stage 2C using measurement mirrors, which are disposed on the measurement stage 2C. When an exposing process or a prescribed measurement process is performed on the substrate P, the control apparatus 4 controls, based on the measurement results of the interferometer system 130, the positions of the mask stage 1 (i.e., the mask M), the substrate stage 2P (i.e., the substrate P), or the measurement stage 2C (i.e., the measuring instrument C), or any combination thereof.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 radiates the exposure light EL to the substrate P through the projection optical system PL and the exposure liquid LQ in the immersion space LS above the substrate P while moving the substrate P in the Y axial directions with respect to the projection area PR of the projection optical system PL and moving the mask M, synchronized to the movement of the substrate P, in the Y axial direction with respect to the illumination area IR of the illumination system IL.

The liquid immersion member 3 forms the immersion space LS such that the optical path K of the exposure light EL radiated to the projection area PR is filled with the exposure liquid LQ. The liquid immersion member 3 forms the immersion space LS by holding the exposure liquid LQ between itself and an object such that the optical path K of the exposure light EL between the last optical element 8, wherefrom the exposure light EL can emerge, and the object, which is disposed at a position whereto the exposure light EL emerging from the emergent surface 7 of the last optical element 8 can be radiated, is filled with the exposure liquid LQ.

In the present embodiment, the position whereto the exposure light EL emerging from the emergent surface 7 can be radiated includes the projection area PR. In addition, the position whereto the exposure light EL that emerges from the emergent surface 7 can be radiated includes the position at which the object opposes the emergent surface 7. In the present embodiment, the object that is capable of being disposed at the position at which the object opposes the emergent surface 7, in other words, the object that is capable of being disposed in the projection area PR, may be the substrate stage 2P (i.e., the cover member T), the substrate P held by the substrate stage 2P (i.e., the substrate holding part 10), or the measurement stage 2C (i.e., the measuring member C and the ultrasonic wave generating apparatus 13), or any combination thereof. In the exposure of the substrate P, the liquid immersion member 3 forms the immersion space LS by holding the exposure liquid LQ between itself and the substrate P such that the optical path K of the exposure light EL radiated to the substrate P is filled with the exposure liquid LQ.

In the present embodiment, the liquid immersion member 3 is disposed at least partly around the last optical element 8 and the optical path K of the exposure light EL that passes through the exposure liquid LQ between the last optical element 8 and the object disposed in the projection area PR. In the present embodiment, the liquid immersion member 3 is annular. In the present embodiment, part of the liquid immersion member 3 is disposed around the last optical element 8 and part of the liquid immersion member 3 is disposed around the optical path K of the exposure light EL between the last optical element 8 and the object. The immersion space LS is formed such that the optical path K of the exposure light EL between the last optical element 8 and the object disposed in the projection area PR is filled with the exposure liquid LQ.

Furthermore, the liquid immersion member 3 does not have to be annular. For example, the liquid immersion member 3 may be disposed partly around the last optical element 8 and the optical path K. In addition, the liquid immersion member 3 does not have to be disposed at least partly around the last optical element 8. For example, the liquid immersion member 3 may be disposed at least partly around the optical path K between the emergent surface 7 and the object and not around the last optical element 8. In addition, the liquid immersion member 3 does not have to be disposed at least partly around the optical path K between the emergent surface 7 and the object. For example, the liquid immersion member 3 may be disposed at least partly around the last optical element 8 and not around the optical path K between the emergent surface 7 and the object.

The liquid immersion member 3 has a lower surface 14, which the front surface (i.e., the upper surface) of the object disposed in the projection area PR is capable of opposing. The lower surface 14 of the liquid immersion member 3 can hold the exposure liquid LQ between itself and the front surface of the object. In the present embodiment, some of the exposure liquid LQ in the immersion space LS is held between the last optical element 8 and the object disposed such that the object opposes the emergent surface 7 of the last optical element 8. In addition, some of the exposure liquid LQ in the immersion space LS is held between the liquid immersion member 3 and the object disposed such that the object opposes the lower surface 14 of the liquid immersion member 3. Holding the exposure liquid LQ between the emergent surface 7 and the lower surface 14 on one side and the front surface (i.e., the upper surface) of the object on the other side forms the immersion space LS such that the optical path K of the exposure light EL between the last optical element 8 and the object is filled with the exposure liquid LQ.

In the present embodiment, when the substrate P is being irradiated with the exposure light EL, the immersion space LS is formed such that part of the area of the front surface of the substrate P that includes the projection area PR is covered with the exposure liquid LQ. At least part of an interface LG (i.e., a meniscus or edge) of the exposure liquid LQ is formed between the lower surface 14 of the liquid immersion member 3 and the front surface of the substrate P. Namely, the exposure apparatus EX of the present embodiment adopts a local liquid immersion system. The outer side of the immersion space LS (i.e., the outer side of the interface LG) is a gas space GS.

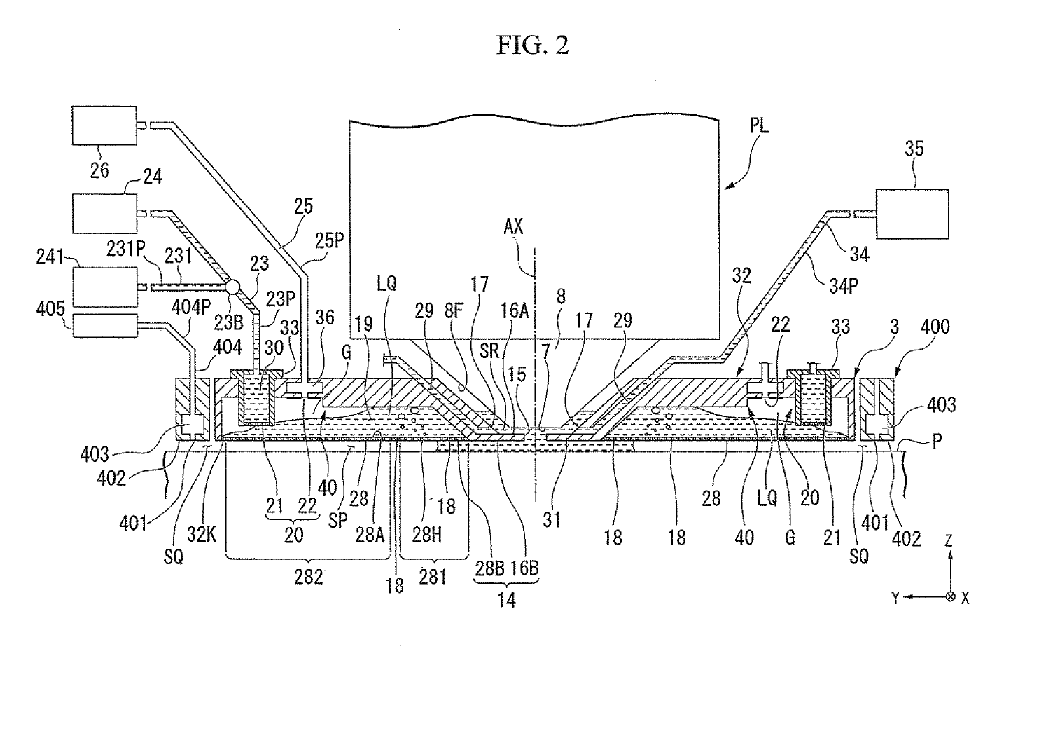

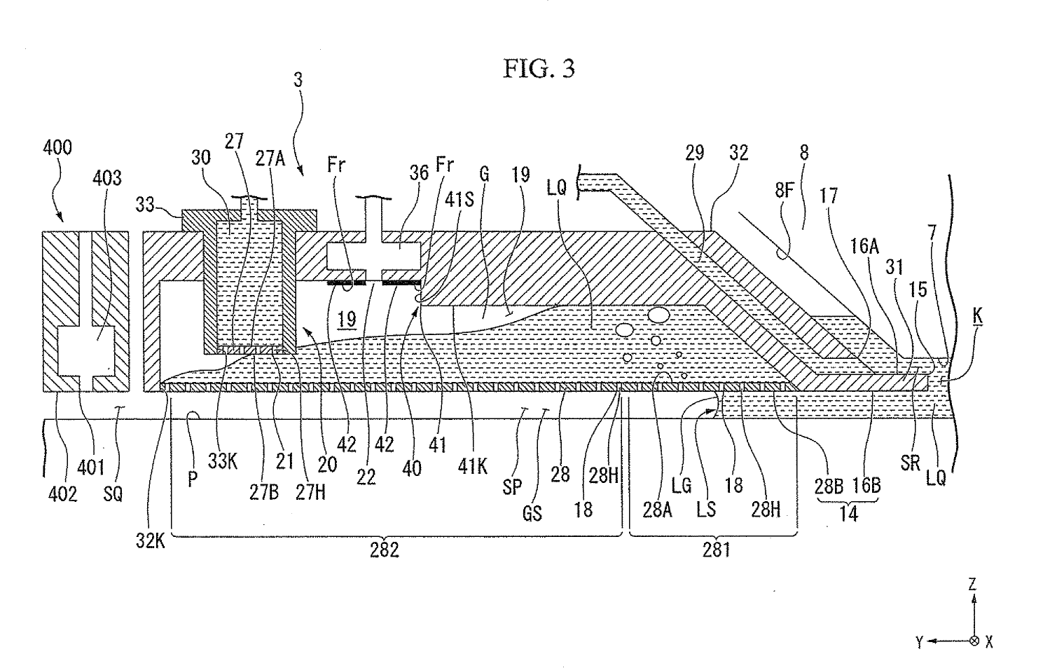

FIG. 2 is a side cross sectional view that shows one example of the liquid immersion member 3 and the recovery member 400 according to the present embodiment, and FIG. 3 shows a partial enlarged view of FIG. 2. The text below explains an exemplary case, referencing FIG. 2 and FIG. 3, wherein the substrate P is disposed in the projection area PR, but the substrate stage 2P (i.e., the cover member T) and the measurement stage 2C (i.e., the measuring member C and the ultrasonic wave generating apparatus 13) can also be disposed in the projection area PR as discussed above.

In the present embodiment, the liquid immersion member 3 comprises a plate part 31, at least part of which is disposed such that the plate part 31 opposes the emergent surface 7, a main body part 32, at least part of which is disposed such that the main body part 32 opposes a side surface 8F of the last optical element 8, and a passageway forming member 33. In the present embodiment, the plate part 31 and the main body part 32 are one body. In the present embodiment, the passageway forming member 33 is different from the plate part 31 and the main body part 32. In the present embodiment, the passageway forming member 33 is supported by the main body part 32. Furthermore, the passageway forming member 33, the plate part 31, and the main body part 32 may be one body. Furthermore, the passageway forming member 33 may be replaceable and may be capable of separating from the main body part 32.

Furthermore, the side surface 8F is disposed around the emergent surface 7. In the present embodiment, the side surface 8F is inclined upward toward the outer side in radial directions with respect to the optical path K. Furthermore, the radial directions with respect to the optical path K include the radial directions with respect to the optical axis AX of the projection optical system PL as well as the directions perpendicular to the Z axis.

The liquid immersion member 3 has an opening 15, which is formed at a position at which the opening 15 faces the emergent surface 7. The exposure light EL that emerges from the emergent surface 7 can be radiated through the opening 15 to the substrate P. In the present embodiment, the plate part 31 has an upper surface 16A, which opposes at least part of the emergent surface 7, and a lower surface 16B, which is capable of opposing the front surface of the substrate P. The opening 15 is a hole that is formed such that the opening 15 connects the upper surface 16A and the lower surface 16B. The upper surface 16A is disposed around an upper end of the opening 15 and the lower surface 16B is disposed around a lower end of the opening 15.

In the present embodiment, the upper surface 16A is flat. The upper surface 16A is substantially parallel to the XY plane. Furthermore, at least part of the upper surface 16A may be tilted with respect to the XY plane and may include a curved surface. In the present embodiment, the lower surface 16B is flat. The lower surface 16B is substantially parallel to the XY plane. Furthermore, at least part of the lower surface 16B may be tilted with respect to the XY plane and may include a curved surface. The lower surface 16B holds the exposure liquid LQ between itself and the front surface of the substrate P.

The liquid immersion member 3 has: supply ports 17, which are capable of supplying the exposure liquid LQ; recovery ports 18, which are capable of recovering the exposure liquid LQ; a recovery passageway 19, wherethrough the exposure liquid LQ recovered from the space SP, which the recovery ports 18 face, via the recovery ports 18 flows; and discharge parts 20, which separately discharge the exposure liquid LQ and a gas G from the recovery passageway 19.

The supply ports 17 are capable of supplying the exposure liquid LQ to the optical path K. In the present embodiment, the supply ports 17 supply the exposure liquid LQ to the optical path K during at least part of the exposure of the substrate P. The supply ports 17 are disposed in the vicinity of the optical path K such that they face the optical path K. In the present embodiment, the supply ports 17 supply the exposure liquid LQ to a space SR between the emergent surface 7 and the upper surface 16A. At least some of the exposure liquid LQ supplied to the space SR via the supply ports 17 is supplied to the space above the substrate P via the opening 15 as well as to the optical path K. Furthermore, at least part of at least one of the supply ports 17 may face the side surface 8F.

The liquid immersion member 3 comprises supply passageways 29, which are connected to the supply ports 17. At least part of each of the supply passageways 29 is formed inside the liquid immersion member 3. In the present embodiment, each of the supply ports 17 includes an opening, which is formed at one end of the corresponding supply passageway 29. The other end of each of the supply passageways 29 is connected to a liquid supply apparatus 35 via a passageway 34 formed by a piping member 34P.

The liquid supply apparatus 35 is capable of delivering the exposure liquid LQ, which is clean and temperature adjusted. The exposure liquid LQ that is delivered from the liquid supply apparatus 35 is supplied to the supply ports 17 via passageways 34 and the supply passageways 29. The supply ports 17 supply the exposure liquid LQ from the supply passageways 29 to the optical path K (i.e., the space SR).

The recovery ports 18 are capable of recovering at least some of the exposure liquid LQ from the space above the substrate P (i.e., the object). The recovery ports 18 recover at least some of the exposure liquid LQ from the space above the substrate P during the exposure of the substrate P. The recovery ports 18 face the −Z direction. The front surface of the substrate P faces the recovery ports 18 during at least part of the exposure of the substrate P.

In the present embodiment, the liquid immersion member 3 comprises a first member 28, which has the recovery ports 18. The first member 28 has: a first surface 28B; a second surface 28A, which faces a direction other than that faced by the first surface 28B; and a plurality of holes 28H, which connect the first surface 28B and the second surface 28A. In the present embodiment, the recovery ports 18 include the holes 28H of the first member 28. In the present embodiment, the first member 28 is a porous member that has the plurality of holes 28H (i.e., openings or pores). Furthermore, the first member 28 may be a mesh filter, which is a porous member wherein numerous small holes are formed as a mesh. Namely, a variety of members that have holes capable of recovering the exposure liquid LQ can serve as the first member 28.

At least part of the recovery passageway 19 is formed inside the liquid immersion member 3. In the present embodiment, an opening 32K is formed in a lower end of the recovery passageway 19. The opening 32K is disposed at least partly around the lower surface 16B. The opening 32K is formed at the lower end of the main body part 32. The opening 32K faces downward (i.e., the −Z direction). In the present embodiment, the first member 28 is disposed in the opening 32K. The recovery passageway 19 includes a space between the main body part 32 and the first member 28. The exposure liquid LQ recovered via the recovery ports 18 flows through the recovery passageway 19.

The first member 28 is disposed at least partly around the optical path K (i.e., the lower surface 16B). In the present embodiment, the first member 28 is disposed around the optical path K. Furthermore, the annular first member 28 may be disposed around the optical path K (i.e., the lower surface 16B) or a plurality of the first members 28 may be disposed such that the first members 28 are distributed around the optical path K (i.e., the lower surface 16B).

In the present embodiment, the first member 28 is a plate shaped member. The first surface 28B is one surface of the first member 28 and the second surface 28A is the other surface of the first member 28. In the present embodiment, the first surface 28B faces the space SP, which is on the lower side (i.e., the −Z side) of the liquid immersion member 3. The space SP includes, for example, the space between the lower surface 14 of the liquid immersion member 3 and the front surface of the object (i.e., the substrate P and the like) that opposes the lower surface 14 of the liquid immersion member 3. If the immersion space LS is formed above the object (i.e., the substrate P and the like) opposing the lower surface 14 of the liquid immersion member 3, then the space SP includes the immersion space LS (i.e., a liquid space) and the gas space GS. In the present embodiment, the first member 28 is disposed in the opening 32K such that the first surface 28B faces the space SP and the second surface 28A faces the recovery passageway 19. In the present embodiment, the first surface 28B and the second surface 28A are substantially parallel. The first member 28 is disposed in the opening 32K such that the first surface 28B faces the −Z direction and the second surface 28A faces the opposite direction (i.e., the +Z direction) to that faced by the first surface 28A. In addition, in the present embodiment, the first member 28 is disposed in the opening 32K such that the first surface 28B and the second surface 28A are substantially parallel to the XY plane.

In the explanation below, the first surface 28B is called the lower surface 28B where appropriate, and the second surface 28A is called the upper surface 28A where appropriate.

Furthermore, the first member 28 does not have to be plate shaped. In addition, the lower surface 28B and the upper surface 28A may be nonparallel. In addition, at least part of the lower surface 28B may be tilted with respect to the XY plane and may include a curved surface. In addition, at least part of the upper surface 28A may be tilted with respect to the XY plane and may include a curved surface.

The holes 28H are formed such that they connect the lower surface 28B and the upper surface 28A. The fluid (i.e., the fluid containing the gas G or the exposure liquid LQ, or both) is capable of passing through the holes 28H of the first member 28. In the present embodiment, the recovery ports 18 include the openings at the lower ends of the holes 28H on the lower surface 28B side. The lower surface 28B is disposed around the lower ends of the holes 28H, and the upper surface 28A is disposed around the upper ends of the holes 28H. The exposure liquid LQ recovered via the recovery ports 18 from the space SP, which the recovery ports 18 face, flows through the recovery passageway 19.

The recovery passageway 19 is connected to the holes 28H (i.e., the recovery ports 18) of the first member 28. The first member 28 recovers at least some of the liquid LQ from the space above the substrate P (i.e., the object) opposing the lower surface 28B via the holes 28H (i.e., the recovery ports 18). The exposure liquid LQ recovered via the holes 28H of the first member 28 flows through the recovery passageway 19.

In the present embodiment, the lower surface 14 of the liquid immersion member 3 includes the lower surface 16B and the lower surface 28B. In the present embodiment, the lower surface 28B is disposed at least partly around the lower surface 16B. In the present embodiment, the annular lower surface 28B is disposed around the lower surface 16B. Furthermore, a plurality of the lower surfaces 28B may be disposed such that the lower surfaces 28B are distributed around the lower surface 16B (i.e., the optical path K).

In the present embodiment, the first member 28 comprises a first portion 281 and a second portion 282. In the present embodiment, the second portion 282 is disposed on the outer side of the first portion 281 in radial directions with respect to the optical path K. In the present embodiment, the second portion 282 hinders the flow of the gas G from the space SP into the recovery passageway 19 via the holes 28H more than the first portion 281 does.

In the present embodiment, the inflow resistance of the gas G from the space SP into the recovery passageway 19 via the holes 28H is greater at the second portion 282 than at the first portion 281.

The first portion 281 and the second portion 282 each have a plurality of the holes 28H. For example, in the state wherein the immersion space LS is being formed in the space SP, some of the holes 28H among the plurality of the holes 28H of the first portion 281 might contact the exposure liquid LQ in the immersion space LS and some might not. In addition, some of the holes 28H among the plurality of the holes 28H of the second portion 282 might contact the exposure liquid LQ in the immersion space LS and some might not.

In the present embodiment, the first portion 281 is capable of recovering the exposure liquid LQ to the recovery passageway 19 via the holes 28H that contact the exposure liquid LQ in the space SP (i.e., the exposure liquid LQ in the space above the substrate P). In addition, the first portion 281 suctions the gas G into the recovery passageway 19 via the holes 28H that do not contact the exposure liquid LQ.

Namely, the first portion 281 is capable of recovering the exposure liquid LQ from the immersion space LS to the recovery passageway 19 via the holes 28H that face the immersion space LS, and the first portion 281 suctions the gas G into the recovery passageway 19 via the holes 28H that face the gas space GS, which is disposed on the outer side of the immersion space LS.

In other words, the first portion 281 is capable of recovering the exposure liquid LQ from the immersion space LS to the recovery passageway 19 via the holes 28H that face the immersion space LS, and the first portion 281 suctions the gas G into the recovery passageway 19 via the holes 28H that do not face the immersion space LS.

Namely, if the interface LG of the exposure liquid LQ in the immersion space LS is present between the first portion 281 and the substrate P, then the first portion 281 recovers to the recovery passageway 19 the exposure liquid LQ together with the gas G. Furthermore, at the interface LG, both the exposure liquid LQ and the gas G may be suctioned via the holes 28H that face both the immersion space LS and the gas space GS.

The second portion 282 is capable of recovering the exposure liquid LQ to the recovery passageway 19 via the holes 28H that contact the exposure liquid LQ in the space SP (i.e., the exposure liquid LQ in the space above the substrate P). In addition, the second portion 282 hinders the flow of the gas G into the recovery passageway 19 via the holes 28H that do not contact the exposure liquid LQ.

Namely, the second portion 282 is capable of recovering the exposure liquid LQ from the immersion space LS to the recovery passageway 19 via the holes 28H that face the immersion space LS, and the second portion 282 hinders the flow of the gas G into the recovery passageway 19 via the holes 28H that face the gas space GS, which is disposed on the outer side of the immersion space LS.

In the present embodiment, the second portion 282 recovers substantially only the exposure liquid LQ, and not the gas G, to the recovery passageway 19.

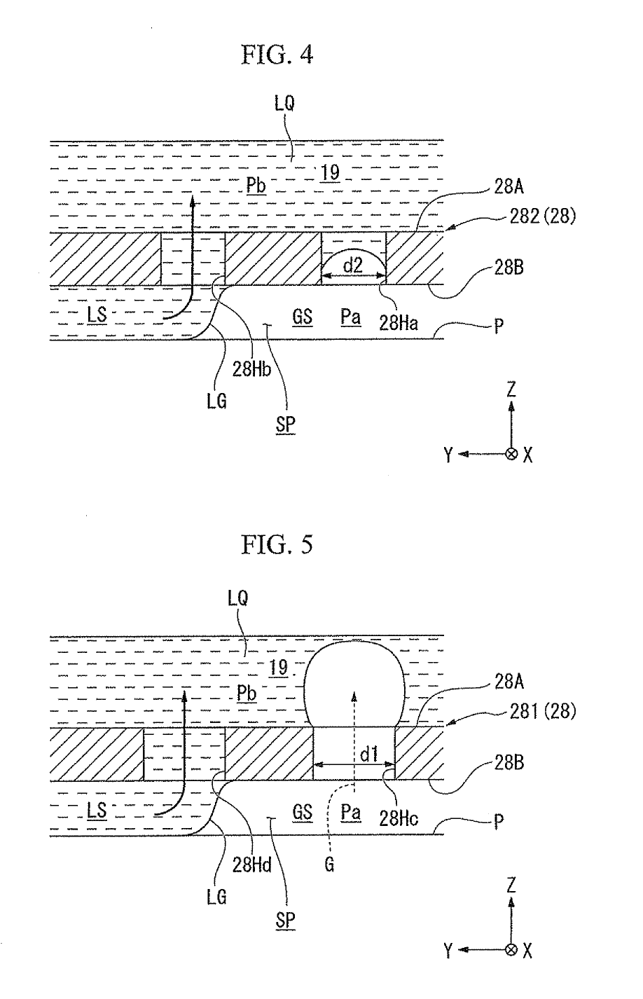

FIG. 4 is a partial enlarged cross sectional view of the second portion 282 of the first member 28 and serves as a schematic drawing for explaining one example of the state wherein the second portion 282 is recovering only the exposure liquid LQ.

In FIG. 4, there is a difference between a pressure Pa in the space SP (i.e., the gas space GS) and a pressure Pb in the recovery passageway 19. In the present embodiment, the pressure Pb in the recovery passageway 19 is lower than the pressure Pa in the space SP. When the exposure liquid LQ is being recovered from the space above the substrate P (i.e., the object) via the first member 28, the exposure liquid LQ is recovered from the space above the substrate P to the recovery passageway 19 via a hole 28Hb of the second portion 282, and the flow of the gas G into the recovery passageway 19 via a hole 28Ha of the second portion 282 is hindered.

In FIG. 4, the immersion space LS (i.e., the liquid space) and the gas space GS are formed in the space SP between the lower surface 28B of the second portion 282 and the front surface of the substrate P. In FIG. 4, the space that the lower end of the hole 28Ha of the second portion 282 faces is the gas space GS, and the space that the lower end of the hole 28Hb of the second portion 282 faces is the immersion space LS (i.e., the liquid space). In addition, in FIG. 4, the exposure liquid LQ in the recovery passageway 19 (i.e., a liquid space) is present on the upper side of the second portion 282.

In the present embodiment, the exposure liquid LQ is recovered from the space above the substrate P to the recovery passageway 19 via the hole 28Hb of the second portion 282, which contacts the exposure liquid LQ, and the flow of the gas G into the recovery passageway 19 via the hole 28Ha of the second portion 282, which does not contact the exposure liquid LQ, is hindered.

In FIG. 4, the condition below is satisfied.

(4×γ×cos θ2)/d2≧(Pb−Pa) (1)

Therein, Pa is the pressure in the gas space GS that the lower end of the hole 28Ha faces (i.e., the pressure on the lower surface 28B side), Pb is the pressure in the recovery passageway 19 (i.e., liquid space) on the upper side of the first member 28 (i.e., the pressure on the upper surface 28A side), d2 is the dimension (i.e., the pore size or diameter) of each of the holes 28Ha, 28Hb, θ2 is the contact angle of the exposure liquid LQ with respect to the surface (i.e., the inner surface) of each of the holes 28H of the second portion 282, and γ is the surface tension of the exposure liquid LQ. Furthermore, to simplify the explanation, the condition expressed in the abovementioned equation (1) does not take the hydrostatic pressure of the exposure liquid LQ on the upper side of the first member 28 into consideration.

Furthermore, in the present embodiment, the dimension d2 of each of the holes 28H of the second portion 282 indicates the minimum value thereof of all of the holes 28H between the upper surface 28A and the lower surface 28B. Furthermore, the dimension d2 does not have to be the minimum dimension of all of the holes 28H between the upper surface 28A and the lower surface 28B, and may be, for example, the average value or the maximum value thereof.

In this case, the contact angle θ2 of the exposure liquid LQ with respect to the surface of each of the holes 28H of the second portion 282 satisfies the condition below.

θ2≦90° (2)

If the above condition holds, then, even if the gas space GS is formed on the lower side (i.e., on the space SP side) of the hole 28Ha of the first member 28, the gas G in the gas space GS on the lower side of the first member 28 is hindered from moving to (i.e., flowing into) the recovery passageway 19 (i.e., the liquid space) on the upper side of the first member 28 via the hole 28Ha. Namely, if the dimension d2 (i.e., the pore size or diameter) of each of the holes 28H of the second portion 282, the contact angle θ2 (i.e., the affinity) of the exposure liquid LQ with respect to the surface of each of the holes 28H of the second portion 282, the surface tension γ of the exposure liquid LQ, and the pressures Pa, Pb satisfy the above condition, then the interface between the exposure liquid LQ and the gas G is kept on the inner side of the hole 28Ha and the flow of the gas G from the space SP into the recovery passageway 19 via the hole 28Ha of the second portion 282 is hindered. Moreover, because the immersion space LS (i.e., the liquid space) is formed on the lower side (i.e., on the space SP side) of the hole 28Hb, only the exposure liquid LQ is recovered via the hole 28Hb.

In the present embodiment, the above condition is satisfied for all of the holes 28H of the second portion 282, and substantially only the exposure liquid LQ is recovered via the holes 28H of the second portion 282.

In the explanation below, the state wherein only the exposure liquid LQ is recovered via the holes of the porous member is called a liquid selective recovery state where appropriate, and the condition wherein only the exposure liquid LQ is recovered via the holes of the porous member is called a liquid selective recovery condition.

FIG. 5 is a partial enlarged cross sectional view of the first portion 281 of the first member 28 and serves as a schematic drawing for explaining one example of the state wherein the first portion 281 is recovering the exposure liquid LQ and the gas G.

In FIG. 5, there is a difference between the pressure Pa in the space SP (i.e., the gas space GS) and the pressure Pb in the recovery passageway 19. In the present embodiment, the pressure Pb in the recovery passageway 19 is lower than the pressure Pa in the space SP. When the exposure liquid LQ is being recovered from the space above the substrate P (i.e., the object) via the first member 28, the gas G is suctioned into the recovery passageway 19 via a hole 28Hc in the first portion 281.

In FIG. 5, the immersion space LS (i.e., the liquid space) and the gas space GS are formed in the space SP. In FIG. 5, the space that the lower end of the hole 28Hc of the first portion 281 faces is the gas space GS, and the space that the lower end of a hole 28Hd of the first portion 281 faces is the immersion space LS (i.e., the liquid space). In addition, in FIG. 5, the exposure liquid LQ in the recovery passageway 19 (i.e., the liquid space) is present on the upper side of the first portion 281.

In the present embodiment, the exposure liquid LQ is recovered from the space above the substrate P to the recovery passageway 19 via the hole 28Hd of the first portion 281, which contacts the exposure liquid LQ, and the gas G is suctioned into the recovery passageway 19 via the hole 28Hc of the first portion 281, which does not contact the exposure liquid LQ.

In the present embodiment, the dimension (i.e., the pore size or diameter) of each of the holes 28H or the contact angle of the exposure liquid LQ with respect to the surface (i.e., the inner surface) of each of the holes 28H, or both, is different at the first portion 281 than it is at the second portion 282. Owing to the difference between the pressure Pa in the space SP (i.e., the gas space GS) and the pressure Pb in the recovery passageway 19, the exposure liquid LQ is recovered from the space above the substrate P to the recovery passageway 19 via the hole 28Hd of the first portion 281, which contacts the exposure liquid LQ, and the gas G is suctioned into the recovery passageway 19 via the hole 28Hc of the first portion 281, which does not contact the exposure liquid LQ.

Furthermore, in the present embodiment, a dimension d1 of each of the holes 28H of the first portion 281 indicates the minimum value thereof of all of the holes 28H between the upper surface 28A and the lower surface 28B. Furthermore, the dimension d1 does not have to be the minimum dimension of all of the holes 28H between the upper surface 28A and the lower surface 28B, and may be, for example, the average value or the maximum value thereof.

In the present embodiment, the surface of each of the holes 28H of the second portion 282 is more lyophilic with respect to the exposure liquid LQ than the surface of each of the holes 28H of the first portion 281 is. Namely, the contact angle θ₂ of the exposure liquid LQ with respect to the surface (i.e., the inner surface) of each of the holes 28H of the second portion 282 is smaller than a contact angle θ1 of the exposure liquid LQ with respect to the surface (i.e., the inner surface) of each of the holes 28H of the first portion 281. Thereby, the first portion 281 recovers the exposure liquid LQ together with the gas G and the second portion 282 recovers the exposure liquid LQ while hindering the flow of the gas G into the recovery passageway 19.

In the present embodiment, the contact angle θ2 of the exposure liquid LQ with respect to the surface of each of the holes 28H of the second portion 282 is less than 90°, For example, the contact angle θ2 of the exposure liquid LQ with respect to the surface of each of the holes 28H of the second portion 282 may be less than 50°, less than 40°, less than 30°, or less than 20°.

Furthermore, the dimension d1 of each of the holes 28H of the first portion 281 may be different from the dimension d2 of each of the holes 28H of the second portion 282. For example, by making the dimension d2 of each of the holes 28H of the second portion 282 smaller than the dimension d1 of each of the holes 28H of the first portion 281, the first portion 281 recovers the exposure liquid LQ together with the gas G, and the second portion 282 recovers the exposure liquid LQ while hindering the flow of the gas G into the recovery passageway 19.

The text below explains the discharge parts 20, referencing FIG. 2 and FIG. 3. Each of the discharge parts 20 has first discharge ports 21, which face the recovery passageway 19 and are for discharging the exposure liquid LQ from the recovery passageway 19, and a second discharge port 22, which faces the recovery passageway 19 and is for discharging the gas G from the recovery passageway 19.

In the present embodiment, the first discharge ports 21 are disposed above (i.e., in the +Z direction of) the recovery ports 18 such that the first discharge ports 21 face the recovery passageway 19. The second discharge ports 22 are disposed above (i.e., in the +Z direction of) the recovery ports 18 such that the second discharge ports 22 face the recovery passageway 19.

In the present embodiment, the first discharge ports 21 or the second discharge ports 22, or both, face downward (i.e., in the −Z direction). In the present embodiment, the first discharge ports 21 and the second discharge ports 22 each face downward.

In the present embodiment, the first discharge ports 21 are disposed on the outer side of the second discharge ports 22 in radial directions with respect to the optical path K. Namely, in the present embodiment, the first discharge ports 21 are farther from the optical path K than the second discharge ports 22 are.

In the present embodiment, at least part of at least one of the first discharge ports 21 opposes the upper surface 28A of the second portion 282 of the first member 28. In the present embodiment, all of each of the first discharge ports 21 opposes the upper surface 28A of the second portion 282. The first discharge ports 21, which oppose the first member 28, oppose the recovery ports 18.

In the present embodiment, at least some of and at least one of the second discharge ports 22 oppose the upper surface 28A of the second portion 282 of the first member 28. In the present embodiment, all of the second discharge ports 22 oppose the upper surface 28A of the second portion 282. The second discharge ports 22, which oppose the first member 28, oppose the recovery ports 18.

In the present embodiment, the first discharge ports 21 are disposed below the second discharge ports 22.

In addition, in the present embodiment, the second discharge ports 22 are disposed more spaced apart from the upper surface 28A of the first member 28 than the first discharge ports 21 are.

In addition, in the present embodiment, at least part of the second portion 282 is disposed on the outer side of the first discharge ports 21 and the second discharge ports 22 in the radial directions with respect to the optical path K. Namely, in the present embodiment, at least part of the second portion 282 is farther from the optical path K than the first discharge ports 21 and the second discharge ports 22 are. In the example shown in FIG. 2 and FIG. 3, an outer edge of the second portion 282 is disposed on the outer side of the first discharge ports 21 and the second discharge ports 22 in the radial directions with respect to the optical path K.

In addition, in the present embodiment, at least part of the first portion 281 of the first member 28 is disposed on the inner side of the first discharge ports 21 and the second discharge ports 22 in the radial directions with respect to the optical path K. Namely, in the present embodiment, at least part of the first portion 281 is closer to the optical path K than the first discharge ports 21 and the second discharge ports 22 are. In the example shown in FIG. 2 and FIG. 3, substantially the entire first portion 281 is disposed on the inner side of the first discharge ports 21 and the second discharge ports 22 in the radial directions with respect to the optical path K.

As discussed above, the first member 28 (i.e., the first portion 281) recovers the exposure liquid LQ together with the gas G from the space SP to the recovery passageway 19. The exposure liquid LQ and the gas G in the space SP between the substrate P and the first member 28 flow to the recovery passageway 19 via the first member 28. As shown in FIG. 2 and FIG. 3, a gas space and the liquid space are formed in the recovery passageway 19. The first discharge ports 21 discharge the exposure liquid LQ from the recovery passageway 19, and the second discharge ports 22 discharge the gas G from the recovery passageway 19.

In the present embodiment, the first discharge ports 21 hinder the inflow of the gas G more than the second discharge ports 22 do. The second discharge ports 22 hinder the discharge of the exposure liquid LQ more than the first discharge ports 21 do. In other words, the second discharge ports 22 hinder the inflow of the exposure liquid LQ more than the first discharge ports 21 do.

In the present embodiment, the first discharge ports 21 discharge the fluid, which includes the exposure liquid LQ and wherein the percentage of the exposure liquid LQ is higher than the percentage of the gas G, from the recovery passageway 19. The second discharge ports 22 discharge the fluid, which includes the gas G and wherein the percentage of the exposure liquid LQ is lower than the percentage of the gas G, from the recovery passageway 19. Namely, in the present embodiment, the percentage of the exposure liquid LQ in the fluid discharged via the first discharge ports 21 is higher than the percentage of the exposure liquid LQ in the fluid discharged via the second discharge ports 22. In the present embodiment, the percentage of the gas G in the fluid discharged via the first discharge ports 21 is lower than the percentage of the gas G in the fluid discharged via the second discharge ports 22.

In the present embodiment, the first discharge ports 21 discharge substantially only the exposure liquid LQ from the recovery passageway 19. The second discharge ports 22 discharge substantially only the gas G from the recovery passageway 19.

In the present embodiment, the liquid immersion member 3 comprises second members 27, which have the first discharge ports 21. Each of the second members 27 has: a third surface 27B, which faces the recovery passageway 19; a fourth surface 27A, which faces a direction other than that faced by the third surface 27B; and multiple holes 27H, which connect the third surface 27B and the fourth surface 27A. In the present embodiment, the first discharge ports 21 include the holes 27H of the second members 27. In the present embodiment, each of the second members 27 is a porous member that has the multiple holes 27H. Furthermore, each of the second members 27 may be a mesh filter, which is a porous member wherein numerous small holes are formed as a mesh. Namely, a variety of members that have holes capable of hindering the inflow of the gas G can serve as each of the second members 27.

In the present embodiment, openings 33K are formed at the lower end of the passageway forming member 33. The openings 33K face downward (i.e., the −Z direction). In the present embodiment, the second members 27 are disposed in the openings 33K.

In the present embodiment, the second members 27 are plate shaped members. Each of the third surfaces 27B is one surface of the corresponding second member 27, and each of the fourth surfaces 27A is the other surface of the corresponding second member 27. In the present embodiment, the second members 27 are disposed in the openings 33K such that the third surfaces 27B face the recovery passageway 19 and the fourth surfaces 27A face the passageways 30 of the passageway forming member 33. In the present embodiment, the third surfaces 27B and the fourth surfaces 27A are substantially parallel. The second members 27 are disposed in the openings 33K such that the fourth surfaces 27A face the +Z direction and the third surfaces 27B face the opposite direction (i.e., the −Z direction) to that faced by the fourth surfaces 27A. In addition, in the present embodiment, the second members 27 are disposed in the openings 33K such that the third surfaces 27B and the fourth surfaces 27A are substantially parallel to the XY plane.

In the explanation below, the third surfaces 27B are called the lower surfaces 27B where appropriate, and the fourth surfaces 27A are called the upper surfaces 27A where appropriate.

Furthermore, the second members 27 do not have to be plate shaped members. In addition, the lower surfaces 27B and the upper surfaces 27A may be nonparallel. In addition, at least part of each of the lower surfaces 27B may be tilted with respect to the XY plane and may include a curved surface. In addition, at least part of each of the upper surfaces 27A may be tilted with respect to the XY plane and may include a curved surface.

The holes 27H are disposed such that they connect each of the lower surfaces 27B to the corresponding upper surface 27A. The fluid (i.e., the fluid containing the exposure liquid LQ or the gas G, or both) can flow through the holes 27H of the second members 27. In the present embodiment, each of the first discharge ports 21 is disposed at the lower ends of the holes 27H on the corresponding lower surface 27B side. In other words, the first discharge ports 21 are the openings at the lower ends of the holes 27H. Each of the lower surfaces 27B is disposed around the lower ends of the corresponding holes 27H, and each of the upper surfaces 27A is disposed around the upper ends of the corresponding holes 27H.

Each of the passageways 30 are connected to the holes 27H (i.e., the first discharge ports 21) of the corresponding second member 27. The second members 27 discharge at least some of the exposure liquid LQ from the recovery passageway 19 via the holes 27H (i.e., the first discharge ports 21). The exposure liquid LQ discharged via the holes 27H of the second members 27 flows through the passageways 30.

In the present embodiment, the pressure differential between the recovery passageway 19 that the lower surfaces 27B face and the passageways 30 (i.e., the spaces) that the upper surfaces 27A face is adjusted such that the discharge of the gas G via the first discharge ports 21 is hindered.

In the present embodiment, the second members 27 discharge substantially only the exposure liquid LQ, and not the gas G to the passageways 30.

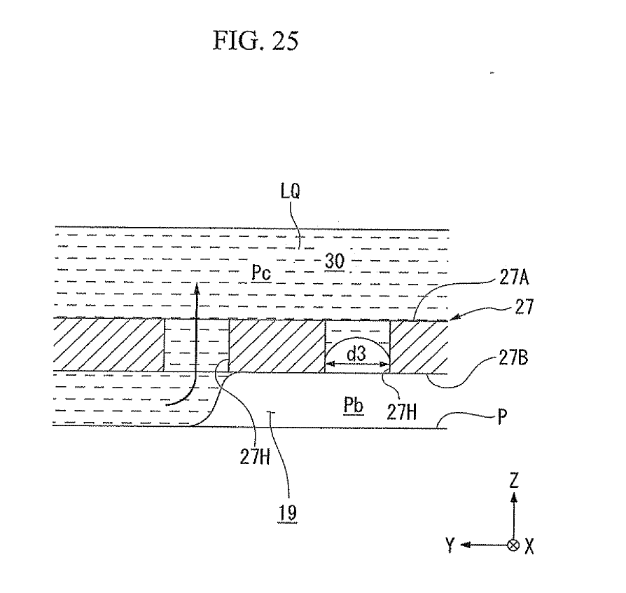

In the present embodiment, the recovery condition (i.e., the discharge condition) of the exposure liquid LQ via the holes 27H of the second members 27 satisfies the liquid selective recovery condition, as explained referencing FIG. 4 and the like. Namely, as shown in FIG. 25, by making a dimension d3 (i.e., the pore size or diameter) of each of the holes 27H of the second members 27, a contact angle θ3 (i.e., the affinity) of the exposure liquid LQ with respect to the surface of each of the holes 27H of the second members 27, the surface tension γ of the exposure liquid LQ, the pressure Pb in the recovery passageway 19 that the lower surfaces 27B face, and a pressure Pc in the passageways 30 that the upper surfaces 27A face satisfy the liquid selective recovery condition, the interface between the exposure liquid LQ and the gas G is kept on the inner side of the holes 27H and the flow of the gas G from the recovery passageway 19 into the passageways 30 via the holes 27H of the second members 27 is hindered. Thereby, the second members 27 (i.e., the first discharge ports 21) can discharge substantially only the exposure liquid LQ.

In the present embodiment, the difference between the pressure Pb in the recovery passageway 19 and the pressure Pc in the passageways 30 is adjusted such that the recovery condition (i.e., the discharge condition) of the exposure liquid LQ via the holes 27H of the second members 27 is the liquid selective recovery condition. The pressure Pc is lower than the pressure Pb. Namely, the difference between the pressure Pb in the recovery passageway 19 and the pressure Pc in the passageways 30 is prescribed such that the exposure liquid LQ is discharged from the recovery passageway 19 to the passageways 30 via the holes 27H of the second members 27 and the gas G is hindered from flowing into the passageways 30 via the holes 27H of the second members 27. By adjusting the pressure Pb or the pressure Pc, or both, the second members 27 discharge substantially only the exposure liquid LQ, and not the gas G, to the passageways 30 via the holes 27H.

In the present embodiment, at least part of the surface of each of the second members 27 is lyophilic with respect to the exposure liquid LQ. In the present embodiment, at least the surfaces (i.e., the inner surfaces) of the holes 27H of the second members 27 are lyophilic with respect to the exposure liquid LQ. In the present embodiment, the contact angle of the exposure liquid LQ with respect to the surface of each of the holes 27H is less than 90°. Furthermore, the contact angle of the exposure liquid LQ with respect to the surface of each of the holes 27H may be less than 50°, less than 40°, less than 30°, or less than 20°.

In the present embodiment, the liquid immersion member 3 comprises a hindering part 40, which is disposed in the recovery passageway 19 and hinders the exposure liquid LQ in the recovery passageway 19 from contacting the second discharge ports 22. The hindering part 40 is provided in the recovery passageway 19 such that the second discharge ports 22 are disposed in the gas space of the recovery passageway 19. Namely, the hindering part 40 is provided in the recovery passageway 19 such that the peripheral space of each of the second discharge ports 22 in the recovery passageway 19 is the gas space. For example, the hindering part 40 adjusts the interface (i.e., the surface) of the liquid space in the recovery passageway 19 such that the exposure liquid LQ does not contact the second discharge ports 22. Thereby, the second discharge ports 22 disposed in the gas space discharge substantially only the gas G from the recovery passageway 19.

In the present embodiment, the hindering part 40 comprises a projection 41, which is disposed at least partly around the second discharge ports 22. The projection 41 is provided inside the recovery passageway 19 such that the second discharge ports 22 are disposed in the gas space in the recovery passageway 19. The projection 41 limits the movement of the interface of the liquid space in the recovery passageway 19 such that the second discharge ports 22 are disposed in the gas space in the recovery passageway 19. Namely, the projection 41 hinders the interface of the liquid space in the recovery passageway 19 from approaching the second discharge ports 22.

In addition, in the present embodiment, the hindering part 40 comprises a liquid repellent part 42, which is disposed inside the recovery passageway 19 at least partly around the second discharge ports 22 and whose surface is liquid repellent with respect to the exposure liquid LQ. The liquid repellent part 42 hinders contact between the second discharge ports 22 and the exposure liquid LQ in the recovery passageway 19. The liquid repellent part 42 is provided inside the recovery passageway 19 such that the second discharge ports 22 are disposed in the gas space in the recovery passageway 19. The liquid repellent part 42 hinders the interface of the liquid space in the recovery passageway 19 from approaching the second discharge ports 22 such that the peripheral space of each of the second discharge ports 22 inside the recovery passageway 19 is the gas space.

In the present embodiment, the second discharge ports 22 are disposed on the outer side of the projection 41 in radial directions with respect to the optical path K. Namely, the second discharge ports 22 are farther from the optical path K than the projection 41 is. In addition, at least part of the liquid repellent part 42 is disposed between the second discharge ports 22 and the projection 41.

In the present embodiment, the projection 41 is disposed between the second discharge ports 22 and at least some of the recovery ports 18 in the radial directions with respect to the optical path K. In the present embodiment, the projection 41 is disposed between the recovery ports 18 of the first portion 281 and the second discharge ports 22 in the radial directions with respect to the optical path K.

The projection 41 projects downward at least partly around the second discharge ports 22. In the present embodiment, the projection 41 is formed by at least part of the inner surface of the recovery passageway 19. In the present embodiment, the surfaces of the projection 41 include a side surface 41S, which extends downward at least partly around the second discharge ports 22, and a lower surface 41K, which extends from a lower end part of the side surface 41S such that it approaches the optical path K proceeding from the inner sides of the second discharge ports 22. The side surface 41S faces the outer side in the radial directions with respect to the optical path K. The side surface 41S is substantially parallel to the optical path K. The side surface 41S is substantially parallel to the Z axis. Furthermore, the side surface 41S does not have to be parallel to the Z axis. The lower surface 41K faces the direction. In the present embodiment, the lower surface 41K is substantially parallel to the XY plane. The side surface 41S and the lower surface 41K are part of the inner surface of the recovery passageway 19. In the present embodiment, the angle formed between the lower surface 41K and the side surface 41S is substantially 90°. Furthermore, the angle formed between the lower surface 41K and the side surface 41S may be less than or greater than 90°. In the present embodiment, the tip (i.e., the lower end) of the projection 41 is disposed at a position that is lower than the second discharge ports 22.

In the present embodiment, the lower surface 41K and the side surface 41S of the inner surface of the recovery passageway 19, which form the projection 41, are lyophilic with respect to the exposure liquid LQ. In the present embodiment, the lyophilic lower surface 41K and the lyophilic side surface 41S are adjacent to the liquid repellent part 42. At least part of the liquid repellent part 42 is disposed between the lyophilic lower surface 41K and the lyophilic side surface 41S on one side and the second discharge ports 22 on the other side.

In the present embodiment, the contact angle of the exposure liquid LQ with respect to the lyophilic inner surface (i.e., the lower surface 41K and the side surface 41S) of the recovery passageway 19 is less than 90°. The contact angle of the exposure liquid LQ with respect to the surface of the liquid repellent part 42 is 90° or greater. In the present embodiment, the contact angle of the exposure liquid LQ with respect to the surface of the liquid repellent part 42 may be, for example, 100° or greater or 110° or greater.

In the present embodiment, the liquid repellent part 42 is formed with films Fr that are liquid repellent with respect to the exposure liquid LQ. The material used to form the films Fr is fluorine based. In the present embodiment, the films Fr are tetrafluoroethylene-perfluoro (alkyl vinyl ether) copolymer (PFA) films. Furthermore, the films Fr may also be, for example, polytetrafluoroethylene (PTFE) films, polyetheretherketone (PEEK) films, or Teflon® films. In addition, the films Fr may also be Cytop™ (made by Asahi Glass Co.) or Novec EGC™ (made by 3M Company) films.

In the present embodiment, the first discharge ports 21 and the second discharge ports 22 are disposed at least partly around the optical path K. In the present embodiment, the second members 27, which each have the first discharge ports 21, are disposed at prescribed intervals around the optical path K. In the present embodiment, the second members 27 are disposed at four locations around the optical path K. The second discharge ports 22 are disposed at prescribed intervals around the optical path K. Furthermore, the number of the first discharge ports 21 and the number of the second discharge ports 22 may be the same. In addition, the first discharge ports 21 may be provided continuously around the optical path K, the second discharge ports 22 may be provided continuously around the optical path K, or both may be so provided.

As shown in FIG. 2, each of the first discharge ports 21 is connected to a first discharge apparatus 24 via the corresponding passageway 30 and a passageway 23, which is formed by a piping member 23P. The second discharge ports 22 are connected to a second discharge apparatus 26 via a passageway 36, which is formed inside the main body part 32, and a passageway 25, which is formed by a piping member 25P. Each of the first and second discharge apparatuses 24, 26 comprises, for example, a vacuum system and is capable of suctioning the fluid (i.e., the fluid containing the gas G or the exposure liquid LQ, or both).

In the present embodiment, a discharge operation is performed via the first discharge ports 21 by the operation of the first discharge apparatus 24. In addition, in the present embodiment, a discharge operation is performed via the second discharge ports 22 by the operation of the second discharge apparatus 26.

In the present embodiment, the first discharge apparatus 24 is capable of adjusting the pressure Pc in the passageways 30 that the upper surfaces 27A of the second members 27 face. In addition, the second discharge apparatus 26 is capable of adjusting the pressure Pb in the recovery passageway 19 that the lower surfaces 27B of the second members 27 and the upper surface 28A of the first member 28 face. In addition, the internal space CS includes the space SP, and the chamber apparatus 100 is capable of adjusting the pressure Pa in the space SP that the lower surface 28B of the first member 28 faces. The control apparatus 4 uses the chamber apparatus 100 or the second discharge apparatus 26, or both, to adjust the pressure Pa or the pressure Pb, or both, such that the first portion 281 of the first member 28 recovers the exposure liquid LQ together with the gas G from the space SP and such that the second portion 282 recovers the exposure liquid LQ while hindering the inflow of the gas G. In addition, the control apparatus 4 uses the first discharge apparatus 24 or the second discharge apparatus 26, or both, to set the pressure Pb or the pressure Pc, or both, such that the second members 27 discharge the exposure liquid LQ from the recovery passageway 19 while hindering the inflow of the gas G Furthermore, the second discharge apparatus 26 does not have to be capable of adjusting the pressure Pb.

Furthermore, the exposure apparatus EX may comprise the first discharge apparatus 24 or the second discharge apparatus 26, or both. Furthermore, the first discharge apparatus 24 or the second discharge apparatus 26, or both, may be an apparatus that is external to the exposure apparatus EX. Furthermore, the first discharge apparatus 24 or the second discharge apparatus 26, or both, may be equipment in the factory wherein the exposure apparatus EX is installed.

In the present embodiment, the first discharge ports 21 are capable of supplying a liquid to the recovery passageway 19. Namely, in the present embodiment, the first discharge ports 21 can function as liquid supply ports that are capable of supplying the liquid.

In the present embodiment, a supply apparatus 241, which is capable of supplying the liquid, is connected to the passageway 23 via a passageway 231 formed by a piping member 231P. The passageway 231 is connected to the passageway 23 via a passageway switching mechanism 23B, which comprises, for example, a valve mechanism. The supply apparatus 241 is capable of supplying the liquid to the first discharge ports 21 via the passageway 231 and the passageway 23. The first discharge ports 21 are capable of supplying the liquid from the supply apparatus 241 to the recovery passageway 19. When the liquid is discharged from the recovery passageway 19 via the first discharge ports 21, the control apparatus 4 controls the passageway switching mechanism 23B such that the first discharge ports 21 are connected to the first discharge apparatus 24 via the passageway 23 and not to the supply apparatus 241. In the state wherein the passageway switching mechanism 23B connects the first discharge ports 21 and the first discharge apparatus 24 via the passageway 23, fluid is discharged from the recovery passageway 19 via the first discharge ports 21 by the operation of the first discharge apparatus 24. Moreover, when the liquid is supplied to the recovery passageway 19 via the first discharge ports 21, the control apparatus 4 controls the passageway switching mechanism 23B such that the first discharge ports 21 are connected to the supply apparatus 241 via the passageway 23 and the passageway 231 and not to the first discharge apparatus 24. In the state wherein the passageway switching mechanism 23B connects the first discharge ports 21 and the supply apparatus 241 via the passageway 23 and the passageway 231, the liquid is supplied to the recovery passageway 19 via the first discharge ports 21 by the operation of the supply apparatus 241.

In the present embodiment, the liquid that is capable of being supplied via the first discharge ports 21 includes at least one of the following liquids: cleaning liquids LC (LC1, LC2) for cleaning, for example, at least some of the members of the exposure apparatus EX; and a rinsing liquid LH for eliminating any of the cleaning liquids LC that remain on those members. In the present embodiment, the cleaning liquids LC include the first cleaning liquid LC1 and the second cleaning liquid LC2. The supply apparatus 241 is capable of delivering the cleaning liquids LC or the rinsing liquid LH, or both.

The recovery member 400 is disposed at least partly around the liquid immersion member 3. In the present embodiment, the recovery member 400 is annular. The recovery member 400 is disposed such that it surrounds the liquid immersion member 3. Furthermore, a plurality of the recovery members 400 may be disposed such that the recovery members 400 are distributed around the liquid immersion member 3.

The recovery member 400 has a recovery port 401, which is capable of recovering at least some of the liquid from the space above the substrate P (i.e., the object). The substrate P is capable of opposing the recovery port 401. The recovery member 400 has a lower surface 402, which is disposed around the recovery port 401 and which the substrate P (i.e., the object) is capable of opposing. The recovery port 401 is capable of recovering the liquid from a space SQ between the lower surface 402 and the upper surface of the substrate P (i.e., the object) opposing the lower surface 402. In addition, the recovery member 400 has a recovery passageway 403, wherethrough the liquid recovered via the recovery port 401 flows.

The recovery port 401 is connected to a recovery apparatus 405 via the recovery passageway 403 and a passageway 404 formed by a piping member 404P. The recovery apparatus 405 comprises, for example, a vacuum system and is capable of suctioning a fluid (i.e., a fluid containing the liquid or the gas, or both).

In the present embodiment, the recovery operation via the recovery port 401 is performed by the operation of the recovery apparatus 405.

Furthermore, the exposure apparatus EX may comprise the recovery apparatus 405. Furthermore, the recovery apparatus 405 may be an apparatus that is external to the exposure apparatus EX. Furthermore, the recovery apparatus 405 may be equipment in the factory wherein the exposure apparatus EX is installed.

In addition, in the present embodiment, the supply ports 17 can supply the cleaning liquids LC (LC1, LC2). The liquid supply apparatus 35 can deliver not only the exposure liquid LQ but also the cleaning liquids LC.

In the present embodiment, at least part of the surface of the liquid immersion member 3 includes a surface of an amorphous carbon film. The amorphous carbon film includes a tetrahedral amorphous carbon film. In the present embodiment, at least part of the surface of the liquid immersion member 3 includes a surface of a tetrahedral amorphous carbon film. In the present embodiment, at least part of the surface of the liquid immersion member 3 that contacts the exposure liquid LQ in the immersion space LS during an exposure of the substrate P includes a surface of an amorphous carbon film (i.e., a tetrahedral amorphous carbon film). In the present embodiment, the base material of the plate part 31 and the main body part 32 may be titanium, and the amorphous carbon film is formed on the surface of that base material. In the present embodiment, the base material of the first member 28 and the second members 27 may be titanium, and the amorphous carbon film is formed on the surface of that base material.

Furthermore, the base material of the liquid immersion member 3, which comprises the plate part 31, the main body part 32, the first member 28, or the second members 27, or any combination thereof, may be a metal, such as stainless steel or aluminum, or a ceramic material.

Furthermore, the amorphous carbon film may be formed on the base material using, for example, chemical vapor deposition (CVD), physical vapor deposition (PVD), and the like. Furthermore, at least part of the surface of the liquid immersion member 3 does not have to include the surface of the amorphous carbon film.

Furthermore, at least part of the liquid immersion member 3 may include a material other than titanium, for example, stainless steel or magnesium. In addition, at least part of the liquid immersion member 3 may include a ceramic material.

Furthermore, at least part of the surface of the liquid immersion member 400 may include the surface of an amorphous carbon film or with a tetrahedral amorphous carbon film. In addition, the base material of the recovery member 400 may be a metal such as titanium, stainless steel, or aluminum, or may be a ceramic material.

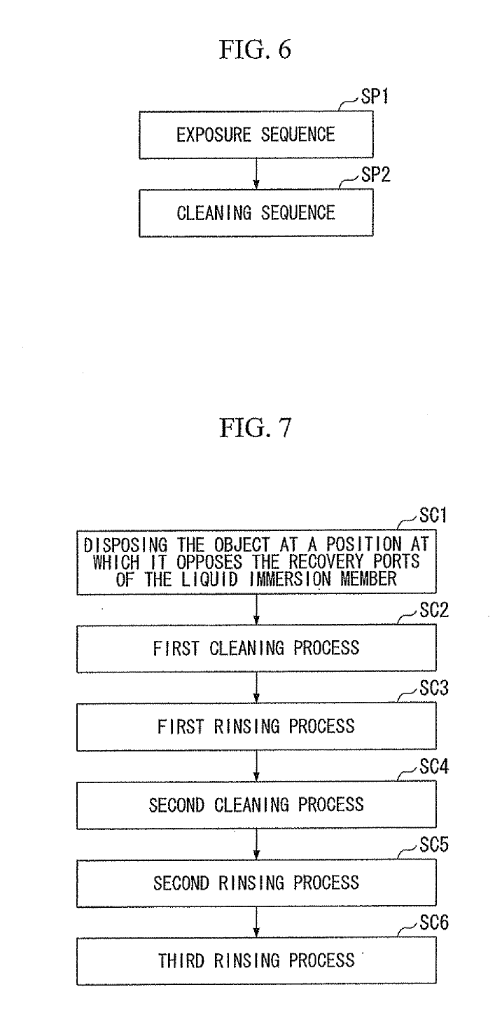

The text below explains one example of the operation of the exposure apparatus EX, which has the configuration discussed above. As in the flow chart shown in FIG. 6, in the present embodiment, an exposure sequence (i.e., a step SP1), which includes the exposing process that is performed on the substrate P, and a cleaning sequence (i.e., a step SP2), which includes a cleaning process that is performed on the liquid immersion member 3, are performed. Furthermore, the exposure sequence may be performed after the cleaning sequence, and the exposure sequence and the cleaning sequence may be performed repeatedly. In addition, the cleaning sequence may be performed at prescribed intervals and/or in a case that it is determined that the liquid immersion member 3 has become contaminated.

First, the exposure sequence (i.e., the step SP1) will be explained. To load the unexposed substrate P onto the substrate stage 2P (i.e., the substrate holding part 10), the control apparatus 4 moves the substrate stage 2P to a substrate exchange position. The substrate exchange position is a position spaced apart from the liquid immersion member 3 (i.e., the projection area PR) and is where the substrate P exchanging process can be performed. The substrate P exchanging process includes at least one of the following processes, using a prescribed transport apparatus (not shown) a process that unloads the exposed substrate P, which is held by the substrate stage 2P (i.e., the substrate holding part 10), from the substrate stage 2P; and a process that loads the unexposed substrate P onto the substrate stage 2P (i.e., the substrate holding part 10). The control apparatus 4 moves the substrate stage 2P to the substrate exchange position and performs the substrate P exchanging process.

During at least part of the interval during which the substrate stage 2P is spaced apart from the liquid immersion member 3, the control apparatus 4 disposes the measurement stage 2C at a position at which it opposes the last optical element 8 and the liquid immersion member 3 and forms the immersion space LS by holding the exposure liquid LQ between the last optical element 8 and the liquid immersion member 3 on one side and the measurement stage 2C on the other side.

In addition, during at least part of the interval during which the substrate stage 2P is spaced apart from the liquid immersion member 3, the measuring process may be performed, as needed, using the measurement stage 2C. When the measuring process using the measurement stage 2C is to be performed, the control apparatus 4 causes the last optical element 8 and the liquid immersion member 3 on one side and the measurement stage 2C on the other side to oppose one another and forms the immersion space LS such that the optical path K of the exposure light EL between the last optical element 8 and the measuring member C is filled with the exposure liquid LQ. The control apparatus 4 performs the exposure light EL measuring process by radiating the exposure light EL through the projection optical system PL and the exposure liquid LQ to the measuring member C (i.e., the measuring instrument) held by the measurement stage 2C. The result of that measuring process may be subsequently reflected in the exposing process to be performed on the substrate P.

After the unexposed substrate P is loaded onto the substrate stage 2P and the measuring process that uses the measurement stage 2C has ended, the control apparatus 4 moves the substrate stage 2P to the projection area PR and forms the immersion space LS between the last optical element 8 and the liquid immersion member 3 on one side and the substrate stage 2P (i.e., the substrate P) on the other side.

In the present embodiment, the immersion space LS is formed with the exposure liquid LQ between the last optical element 8 and the liquid immersion member 3 on one side and the substrate P (i.e., the object) on the other side by recovering the exposure liquid LQ via the recovery ports 18 in parallel with supplying the exposure liquid LQ via the supply ports 17.

Furthermore, in the present embodiment, as shown in FIG. 2 and FIG. 3, in the state wherein the object (i.e., the substrate P) opposing the last optical element 8 and the liquid immersion member 3 is substantially stationary, the interface LG of the exposure liquid LQ in the immersion space LS is formed between the first portion 281 and the object.

Furthermore, in the state wherein the object is substantially stationary, the interface LG of the exposure liquid LQ in the immersion space LS is formed between the second portion 282 and the object.

The control apparatus 4 starts the process of exposing the substrate P. The control apparatus 4 radiates the exposure light EL, which emerges from the mask M illuminated with the exposure light EL from the illumination system IL, to the substrate P through the projection optical system PL and the exposure liquid LQ in the immersion space LS. Thereby, the substrate P is exposed with the exposure light EL, which transits the exposure liquid LQ in the immersion space LS and emerges from the emergent surface 7, and thus the image of the pattern of the mask M is projected to the substrate P.

When recovering the exposure liquid LQ via the recovery ports 18, the control apparatus 4 operates the second discharge apparatus 26 to discharge the gas G from the recovery passageway 19 via the second discharge ports 22. Thereby, the pressure in the recovery passageway 19 decreases. In the present embodiment, the control apparatus 4 controls the second discharge apparatus 26 such that the pressure Pb in the recovery passageway 19 is lower than the pressure Pa in the space SR By making the pressure Pb lower than the pressure Pa, at least some of the exposure liquid LQ is recovered from the space above the substrate P to the recovery passageway 19 via the holes 28H of the first portion 281 of the first member 28 or the holes 28H of the second portion 282 of the first member 28, or both. In addition, at least some of the gas G is recovered from the space SP to the recovery passageway 19 via the holes 28H. The exposure liquid LQ and the gas G are separately discharged from the recovery passageway 19 via the discharge parts 20.

In the present embodiment, the discharge operation via the second discharge ports 22 is performed in the state wherein the hindering part 40, which comprises the projection 41 and the liquid repellent part 42, is disposed at least partly around the second discharge ports 22. The gas G is discharged from the recovery passageway 19 via the second discharge ports 22 while the hindering part 40 hinders the exposure liquid LQ in the recovery passageway 19 from contacting the second discharge ports 22. Furthermore, the hindering part 40 may have either just the projection 41 or just the liquid repellent part 42.

In the present embodiment, the exposure liquid LQ and the gas G flow in the recovery passageway 19 such that the exposure liquid LQ in the recovery passageway 19 contacts the first discharge ports 21 but not the second discharge ports 22. In the present embodiment, the arrangement of the first discharge ports 21, the second discharge ports 22, the recovery ports 18, and the like, and, for example, the shape of the inner surface of the recovery passageway 19, a characteristic (e.g., the contact angle) of the inner surface of the recovery passageway 19 with respect to the exposure liquid LQ, the shape of the surface of each of the members that faces the recovery passageway 19, and a characteristic (e.g., the contact angle) of the surface of the members that face the recovery passageway 19 with respect to the exposure liquid LQ are prescribed such that the exposure liquid LQ recovered to the recovery passageway 19 via the holes 28H of the first member 28 flows toward the first discharge ports 21 without contacting the second discharge ports 22.

In the present embodiment, the exposure liquid LQ, together with the gas G, is recovered to the recovery passageway 19 via the first portion 281 of the first member 28, substantially only and the exposure liquid LQ is recovered to the recovery passageway 19 via the second portion 282 of the first member 28 while the flow of the gas G into the recovery passageway 19 via the second portion 282 is hindered.

By virtue of the pressure Pb in the recovery passageway 19 being made lower than the pressure Pa in the space SP between the liquid immersion member 3 and the substrate P, the exposure liquid LQ in the space above the substrate P flows into the recovery passageway 19 via the recovery ports 18 (i.e., the first member 28). Namely, because a pressure differential is generated between the upper surface 28A and the lower surface 28B of the first member 28, the exposure liquid LQ in the space above the substrate P flows into the recovery passageway 19 via the recovery ports 18 (i.e., the first member 28).

In addition, the control apparatus 4 both controls the passageway switching mechanism 23B such that the first discharge apparatus 24 and the first discharge ports 21 are connected and operates the first discharge apparatus 24 to discharge the exposure liquid LQ from the recovery passageway 19 via the first discharge ports 21. The operation of the first discharge apparatus 24 lowers the pressure in the passageways 30. In the present embodiment, the control apparatus 4 controls the first discharge apparatus 24 such that the pressure Pc in the passageways 30 becomes lower than the pressure Pb in the recovery passageway 19.

The control apparatus 4 controls the first discharge apparatus 24 and thereby controls the pressure Pc in the passageways 30 such that only the exposure liquid LQ is discharged to the passageways 30 via the second members 27.

By virtue of the pressure Pc in the passageways 30 becoming lower than the pressure Pb in the recovery passageway 19, the exposure liquid LQ in the recovery passageway 19 flows into the passageways 30 via the first discharge ports 21 (i.e., the second members 27). Namely, by virtue of a pressure differential being generated between the upper surfaces 27A and the lower surfaces 27B of the second members 27, the exposure liquid LQ in the recovery passageway 19 flows into the passageways 30 via the first discharge ports 21 (i.e., the second members 27).

During the recovery of the exposure liquid LQ via the recovery ports 18, the exposure liquid LQ continues to be discharged from the recovery passageway 19 via the first discharge ports 21. To recover the exposure liquid LQ via the recovery ports 18, the second discharge ports 22 continue to discharge the gas G from the recovery passageway 19.

To discharge only the gas G from the recovery passageway 19, the second discharge ports 22 hinder the pressure Pb in the recovery passageway 19 from fluctuating greatly. Namely, the pressure Pb in the recovery passageway 19 is held substantially constant by ensuring a continuous gas passageway between the second discharge apparatus 26 and the gas space at the upper part of the recovery passageway 19 and by the second discharge ports 22 continuing to discharge the gas G from the recovery passageway 19. Because the pressure Pb in the recovery passageway 19 is substantially constant, fluctuations in the amount of the liquid recovered per unit of time from the space above the substrate P (i.e., in the immersion space LS) via the recovery ports 18 are hindered.

In the present embodiment, to form the immersion space LS, the supply ports 17 supply a prescribed amount of the exposure liquid LQ per unit of time. In the present embodiment, the supply ports 17 continue to supply a substantially constant amount of the exposure liquid LQ. In addition, the recovery ports 18 recover a prescribed amount of the exposure liquid LQ per unit of time. In the present embodiment, the recovery ports 18 continue to recover a substantially constant amount of the exposure liquid LQ. Accordingly, large fluctuations in the immersion space LS are hindered.

In the present embodiment, the exposure liquid LQ recovered to the recovery passageway 19 via the recovery ports 18 flows toward the first discharge ports 21 (i.e., the second members 27) while contacting at least part of the inner surface of the recovery passageway 19. The exposure liquid LQ in the recovery passageway 19 that contacts at least one of the first discharge ports 21 (i.e., the second members 27) is discharged via those first discharge ports 21. For example, the exposure liquid LQ recovered via the holes 28H of the first portion 281 flows on the upper surface 28A of the first member 28 toward the first discharge ports 21 (i.e., the second members 27). The exposure liquid LQ is discharged from the recovery passageway 19 via the first discharge ports 21 such that the flow of the gas G from the recovery passageway 19 into the second discharge ports 22 is maintained. The control apparatus 4 controls the first discharge apparatus 24 or the second discharge apparatus 26, or both, such that the discharge of the gas G via the second discharge ports 22 continues and such that the exposure liquid LQ is discharged via the first discharge ports 21.

In the present embodiment, when the exposure liquid LQ is being recovered from the space above the substrate P via the first member 28, at least the upper surface 28A of the second portion 282 is covered by the exposure liquid LQ in the recovery passageway 19. In the present embodiment as shown in FIG. 2 and FIG. 3, in the recovery passageway 19, substantially the entire area of the upper surface 28A of the first member 28 is covered by the exposure liquid LQ in the recovery passageway 19. Namely, in the recovery passageway 19, substantially the entire upper surface 28A contacts the exposure liquid LQ. Thereby, the liquid selective recovery condition is satisfied for the majority of the holes 28H of the second portion 282, and substantially only the exposure liquid LQ is recovered via the second portion 282.

In addition, in the present embodiment, if the exposure liquid LQ in the immersion space LS flows out of the space SP, then the recovery port 401 of the recovery member 400 recovers that exposure liquid LQ. Thereby, the exposure liquid LQ is hindered from flowing out to the outer side of the space SQ. In addition, if the exposure liquid LQ remains in the space above the substrate P (i.e., the object), then the recovery port 401 recovers that residual exposure liquid LQ. Furthermore, the suctioning operation via the recovery port 401 does not have to be performed during the exposing process of the substrate P. Namely, the exposure liquid LQ does not have to be recovered via the recovery port 401 during the substrate P exposing process.

After the substrate P exposing process is complete, the control apparatus 4 moves the substrate stage 2P to the substrate exchange position. The measurement stage 2C is disposed such that it opposes, for example, the last optical element 8 and the liquid immersion member 3. The exposed substrate P is unloaded from the substrate stage 2P, which has moved to the substrate exchange position, and the unexposed substrate P is loaded onto the substrate stage 2P.

Below, the control apparatus 4 performs the processes discussed above repetitively to sequentially expose a plurality of the substrates P.

Furthermore, in the present embodiment, during at least part of the interval of the exposure sequence, which includes the substrate P exchanging process, the measuring process using the measurement stage 2C, and the substrate P exposing process, the exposure liquid LQ is supplied via the supply ports 17 to the space between the last optical element 8 and the liquid immersion member 3 on one side and the object (i.e., the substrate P, the substrate stage 2P, or the measurement stage 2C, or any combination thereof), which is disposed opposing the last optical element 8 and the liquid immersion member 3, on the other side, and at least some of the exposure liquid LQ supplied via the supply ports 17 is recovered via the recovery ports 18. The exposure liquid LQ in the recovery passageway 19 recovered via the recovery ports 18 during the exposure sequence is discharged via the first discharge ports 21, and the gas G in the recovery passageway 19 is discharged via the second discharge ports 22.

Incidentally, during an exposure of the substrate P, there is a possibility that, for example, a substance (e.g., an organic substance such as the photosensitive material) produced by the substrate P will intermix with the exposure liquid LQ in the immersion space LS, or that a substance of the substrate P will elute into the exposure liquid LQ. That substance will function as foreign matter. In addition, along with the substance produced by the substrate P, foreign matter suspended in midair and the like might intermix with the exposure liquid LQ of the immersion space LS.

The liquid immersion member 3 is a member that contacts the exposure liquid LQ. In addition, because the first member 28 continues to contact the exposure liquid LQ at least during the exposure of the substrate P, if foreign matter intermixes with the exposure liquid LQ, then that foreign matter might adhere to the first member 28. For example, foreign matter might adhere to the lower surface 28B of the first member 28.

In addition, by virtue of the exposure liquid LQ in the immersion space LS, which is contaminated by foreign matter, being recovered via the recovery ports 18 and flowing through the recovery passageway 19, at least part of, for example, the upper surface 28A and the surfaces (i.e., the inner surfaces) of the holes 28H of the first member 28, the inner surface of the recovery passageway 19, and the surfaces (i.e., the upper surfaces 27A, the lower surfaces 27B, and the inner surfaces of the holes 2711) of the second members 27 will contact the exposure liquid LQ and thereby the foreign matter might adhere to those surfaces.

If the state wherein foreign matter is adhered to at least part of the surfaces of the liquid immersion member 3—including the lower surface 14, the inner surface of the recovery passageway 19, the surfaces of the first member 28, and the surfaces of the second members 27—is left as is, then, for example, that foreign matter might adhere to the substrate P during an exposure, or the exposure liquid LQ supplied via the supply ports 17 might become contaminated. In addition, if the lower surface 14 becomes contaminated, then there is also a possibility that, for example, the immersion space LS will no longer be able to be formed satisfactorily. As a result, exposure failures might occur.

Accordingly, in the present embodiment, the cleaning sequence (i.e., the step SP2) is performed wherein at least part of the liquid immersion member 3 is cleaned with a prescribed timing.

The text below explains one example of the cleaning sequence for cleaning the liquid immersion member 3.

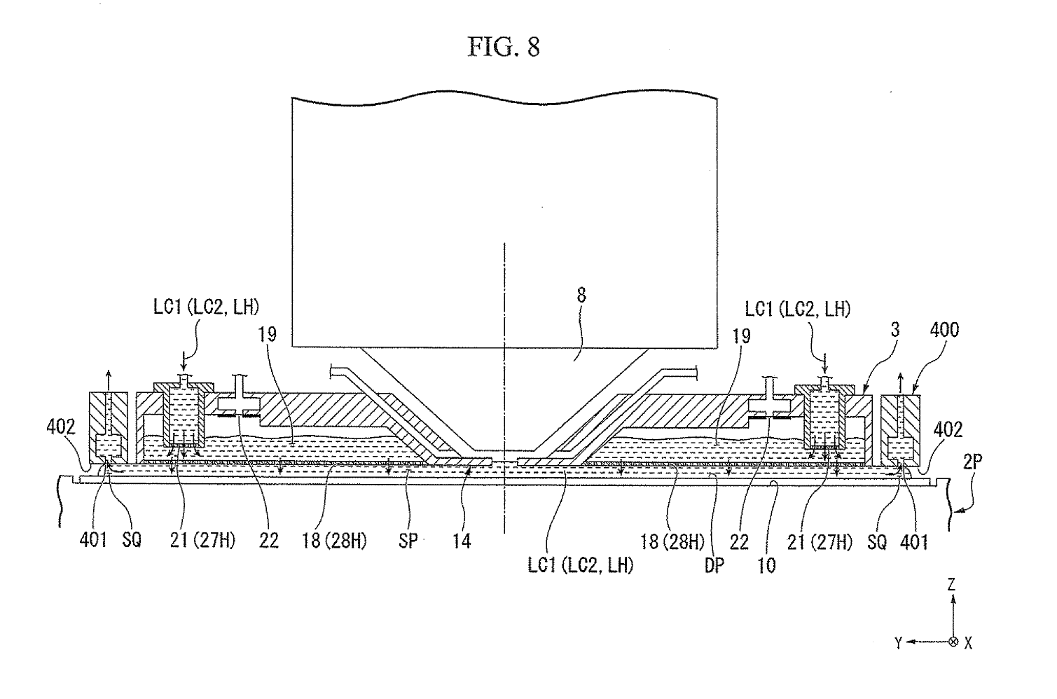

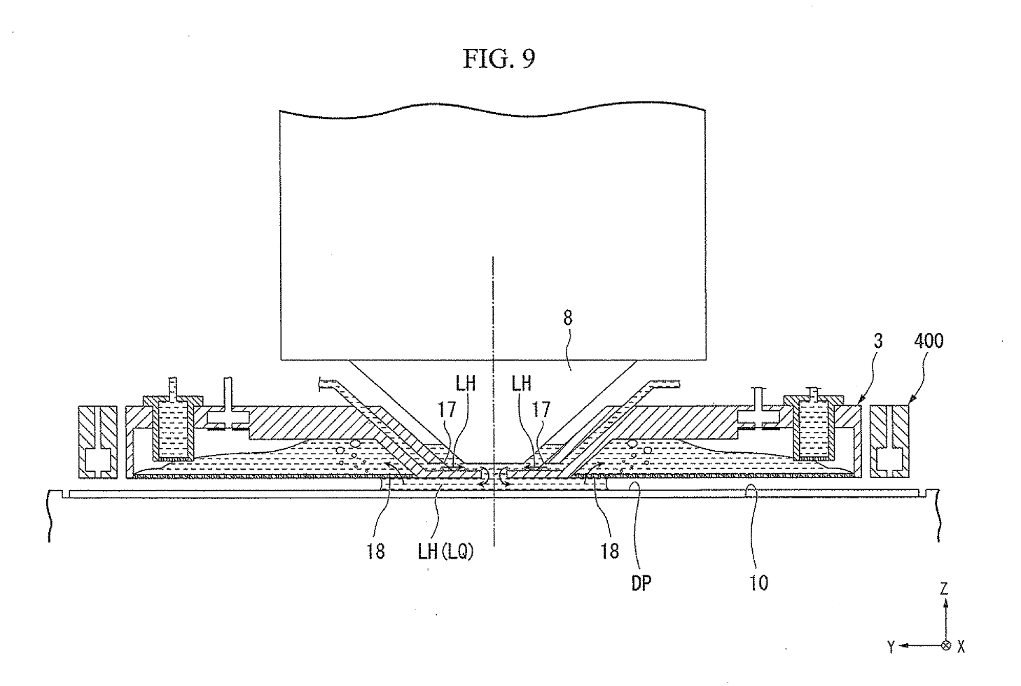

FIG. 7 is a flow chart that shows one example of the cleaning sequence according to the present embodiment, and FIG. 8 and FIG. 9 are schematic drawings that show one example of the cleaning sequence according to the present embodiment.

The cleaning sequence according to the present embodiment comprises: a process (i.e., a step SC1) wherein the object is disposed at a position at which it opposes the recovery ports 18 of the liquid immersion member 3; a process (i.e., a step SC2) wherein the first cleaning liquid LC1 is supplied to the recovery passageway 19 of the liquid immersion member 3 and thereby at least part of the liquid immersion member 3 is cleaned; a process (i.e., a step SC3) wherein the rinsing liquid LH is supplied to the recovery passageway 19; a process (i.e., a step SC4) wherein the second cleaning liquid LC2 is supplied to the recovery passageway 19 and thereby at least part of the liquid immersion member 3 is cleaned; a process (i.e., a step SC5) wherein the rinsing liquid LH is supplied to the recovery passageway 19; and a process (i.e., a step SC6) wherein the rinsing liquid LH is furthermore supplied to the recovery passageway 19.

In the explanation below, the cleaning process that uses the first cleaning liquid LC1 (i.e., the step SC2) is called a first cleaning process where appropriate, and the cleaning process that uses the second cleaning liquid LC2 (i.e., the step SC4) is called a second cleaning process where appropriate.

In addition, in the explanation below, the process wherein the rinsing liquid LH is supplied to a member, such as the liquid immersion member 3, which was cleaned using the cleaning liquids LC (LC1, LC2) is called a rinsing process where appropriate. The rinsing process includes a process that supplies the rinsing liquid LH to a member and then eliminates the cleaning liquids LC (LC1, LC2) remaining on that member by rinsing that member.

In addition, in the explanation below, the rinsing process that is performed after the first cleaning process (i.e., the step SC3) is called a first rinsing process where appropriate, the rinsing process that is performed after the second cleaning process (i.e., the step SC5) is called a second rinsing process where appropriate, and the rinsing process that is performed after the second rinsing process (i.e., the step SC6) is called a third rinsing process where appropriate.

An alkaline liquid, for example, may be used as the first cleaning liquid LC1. Namely, an alkaline solution that contains a prescribed substance may be used as the first cleaning liquid LC1. For example, the prescribed substance that the first cleaning liquid LC1 contains may be, for example, tetramethylammonium hydroxide (TMAH). In addition, an alkaline aqueous solution may be used as the first cleaning liquid LC1.

An acidic liquid, for example, may be used as the second cleaning liquid LC2. Namely, an acidic solution that contains a prescribed substance may be used as the second cleaning liquid LC2. The prescribed substance that the second cleaning liquid LC2 contains may be, for example, hydrogen peroxide. In addition, an acidic aqueous solution may be used as the second cleaning liquid LC2.

In addition, the first cleaning liquid LC1 and the rinsing liquid LH may be the same type of liquid. In addition, the second cleaning liquid LC2 and the rinsing liquid LH may be the same type of liquid.

In the present embodiment, an alkaline aqueous solution that contains tetramethylammonium hydroxide is used as the first cleaning liquid LC1. An aqueous solution of hydrogen peroxide is used as the second cleaning liquid LC2. The exposure liquid LQ is used as the rinsing liquid LH. Namely, in the present embodiment, water (i.e., pure water) is used as the rinsing liquid LH. In the present embodiment, the abovementioned same type of liquid used as the first cleaning liquid LC1, the second cleaning liquid LC2, and the rinsing liquid LH may be water.

In the present embodiment, an aqueous solution of tetramethylammonium hydroxide (TMAH) is used as the first cleaning liquid LC1. An aqueous solution of hydrogen peroxide (i.e., aqueous hydrogen peroxide) is used as the second cleaning liquid LC2.

Furthermore, the alkaline solution used as the first cleaning liquid LC1 is not limited to tetramethylammonium hydroxide, and may be an inorganic alkaline solution of sodium hydroxide, potassium hydroxide, and the like, or may be an organic alkaline solution of trimethyl(2-hydroxyethyl) ammonium hydroxide and the like. Furthermore, aqueous ammonia may be used as the first cleaning liquid LC1.

Furthermore, the second cleaning liquid LC2 may be a solution of buffered hydrofluoric acid. In addition, the second cleaning liquid LC2 may be a solution that contains buffered hydrofluoric acid and hydrogen peroxide. Buffered hydrofluoric acid is a mixture of hydrofluoric acid and ammonium fluoride. The mixing ratio may be in the range of 5:1 to 2,000:1 as calculated by the volumetric ratio of a 40 wt % solution of ammonium fluoride to 50 wt % of hydrofluoric acid. In addition, the mixing ratio of the buffered hydrofluoric acid to the hydrogen peroxide may be in the range of 0.8:1 to 55:1 as calculated by the weight ratio of the hydrogen peroxide to the hydrofluoric acid. The second cleaning liquid LC2 may even be an ozone liquid that contains ozone. Of course, it may be a solution that contains hydrogen peroxide and ozone.

Furthermore, the first cleaning liquid LC1 or the second cleaning liquid LC2, or both, may be an alcohol. For example, the first cleaning liquid LC1 or the second cleaning liquid LC2, or both, may be ethanol, isopropyl alcohol (IPA), or pentanol, or any combination thereof.

In addition, the abovementioned same type of liquid used as the first cleaning liquid LC1 and the second cleaning liquid LC2 may be, for example, an alcohol.

In addition, a rinsing liquid other than the rinsing liquid LH may be used in at least one of the following processes: the first rinsing process, the second rinsing process, and the third rinsing process.

In the present embodiment, at least part of the cleaning sequence that cleans the liquid immersion member 3 is performed in the state wherein the recovery ports 18 of the liquid immersion member 3 and the object are opposed. In the cleaning sequence, first, the object is disposed such that it opposes the recovery ports 18 of the liquid immersion member 3 (i.e., the step SC1).

Furthermore, in the present embodiment, after the exposure liquid LQ that forms the immersion space LS is substantially completely eliminated, the cleaning process is started and the object is disposed at a position at which it opposes the recovery ports 18 of the liquid immersion member 3.

In the present embodiment, the object that is disposed at the position at which it opposes the recovery ports 18 is a dummy substrate DP, which is held by the substrate stage 2P (i.e., the substrate holding part 10). As shown in FIG. 8, the dummy substrate DP held by the substrate stage 2P is disposed such that it opposes the liquid immersion member 3 (i.e., the step SC1). The dummy substrate DP is a substrate that tends not to release foreign matter more than the substrate P tends to. The dummy substrate DP is not used in the formation of the device pattern. In addition, there may be a function that traps foreign matter on the front surface of the dummy substrate DP. In such a case, the dummy substrate DP preferably tends not to release the foreign matter trapped on (i.e., adhered to) its front surface. In addition, in the present embodiment, the external shape and size of the dummy substrate DP are substantially the same as those of the substrate P. The substrate holding part 10 is capable of holding the dummy substrate DP. Furthermore, the external shape and the size of the dummy substrate DP do not have to be the same as those of the substrate P.

In the state wherein the liquid immersion member 3 and the dummy substrate DP are opposed, the control apparatus 4 starts the first cleaning process (i.e., the step SC2). The first cleaning process includes the process wherein the first cleaning liquid LC1 is supplied to the recovery passageway 19.

In the present embodiment, as shown in FIG. 8, the first cleaning liquid LC1 is supplied to the recovery passageway 19 via the first discharge ports 21. As discussed above, in the present embodiment, the supply apparatus 241, which is capable of supplying the cleaning liquids LC (LC1, LC2) and the rinsing liquid LH, is connected to the passageway 23. Furthermore, a supply apparatus that supplies the cleaning liquids LC (LC1, LC2) and a supply apparatus that supplies the rinsing liquid LH may be separately provided. In addition, a supply apparatus that supplies the first cleaning liquid LC1 and a supply apparatus that supplies the second cleaning liquid LC2 may be separately provided. In the first cleaning process, the control apparatus 4 delivers the first cleaning liquid LC1 from the supply apparatus 241. The control apparatus 4 controls the passageway switching mechanism 23B such that the first cleaning liquid LC1 delivered from the supply apparatus 241 is supplied to the first discharge ports 21. Thereby, the first cleaning liquid LC1 delivered from the supply apparatus 241 is supplied to the first discharge ports 21 via the passageway 231 and the passageway 23. The first discharge ports 21, which are disposed such that they face the recovery passageway 19, supply the first cleaning liquid LC1 from the supply apparatus 241 to the recovery passageway 19.

Furthermore, when the first cleaning liquid LC1 is being supplied to the recovery passageway 19 via the first discharge ports 21, the fluid discharge operation via the second discharge ports 22 is stopped. Namely, in the present embodiment, when the first cleaning liquid LC1 is being supplied to the recovery passageway 19 via the first discharge ports 21, the second discharge ports 22 do not suction the fluid (i.e., the fluid containing the gas or the liquid, or both).

The first cleaning liquid LC1 from the supply apparatus 241 contacts at least part of the surfaces of the second members 27. Namely, the first cleaning liquid LC1 from the supply apparatus 241 contacts at least part of the upper surfaces 27A, the inner surfaces of the holes 27H, and the lower surfaces 27B of the second members 27. Thereby, the second members 27 are cleaned by the first cleaning liquid LC1.

In addition, at least some of the first cleaning liquid LC1 supplied to the recovery passageway 19 via the first discharge ports 21 contacts the inner surface of the recovery passageway 19. Thereby, at least part of the inner surface of the recovery passageway 19 is cleaned by the first cleaning liquid LC1.

In addition, at least some of the first cleaning liquid LC1 supplied to the recovery passageway 19 via the first discharge ports 21 contacts at least part of the surfaces of the first member 28. Namely, the first cleaning liquid LC1 from the first discharge ports 21 contacts at least part of the upper surface 28A, the inner surfaces of the holes 28H, and the lower surface 28B of the first member 28. Thereby, the first member 28 is cleaned by the first cleaning liquid LC1.

In addition, at least some of the first cleaning liquid LC1 supplied to the recovery passageway 19 via the first discharge ports 21 flows via the holes 28H (i.e., the recovery ports 18) of the first member 28 to the space SP between the lower surface 14 of the liquid immersion member 3 and the upper surface of the dummy substrate DP. In other words, the first cleaning liquid LC1 is discharged from the recovery passageway 19 via the recovery ports 18 to the space SP, which the lower surface 14 of the liquid immersion member 3 faces. In the present embodiment, the dummy substrate DP is disposed below the liquid immersion member 3 and at least some of the first cleaning liquid LC1 in the recovery passageway 19 flows by the action of gravity to the space below the liquid immersion member 3 via the holes 28H (i.e., the recovery ports 18). The first cleaning liquid LC1 supplied to the space SP via the holes 28H (i.e., the recovery ports 18) is held between the lower surface 14 and the upper surface of the dummy substrate DP.

Furthermore, the first cleaning liquid LC1 may be pushed out of the recovery passageway 19 via the recovery ports 18 to the space above the dummy substrate DP. For example, in the state wherein the recovery passageway 19 is filled with the first cleaning liquid LC1, the first cleaning liquid LC1 may flow from the recovery passageway 19 to the space SP by virtue of the first cleaning liquid LC1 continuing to be supplied to the recovery passageway 19.

By virtue of the first cleaning liquid LC1 continuing to be supplied via the first discharge ports 21 and the first cleaning liquid LC1 continuing to flow to the space SP via the recovery ports 18, an immersion space is formed in the space SP with the first cleaning liquid LC1. At least some of the first cleaning liquid LC1 in the space SP flows to the space SQ between the lower surface 402 of the recovery member 400 and the upper surface of the dummy substrate DP. The first cleaning liquid LC1 in the space SQ is held between the lower surface 402 and the upper surface of the dummy substrate DP.

In the present embodiment, when the first cleaning liquid LC1 is being supplied to the space SP via the recovery ports 18, the recovery operation is performed wherein the first cleaning liquid LC1 is recovered via the recovery port 401. Namely, in the present embodiment, the control apparatus 4 recovers the first cleaning liquid LC1 via the recovery port 401 in parallel with discharging the first cleaning liquid LC1 to the spaces SP, SQ via the recovery ports 18. Thereby, the immersion space of the first cleaning liquid LC1 is formed between the liquid immersion member 3 and the recovery member 400 on one side and the dummy substrate DP on the other side. The first cleaning liquid LC1 contacts at least part of the lower surface 14 of the liquid immersion member 3 and the lower surface 402 of the recovery member 400. At least part of the lower surface 14 and the lower surface 402 is cleaned by the first cleaning liquid LC1.

Thus, in the present embodiment, at least some of the first cleaning liquid LC1 supplied to the recovery passageway 19 via the first discharge ports 21 is discharged (i.e., supplied) to the space SP, which the recovery ports 18 face, via the recovery ports 18, and is recovered via the recovery port 401, which is disposed at least partly around the recovery ports 18, from the space SP.

After the supply of the first cleaning liquid LC1 via the first discharge ports 21 (i.e., the recovery ports 18) and the recovery of the first cleaning liquid LC1 via the recovery port 401 have been performed for a prescribed time, the supply of the first cleaning liquid LC1 via the first discharge ports 21 (i.e., the recovery ports 18) is stopped and the first cleaning liquid LC1 is recovered from the spaces SP, SQ via, for example, the recovery port 401. Thereby, the first cleaning process (i.e., the step SC2) ends. Furthermore, the first cleaning process may end with the first cleaning liquid LC1 remaining as is in the spaces SP, SQ.

Furthermore, in the first cleaning process, the fluid discharge operation via the second discharge ports 22 may be performed. For example, the operation of discharging the fluid (i.e., the fluid containing the first cleaning liquid LC1 or the gas G, or both) from the recovery passageway 19 via the second discharge ports 22 may be performed in parallel with at least part of the operation of supplying the first cleaning liquid LC1 via the first discharge ports 21.

In addition, in the first cleaning process, the discharge (i.e., the recovery) of the first cleaning liquid LC1 present in the recovery passageway 19 may be performed via the first discharge ports 21 by the operation of the first discharge apparatus 24. For example, the first cleaning liquid LC1 may be discharged (i.e., recovered) from the recovery passageway 19 via the first discharge ports 21 after the supply of the first cleaning liquid LC1 is stopped. In such a case, at least some of the first cleaning liquid LC1 may be discharged from the spaces SP, SQ via the recovery ports 18 and then via the first discharge ports 21.

Furthermore, when the first cleaning process is to be started, the supply of the first cleaning liquid LC1 may be started in the state wherein the exposure liquid LQ remains in at least part of the recovery passageway 19, the space SP, and the space SQ. In that case, the exposure liquid LQ is supplied to the recovery passageway 19 via the first discharge ports 21 and is recovered via the recovery port 401 together with the first cleaning liquid LC1 that flowed into the spaces SP, SQ via the recovery ports 18.

Next, the first rinsing process (i.e., the step SC3) is started. In the present embodiment, the first rinsing process includes the supplying of the rinsing liquid LH to the recovery passageway 19.

In the present embodiment, the rinsing liquid LH is supplied to the recovery passageway 19 via the first discharge ports 21. As discussed above, in the present embodiment, the supply apparatus 241 is capable of supplying the rinsing liquid LH. In the first rinsing process, the control apparatus 4 delivers the rinsing liquid LH from the supply apparatus 241. The control apparatus 4 controls the passageway switching mechanism 23B such that the rinsing liquid LH delivered from the supply apparatus 241 is supplied to the first discharge ports 21. Thereby, the rinsing liquid LH delivered from the supply apparatus 241 is supplied to the first discharge ports 21 via the passageway 231 and the passageway 23. The first discharge ports 21 supply the rinsing liquid LH from the supply apparatus 241 to the recovery passageway 19.

Furthermore, in the present embodiment, when the rinsing liquid LH is being supplied to the recovery passageway 19 via the first discharge ports 21, the fluid discharge operation via the second discharge ports 22 is stopped.

The rinsing liquid LH from the supply apparatus 241 contacts at least part of the surfaces of the second members 27. Namely, the rinsing liquid LH from the supply apparatus 241 contacts at least part of the upper surfaces 27A, the inner surfaces of the holes 27H, and the lower surfaces 27B of the second members 27. Thereby, at least some of the first cleaning liquid LC1 remaining on the surfaces of the second members 27 is eliminated by the rinsing liquid LH.

In addition, at least some of the rinsing liquid LH supplied to the recovery passageway 19 via the first discharge ports 21 contacts the inner surface of the recovery passageway 19. Thereby, at least some of the first cleaning liquid LC1 remaining on the inner surface of the recovery passageway 19 is eliminated by the rinsing liquid LH.

In addition, at least some of the rinsing liquid LH supplied to the recovery passageway 19 via the first discharge ports 21 contacts at least part of the surfaces of the first member 28. Namely, the rinsing liquid LH from the first discharge ports 21 contacts at least part of the upper surface 28A, the inner surfaces of the holes 28H, and the lower surface 28B of the first member 28. Thereby, at least some of the first cleaning liquid LC1 remaining on the surfaces of the first member 28 is eliminated by the rinsing liquid LH.

At least some of the rinsing liquid LH supplied to the recovery passageway 19 via the first discharge ports 21 flows via the holes 28H (i.e., the recovery ports 18) of the first member 28 to the space SP between the lower surface 14 and the upper surface of the dummy substrate DP. The rinsing liquid LH discharged (i.e., supplied) to the space SP via the holes 28H (i.e., the recovery ports 18) is held between the lower surface 14 and the upper surface of the dummy substrate DP.

Furthermore, in the present embodiment, although the rinsing liquid LH flows to the space SP via the holes 28H (i.e., the recovery ports 18) by the action of gravity, the rinsing liquid LH may be pushed out of the recovery passageway 19. For example, in the state wherein the recovery passageway 19 is filled with the rinsing liquid LH, the rinsing liquid LH may be discharged from the recovery passageway 19 to the space SP by virtue of the rinsing liquid LH continuing to be supplied to the recovery passageway 19.

By virtue of the rinsing liquid LH continuing to be supplied via the first discharge ports 21 and the rinsing liquid LH being discharged to the space SP via the recovery ports 18, an immersion space is formed in the space SP with the rinsing liquid LH. At least some of the rinsing liquid LH in the space SP flows to the space SQ between the lower surface 402 of the recovery member 400 and the upper surface of the dummy substrate DP. The rinsing liquid LH in the space SQ is held between the lower surface 402 and the upper surface of the dummy substrate DP.

In the present embodiment, when the rinsing liquid LH is being discharged to the space SP via the recovery ports 18, the recovery operation is performed wherein the rinsing liquid LH is recovered via the recovery port 401. Namely, the rinsing liquid LH is recovered via the recovery port 401 in parallel with the rinsing liquid LH being discharged to the spaces SP, SQ via the recovery ports 18. Thereby, the immersion space of the rinsing liquid LH is formed between the liquid immersion member 3 and the recovery member 400 on one side and the dummy substrate DP on the other side. The rinsing liquid LH contacts at least part of the lower surface 14 of the liquid immersion member 3 and the lower surface 402 of the recovery member 400. At least some of the first cleaning liquid LC1 remaining on the lower surface 14 and the lower surface 402 is eliminated by the rinsing liquid LH.

Thus, in the present embodiment, at least some of the rinsing liquid LH supplied to the recovery passageway 19 via the first discharge ports 21 is discharged (i.e., supplied) to the space SP, which the recovery ports 18 face, via the recovery ports 18, and is recovered from the space SP via the recovery port 401, which is disposed at least partly around the recovery ports 18.

After the supply of the rinsing liquid LH via the first discharge ports 21 (i.e., the recovery ports 18) and the recovery of the rinsing liquid LH via the recovery port 401 have been performed for a prescribed time, the supply of the rinsing liquid LH via the first discharge ports 21 (i.e., the recovery ports 18) is stopped and the rinsing liquid LH is recovered from the spaces SP, SQ via, for example, the recovery port 401. Thereby, the first rinsing process (i.e., the step SC3) ends.

Furthermore, in the first rinsing process, the fluid discharge operation via the second discharge ports 22 may be performed. For example, the operation of discharging the fluid (i.e., the fluid containing the rinsing liquid LH or the gas G, or both) from the recovery passageway 19 via the second discharge ports 22 may be performed in parallel with at least part of the operation of supplying the rinsing liquid LH via the first discharge ports 21.

In addition, in the first rinsing process, the discharge (i.e., the recovery) of the rinsing liquid LH present in the recovery passageway 19 may be performed via the first discharge ports 21 by the operation of the first discharge apparatus 24. For example, the rinsing liquid LH may be discharged (i.e., recovered) from the recovery passageway 19 via the first discharge ports 21 after the supply of the rinsing liquid LH is stopped. In such a case, at least some of the rinsing liquid LH may be discharged from the spaces SP, SQ via the recovery ports 18 and then via the first discharge ports 21.

Furthermore, when the first rinsing process is to be started, the supply of the rinsing liquid LH may be started in the state wherein the first cleaning liquid LC1 remains in at least part of the recovery passageway 19, the space SP, and the space SQ. For example, the supply of the rinsing liquid LH may be started without performing the operation of recovering the first cleaning liquid LC1 present in the recovery passageway 19, the space SP, or the space SQ, or any combination thereof, via the recovery port 401 and the like. In that case, the first cleaning liquid LC1 is supplied to the recovery passageway 19 via the first discharge ports 21 and is recovered via the recovery port 401 together with the rinsing liquid LH that flowed into the spaces SP, SQ via the recovery ports 18.

Next, the second cleaning process (i.e., the step SC4) is started. In the present embodiment, the second cleaning process includes the supplying of the second cleaning liquid LC2 to the recovery passageway 19.

In the present embodiment, the second cleaning liquid LC2 is supplied to the recovery passageway 19 via the first discharge ports 21. As discussed above, in the present embodiment, the supply apparatus 241 is capable of supplying the second cleaning liquid LC2. In the second cleaning process, the control apparatus 4 delivers the second cleaning liquid LC2 from the supply apparatus 241. The second cleaning liquid LC2 delivered from the supply apparatus 241 is supplied to the first discharge ports 21 via the passageway 231 and the passageway 23. The first discharge ports 21 supply the second cleaning liquid LC2 from the supply apparatus 241 to the recovery passageway 19.

Because the second cleaning process that uses the second cleaning liquid LC2 is performed in the same manlier as the first cleaning process that uses the first cleaning liquid LC1, a detailed explanation thereof is omitted.

The second cleaning process cleans at least part of the surfaces of the second members 27 with the second cleaning liquid LC2.

In addition, the second cleaning process cleans at least part of the inner surface of the recovery passageway 19 with the second cleaning liquid LC2.

In addition, the second cleaning process cleans at least part of the surfaces of the first member 28 with the second cleaning liquid LC2.

After the supply of the second cleaning liquid LC2 via the first discharge ports 21 (i.e., the recovery ports 18) and the recovery of the second cleaning liquid LC2 via the recovery port 401 have been performed for a prescribed time, the supply of the second cleaning liquid LC2 via the first discharge ports 21 (i.e., the recovery ports 18) is stopped and the second cleaning liquid LC2 is recovered from the spaces SP, SQ via, for example, the recovery port 401. Thereby, the second cleaning process (i.e., the step SC4) ends. Furthermore, the second cleaning process may end with the second cleaning liquid LC2 remaining as is in the spaces SP, SQ.

Furthermore, in the second cleaning process, the fluid discharge operation via the second discharge ports 22 may be performed. For example, the operation of discharging the fluid (i.e., the fluid containing the second cleaning liquid LC2 or the gas G, or both) from the recovery passageway 19 via the second discharge ports 22 may be performed in parallel with at least part of the operation of supplying the second cleaning liquid LC2 via the first discharge ports 21.

In addition, in the second cleaning process, the discharge (i.e., the recovery) of the second cleaning liquid LC2 present in the recovery passageway 19 may be performed via the first discharge ports 21 by the operation of the first discharge apparatus 24. For example, the second cleaning liquid LC2 may be discharged (i.e., recovered) from the recovery passageway 19 via the first discharge ports 21 after the supply of the second cleaning liquid LC2 is stopped. In such a case, at least some of the second cleaning liquid LC2 may be discharged from the spaces SP, SQ via the recovery ports 18 and then via the first discharge ports 21.

Furthermore, when the second cleaning process is to be started, the supply of the second cleaning liquid LC2 may be started without performing the operation of recovering the rinsing liquid LH present in at least part of the recovery passageway 19, the space SP, and the space SQ via the recovery port 401 and the like. In that case, the rinsing liquid LH is supplied to the recovery passageway 19 via the first discharge ports 21 and is recovered via the recovery port 401 together with the second cleaning liquid LC2 that flowed into the space SP via the recovery ports 18.

Furthermore, in the second cleaning process, the supply of the second cleaning liquid LC2 may be started in the state wherein at least some of the rinsing liquid LH remains in at least part of the recovery passageway 19 and the spaces SP, SQ. In that case, the rinsing liquid LH is supplied to the recovery passageway 19 via the first discharge ports 21 and recovered via the recovery port 401 together with the second cleaning liquid LC2 that flowed into the spaces SP, SQ via the recovery ports 18.

Next, the second rinsing process (i.e., the step SC5) is started. In the present embodiment, the rinsing liquid LH is supplied to the recovery passageway 19 via the first discharge ports 21. The second rinsing process includes the same sequence of steps as that of the first rinsing process discussed above. The explanation of the second rinsing process is omitted. The second rinsing process eliminates the second cleaning liquid LC2 remaining on at least part of the surfaces of the liquid immersion member 3.

When the supply of the rinsing liquid LH via the first discharge ports 21 is stopped and the second rinsing process ends, the rinsing liquid LH is discharged from the spaces SP, SQ via the recovery port 401.

Furthermore, in the second cleaning process, too, the fluid discharge operation via the second discharge ports 22 may be performed. For example, the fluid (i.e., the fluid containing the rinsing liquid LH or the gas G, or both) may be discharged from the recovery passageway 19 via the second discharge ports 22 in parallel with at least part of the operation of supplying the rinsing liquid LH via the first discharge ports 21.

Furthermore, in the second cleaning process, too, the discharge (i.e., the recovery) of the rinsing liquid LH present in the recovery passageway 19 may be performed via the first discharge ports 21 by the operation of the first discharge apparatus 24. For example, the rinsing liquid LH may be discharged (i.e., recovered) from the recovery passageway 19 via the first discharge ports 21 after the supply of the rinsing liquid LH is stopped. In such a case, at least some of the rinsing liquid LH may be discharged from the spaces SP, SQ via the recovery ports 18 and then via the first discharge ports 21.

Furthermore, when the second rinsing process is to be started, the supply of the rinsing liquid LH may be started in the state wherein the second cleaning liquid LC2 remains in at least part of the recovery passageway 19 and the spaces SP, SQ.

The control apparatus 4 starts the third rinsing process (i.e., the step SC6) in the state wherein the liquid immersion member 3 and the dummy substrate DP are opposed. As shown in FIG. 9, the third rinsing process includes the operation of supplying the rinsing liquid LH (i.e., the exposure liquid LQ) via the supply ports 17 of the liquid immersion member 3 in the state wherein the dummy substrate DP is disposed such that it opposes the liquid immersion member 3, and the operation of recovering, in parallel with the operation of supplying, the rinsing liquid LH via the recovery ports 18. In addition, the third rinsing process includes the discharging of the rinsing liquid LH via the first discharge ports 21 or the second discharge ports 22, or both. In the present embodiment, the majority of the rinsing liquid LH is discharged via the first discharge ports 21. Thereby, at least part of the liquid immersion member 3 is rinsed.

Furthermore, during at least part of the third rinsing process, the size of the rinsing liquid LH formed above the dummy substrate DP (i.e., the area of the surface of the dummy substrate DP covered by the rinsing liquid LH) may be varied by controlling the amount of the rinsing liquid LH supplied via the supply ports 17 or the amount of the rinsing liquid LH recovered via the recovery ports 18 (i.e., the first discharge ports 21 or the second discharge ports 22, or both), or both.

Furthermore, in the third rinsing process, at least some of the rinsing liquid LH may be recovered via the recovery port 401.

Furthermore, during at least part of the first cleaning process, the first rinsing process, the second cleaning process, the second rinsing process, or the third rinsing process, or any combination thereof, the dummy substrate DP may be moved within the XY plane by controlling the substrate stage 2P in the state wherein the immersion space is formed between the last optical element 8 and the liquid immersion member 3 on one side and the dummy substrate DP on the other side; furthermore, the dummy substrate DP does not have to be moved.

Furthermore, during at least part of the first cleaning process, the first rinsing process, the second cleaning process, the second rinsing process, or the third rinsing process, or any combination thereof, if the substrate stage 2P is moved, then the range of movement of the dummy substrate DP (i.e., the substrate stage 2P) with respect to the liquid immersion member 3 may be controlled such that the immersion space is formed only above the dummy substrate DP and the liquid in the immersion space does not contact the upper surface 2PF on the outer side of the dummy substrate DP; furthermore, the dummy substrate DP (i.e., the substrate stage 2P) may be moved such that the liquid does contact the upper surface 2PF.

The above step completes the cleaning sequence. After the cleaning sequence has ended, the exposure sequence discussed above, for example, may be started.

According to the present embodiment as explained above, the liquid immersion member 3, which contacts the exposure liquid LQ, can be cleaned satisfactorily. Accordingly, it is possible to prevent exposure failures from occurring and defective devices from being produced.

In addition, according to the present embodiment, at least part of the surfaces of the liquid immersion member 3—including the lower surface 14 of the liquid immersion member 3, the surfaces (i.e., the upper surface 28A, the lower surface 28B, or the inner surfaces of the holes 28H, or any combination thereof) of the first member 28, the inner surface of the recovery passageway 19, and the surfaces (i.e., the upper surfaces 27A, the lower surfaces 27B, or the inner surfaces of the holes 27H, or any combination thereof) of the second members 27—can be cleaned satisfactorily. In addition, the passageways connected to the liquid immersion member 3 can be cleaned.

Furthermore, in the present embodiment, it is given that the first cleaning liquid LC1, the second cleaning liquid LC2, and the rinsing liquid LH are supplied to the recovery passageway 19 via the first discharge ports 21, which face the recovery passageway 19; however, a supply port that faces the recovery passageway 19 and is different from the first discharge ports 21 and the second discharge ports 22 may be provided to the liquid immersion member 3, and the first cleaning liquid LC1, the second cleaning liquid LC2, or the rinsing liquid LH, or any combination thereof, may be supplied to the recovery passageway 19 via that supply port.

Furthermore, in the present embodiment, a liquid recovery port other than the recovery ports 18 may be provided to the liquid immersion member 3 such that the liquid recovery port faces the space SP, and the liquid (i.e., the first cleaning liquid LC1, the second cleaning liquid LC2, or the rinsing liquid LH, or any combination thereof) that is supplied to the recovery passageway 19 via the first discharge ports 21 (or the second discharge ports 22) and flows to the space SP via the recovery ports 18 may be recovered via that liquid recovery port. In that case, the recovery member 400, which is different from the liquid immersion member 3, may be omitted, or may be used in parallel therewith.

In addition, in the present embodiment, the first discharge ports 21 may be capable of supplying the gas to the recovery passageway 19.

Furthermore, in the present embodiment, as in the third rinsing process, the first rinsing process may include a process that supplies the rinsing liquid LH (i.e., the exposure liquid LQ) via the supply ports 17.

Furthermore, in the present embodiment, the second rinsing process may be omitted and the third rinsing process may be performed.

Furthermore, during the first cleaning process, the first rinsing process, the second cleaning process, the second rinsing process, or the third rinsing process, or any combination thereof, the fluid discharge operation via the second discharge ports 22 may be performed such that the height of the surface (i.e., the level) of the liquid (i.e., the first cleaning liquid LC1, the second cleaning liquid LC2, or the rinsing liquid LH, or any combination thereof) in the recovery passageway 19 is maximized. In so doing, the liquid inside the recovery passageway 19 contacts substantially all of the surfaces of the second members 27 as well as an extensive area of the inner surface of the recovery passageway 19, which makes it possible to effectively perform cleaning or rinsing, or both. Furthermore, the fluid discharge operation via the second discharge ports 22 may be performed such that the liquid inside the recovery passageway 19 contacts substantially the entire inner surface of the recovery passageway 19.

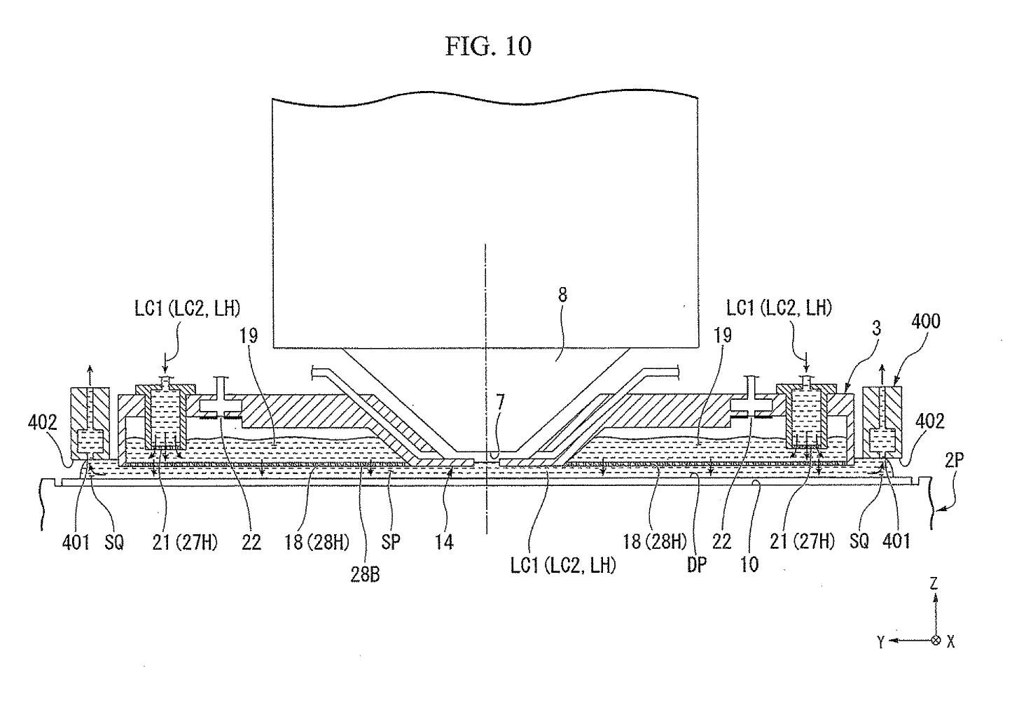

Furthermore, in the present embodiment, as shown in FIG. 10, the distance between the lower surface 402 (i.e., the recovery port 401) of the recovery member 400 and the front surface of the dummy substrate DP may be larger than the distance between the lower surface 28B of the first member 28 and the front surface of the substrate dummy DP. Namely, the lower surface 402 (i.e., the recovery port 401) of the recovery member 400 may be higher than the lower surface 28B of the first member 28. In so doing, the liquid (i.e., the first cleaning liquid LC1, the second cleaning liquid LC2, or the rinsing liquid LH, or any combination thereof) that flows from the recovery passageway 19 to the space SP spreads out above the dummy substrate DP such that this liquid contacts substantially the entire surface of the lower surface 28B of the first member 28, after which this liquid is recovered via the recovery port 401. Accordingly, the cleaning or the rinsing, or both, of the first member 28 is performed effectively. Furthermore, in FIG. 10, the lower surface 402 (i.e., the recovery port 401) is lower than the emergent surface 7 of the last optical element 8, but it may be higher. In addition, in FIG. 10, the entire lower surface 28B of the first member 28 is lower than the lower surface 402 (i.e., the recovery port 401); however, if the lower surface 28B of the first member 28 is tilted, then just part of the lower surface 28B of the first member 28 may be lower than the lower surface 402 (i.e., the recovery port 401). In addition, if the recovery member 400 is moved in the Z axial directions relative to the liquid immersion member 3, then, during at least part of the cleaning sequence, the recovery member 400 may be moved in the Z axial directions such that at least part of the lower surface 28B of the first member 28 is lower than (i.e., disposed on the −Z side of) the lower surface 402 (i.e., the recovery port 401).

### Second Embodiment

A second embodiment will now be explained. In the explanation below, constituent parts that are identical or equivalent to those in the embodiment discussed above are assigned identical symbols, and the explanations thereof are therefore abbreviated or omitted.

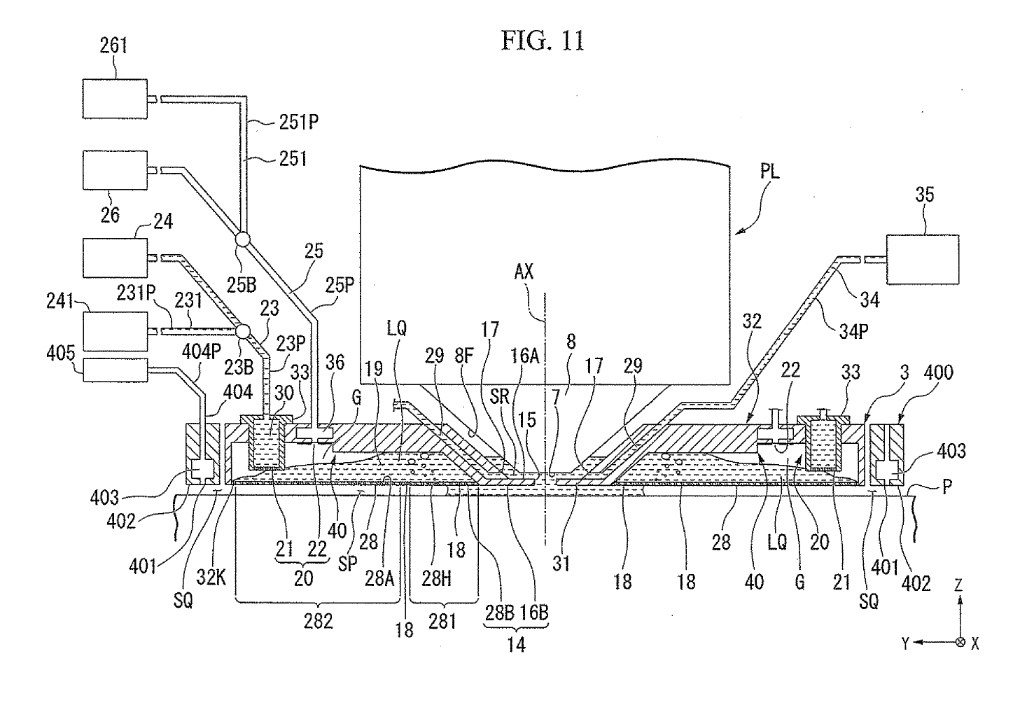

FIG. 11 shows part of the exposure apparatus EX according to the second embodiment. In the present embodiment, as shown in FIG. 11, the second discharge ports 22 are capable of supplying the liquid to the recovery passageway 19.

In FIG. 11, a supply apparatus 261, which is capable of supplying a liquid, is connected to the passageway 25 via a passageway 251, which is formed by a piping member 251P. The passageway 251 is connected to the passageway 25 via a passageway switching mechanism 25B, which comprises, for example, a valve mechanism. The supply apparatus 261 is capable of supplying the liquid to the second discharge ports 22 via the passageway 251 and the passageway 25. The second discharge ports 22 are capable of supplying the liquid from the supply apparatus 261 to the recovery passageway 19. When the liquid is being discharged from the recovery passageway 19 via the second discharge ports 22, the control apparatus 4 controls the passageway switching mechanism 25B such that the second discharge ports 22 are connected via the passageway 25 to the second discharge apparatus 26 and not to the supply apparatus 261. In the state wherein the second discharge ports 22 and the second discharge apparatus 26 are connected via the passageway 25 by the passageway switching mechanism 25B, the fluid is discharged from the recovery passageway 19 via the second discharge ports 22 by the operation of the second discharge apparatus 26. Moreover, when the liquid is being supplied to the recovery passageway 19 via the second discharge ports 22, the control apparatus 4 controls the passageway switching mechanism 25B such that the second discharge ports 22 are connected to the supply apparatus 261 via the passageway 25 and the passageway 251 and not to the second discharge apparatus 26. In the state wherein the passageway switching mechanism 25B connects the second discharge ports 22 and the supply apparatus 261 via the passageway 25 and the passageway 251, the liquid is supplied to the recovery passageway 19 via the second discharge ports 22 by the operation of the supply apparatus 261.

In the present embodiment, the liquid that is capable of being supplied via the second discharge ports 22 includes at least one of the following liquids: the cleaning liquids LC (LC1, LC2), which are for cleaning, for example, at least some of the members of the exposure apparatus EX; and the rinsing liquid LH, which is for eliminating any of the cleaning liquids LC that remain on those members. For example, the supply of the liquid via the second discharge ports 22 may be performed in parallel with at least part of the supply of the liquid via the first discharge ports 21. In that case, the liquid supplied via the first discharge ports 21 and the liquid supplied via the second discharge ports 22 may be of the same type or of different types.

Furthermore, in the present embodiment, an oscillator may be disposed in the piping member 25P (or the piping member 251P). The liquid, whereto the ultrasonic waves generated by the operation of the oscillator have been imparted, may be supplied to the recovery passageway 19 via the second discharge ports 22.

Furthermore, in the present embodiment, if the liquid is not supplied via the first discharge ports 21, then the supply apparatus 241 can be omitted.

Furthermore, in the present embodiment, a configuration may be adopted such that the gas can be supplied via the second discharge ports 22. For example, the flow (i.e., the discharge) from the recovery passageway 19 to the space SP may be promoted by supplying the gas via the second discharge ports 22 in parallel with supplying the liquid via the first discharge ports 21.

Furthermore, in the present embodiment, one or more of the liquids, namely, the first cleaning liquid LC1, the second cleaning liquid LC2, or the rinsing liquid LH (e.g., the first cleaning liquid LC1 and the second cleaning liquid LC2), may be supplied via one of the kinds of ports, namely, the first discharge ports 21 or the second discharge ports 22, and the remainder (e.g., the rinsing liquid LH) may be supplied via the other kind of ports.

In addition, in the first and second embodiments, the first cleaning process, the first rinsing process, the second cleaning process, the second rinsing process, or the third rinsing process, or any combination thereof, may be performed without using the recovery member 400. For example, the supply of the liquid may be stopped midway during each of the processes, and the liquid may be recovered from the space above the dummy substrate DP via the recovery ports 18 after a prescribed time has elapsed.

In addition, in the first and second embodiments, the recovery member 400 does not have to be provided if the first cleaning process, the first rinsing process, the second cleaning process, the second rinsing process, and the third rinsing process are performed without using the recovery member 400.

### Third Embodiment

A third embodiment will now be explained. In the explanation below, constituent parts that are identical or equivalent to those in the embodiments discussed above are assigned identical symbols, and the explanations thereof are therefore abbreviated or omitted.

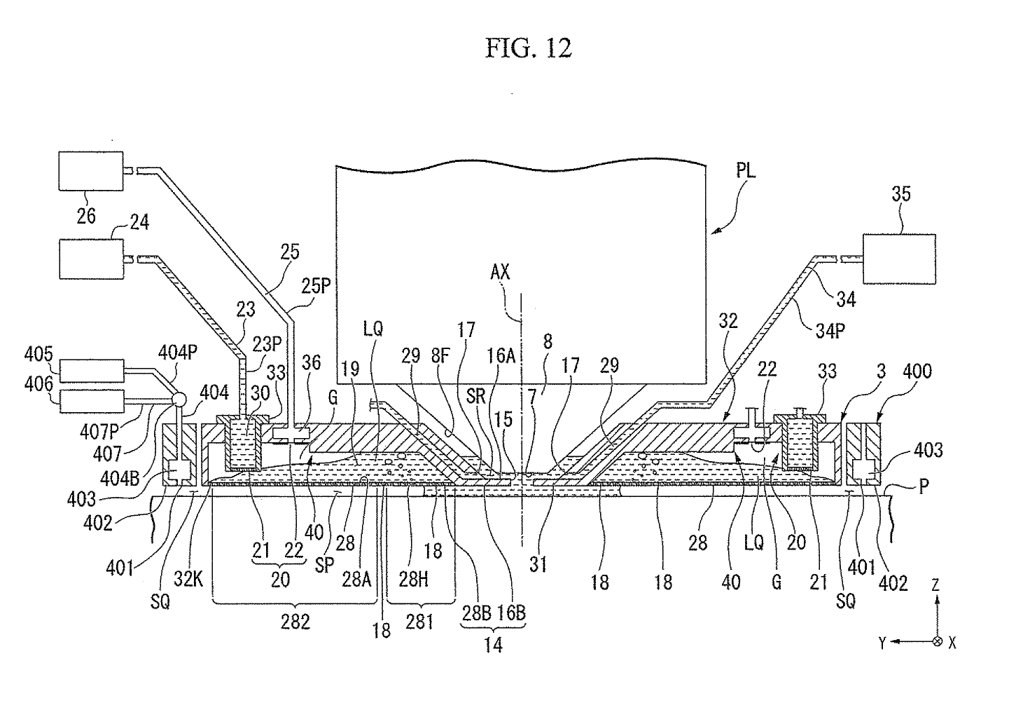

FIG. 12 is a partial view of the exposure apparatus EX according to the third embodiment. In the present embodiment, the recovery port 401 of the recovery member 400 is capable of supplying the liquid (i.e., the first cleaning liquid LC1, the second cleaning liquid LC2, or the rinsing liquid LH, or any combination thereof) to the recovery passageway 19.

In the present embodiment, the recovery port 401 is capable of supplying the liquid to the space SQ, which the recovery port 401 faces. Namely, in the present embodiment, the recovery port 401 can function as a liquid supply port that is capable of supplying the liquid.

In the present embodiment, a supply apparatus 406, which is capable of supplying the liquid, is connected to the passageway 404 via a passageway 407, which is formed by a piping member 407P. The passageway 407 is connected to the passageway 404 via a passageway switching mechanism 404B, which comprises, for example, a valve mechanism. The supply apparatus 406 is capable of supplying the liquid to the recovery port 401 via the passageway 407 and the passageway 404. The recovery port 401 is capable of supplying the liquid from the supply apparatus 406 to the space SQ. When the liquid is being recovered from the space above the object via the recovery port 401, the control apparatus 4 controls the passageway switching mechanism 404B such that the recovery port 401 is connected via the passageway 404 to the recovery apparatus 405 and not to the supply apparatus 406. In the state wherein the recovery port 401 and the recovery apparatus 405 are connected via the passageway 404 by the passageway switching mechanism 404B, the fluid (i.e., a fluid containing the liquid or the gas, or both) is recovered from the space SQ via the recovery port 401 by the operation of the recovery apparatus 405. Moreover, when the liquid is being supplied to the space SQ via the recovery port 401, the control apparatus 4 controls the passageway switching mechanism 404B such that the recovery port 401 is connected to the supply apparatus 406 via the passageway 404 and the passageway 407 and not to the recovery apparatus 405. In the state wherein the passageway switching mechanism 404B connects the recovery port 401 and the supply apparatus 406 via the passageway 404 and the passageway 407, the liquid is supplied to the space above the object via the recovery port 401 by the operation of the supply apparatus 406.

Furthermore, in the present embodiment, the recovery port 401 is capable of supplying the gas to the space SQ. Namely, in the present embodiment, the recovery port 401 functions as a gas supply port that is capable of supplying the gas. In addition, the supply apparatus 406 may be capable of supplying not only the liquid but also the gas. The supply apparatus 406 may be capable of supplying the gas to the recovery port 401 via the passageway 407 and the passageway 404.

In the present embodiment, the liquid that is capable of being supplied via the recovery port 401 includes at least one of the following liquids: the cleaning liquids LC (LC1, LC2) and the rinsing liquid LH. In the present embodiment, the supply apparatus 406 is capable of delivering the first cleaning liquid LC1, the second cleaning liquid LC2, and the rinsing liquid LH. Furthermore, a supply apparatus that supplies the cleaning liquids LC and a supply apparatus that supplies the rinsing liquid LH may be separately provided. In addition, a supply apparatus that supplies the first cleaning liquid LC1 and a supply apparatus that supplies the second cleaning liquid LC2 may be separately provided.

In the present embodiment, during the cleaning sequence, the liquid (i.e., the first cleaning liquid LC1, the second cleaning liquid LC2, or the rinsing liquid LH, or any combination thereof) is supplied via the recovery port 401, which is disposed at a position that is farther from the optical path K than the recovery ports 18 (i.e., the recovery passageway 19) are. In other words, the liquid is supplied via the recovery port 401, which is disposed on the outer side of the recovery ports 18 (i.e., the recovery passageway 19) in the radial directions with respect to the optical path K.

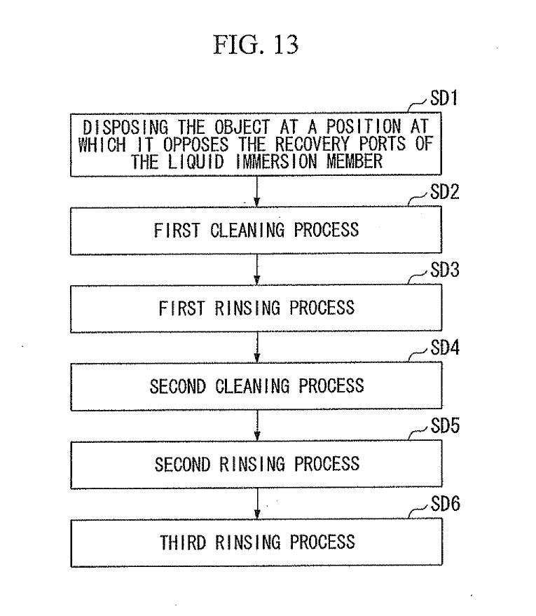

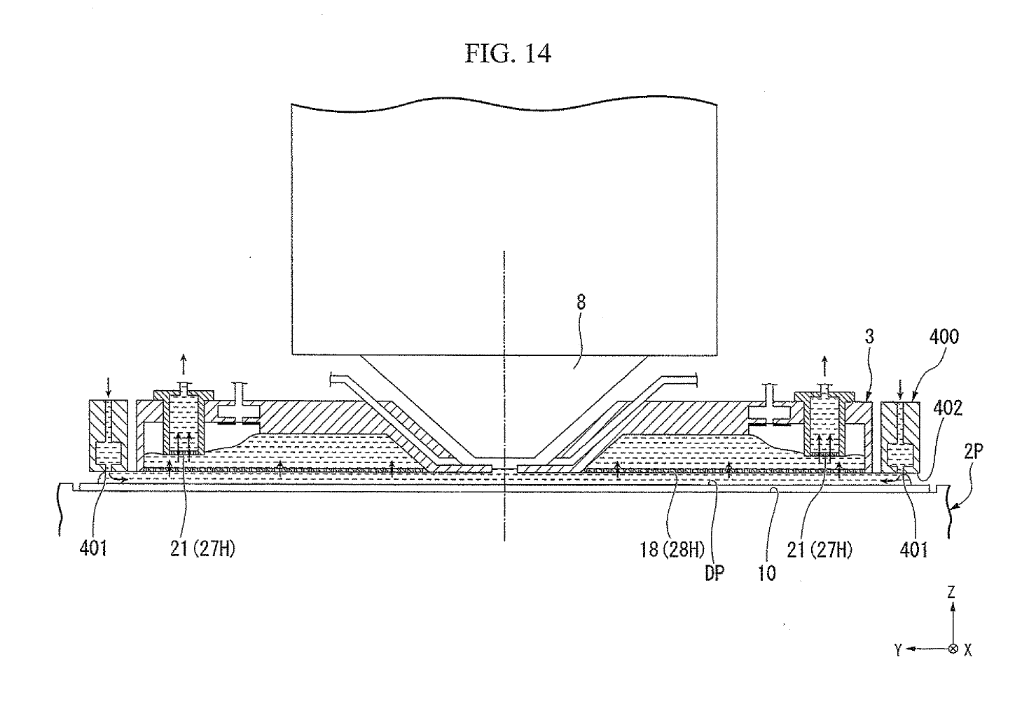

FIG. 13 is a flow chart that shows one example of the cleaning sequence according to the third embodiment, and FIG. 14 is a schematic drawing that shows one example of the cleaning sequence according to the present embodiment.

In the cleaning sequence, first, the dummy substrate DP held by the substrate holding part 10 is disposed at a position at which it opposes the recovery ports 18 of the liquid immersion member 3 (i.e., a step SD1).

Next, the first cleaning process is started (i.e., a step SD2). As shown in FIG. 14, in the present embodiment, the first cleaning liquid LC1 is supplied via the recovery port 401, which belongs to the recovery member 400. The first cleaning liquid LC1 supplied via the recovery port 401 of the recovery member 400 is supplied to the recovery passageway 19 via the recovery ports 18.

In the first cleaning process, the control apparatus 4 delivers the first cleaning liquid LC1 from the supply apparatus 406. The control apparatus 4 controls the passageway switching mechanism 404B such that the first cleaning liquid LC1 delivered from the supply apparatus 406 is supplied to the recovery port 401. Thereby, the first cleaning liquid LC1 delivered from the supply apparatus 406 is supplied to the recovery port 401 via the passageway 407 and the passageway 404. The recovery port 401, which is disposed such that it faces the space SQ, supplies to the space SQ the first cleaning liquid LC1 that was delivered from the supply apparatus 406.

At least some of the first cleaning liquid LC1 supplied to the space SQ via the recovery port 401 flows to the space SP between the lower surface 14 of the liquid immersion member 3 and the upper surface of the dummy substrate DP. The first cleaning liquid LC1 supplied via the recovery port 401 is held between the liquid immersion member 3 and the recovery member 400 on one side and the dummy substrate DP on the other side. The immersion space is formed in the spaces SP, SQ with the first cleaning liquid LC1. The first cleaning liquid LC1 held between the liquid immersion member 3 and the recovery member 400 on one side and the dummy substrate DP on the other side contacts at least part of the lower surface 14 of the liquid immersion member 3 and the lower surface 402 of the recovery member 400.

The control apparatus 4 negatively pressurizes the recovery passageway 19. The control apparatus 4 negatively pressurizes the recovery passageway 19 in the state wherein the first cleaning liquid LC1 is present in the space SP. The control apparatus 4 discharges the fluid from the recovery passageway 19 via the second discharge ports 22 by operating the second discharge apparatus 26. The second discharge ports 22 discharge at least the gas G from the recovery passageway 19. Thereby, the pressure in the recovery passageway 19 decreases to a pressure lower than the pressure (e.g., atmospheric pressure) in the space SP, which the lower surface 14 of the liquid immersion member 3 faces.

In the present embodiment, the first cleaning liquid LC1 is supplied via the recovery port 401 of the recovery member 400 in the state wherein the recovery passageway 19 has been negatively pressurized. The first cleaning liquid LC1 in the space SP that was supplied via the recovery port 401 and that contacts the first member 28 of the liquid immersion member 3 flows into the recovery passageway 19 via the recovery ports 18 (i.e., the holes 28H). Thereby, the second cleaning liquid LC2 in the space SP that was supplied via the recovery port 401 is supplied via the recovery ports 18 from the space SP, which the recovery ports 18 face, to the recovery passageway 19.

In the present embodiment, when the first cleaning liquid LC1 is being supplied to the spaces SQ, SP via the recovery port 401, the operation of recovering the first cleaning liquid LC1 via the recovery ports 18 is performed. When the first cleaning liquid LC1 is supplied to the spaces SQ, SP via the recovery port 401 and is present in the space SP, which the recovery ports 18 face, the discharge operation via the first discharge ports 21 and the second discharge ports 22 is performed, and thereby the recovery passageway 19 is negatively pressurized.

Namely, in the present embodiment, the recovery of the first cleaning liquid LC1 via the recovery ports 18 is performed in parallel with the supply of the first cleaning liquid LC1 to the spaces SQ, SP via the recovery port 401. Thereby, the immersion space of the first cleaning liquid LC1 is formed between the liquid immersion member 3 and the recovery member 400 on one side and the dummy substrate DP on the other side. The first cleaning liquid LC1 contacts at least part of the lower surface 14 of the liquid immersion member 3 and the lower surface 402 of the recovery member 400. At least part of the lower surface 14 and the lower surface 402 is cleaned by the first cleaning liquid LC1.

At least some of the first cleaning liquid LC1 contacts at least part of the surfaces of the first member 28. Namely, the first cleaning liquid LC1 contacts at least part of the upper surface 28A, the inner surfaces of the holes 28H, and the lower surface 28B of the first member 28. Thereby, the first member 28 is cleaned by the first cleaning liquid LC1.

In addition, at least some of the first cleaning liquid LC1 contacts the inner surface of the recovery passageway 19. Thereby, at least part of the inner surface of the recovery passageway 19 is cleaned by the first cleaning liquid LC1.

In addition, at least some of the first cleaning liquid LC1 contacts at least part of the surfaces of the second members 27. Namely, the first cleaning liquid LC1 contacts at least part of the upper surfaces 27A, the inner surfaces of the holes 27H, and the lower surfaces 27B of the second members 27. Thereby, the second members 27 are cleaned by the first cleaning liquid LC1.

In the present embodiment, the control apparatus 4 performs the fluid discharge operation (i.e., a fluid recovery operation) via the first discharge ports 21 in parallel with at least part of the fluid discharge operation via the second discharge ports 22. Namely, the control apparatus 4 operates both the first discharge apparatus 24 and the second discharge apparatus 26. Thereby, at least some of the first cleaning liquid LC1 supplied to the recovery passageway 19 via the recovery ports 18 is discharged (i.e., recovered) via the first discharge ports 21. In the present embodiment, substantially all of the first cleaning liquid LC1 that flows into the recovery passageway 19 is discharged via the first discharge ports 21. Furthermore, at least some of the second cleaning liquid LC2 may be discharged (i.e., recovered) from the recovery passageway 19 via the second discharge ports 22.

The first cleaning liquid LC1 discharged via the first discharge ports 21 is recovered via a member that constitutes at least part of the exposure apparatus EX, for example, the passageway 23 and the like.

After the supply of the first cleaning liquid LC1 via the recovery port 401 and the recovery of the first cleaning liquid LC1 via the recovery ports 18 have been performed for the prescribed time, the supply of the first cleaning liquid LC1 via the recovery port 401 is stopped and the recovery of the first cleaning liquid LC1 via the first discharge ports 21 or the second discharge ports 22, or both, is performed. Furthermore, after the supply of the first cleaning liquid LC1 via the recovery port 401 is stopped, at least some of the first cleaning liquid LC1 may be recovered from the recovery passageway 19 and the spaces SP, SQ via the recovery port 401. Thereby, the first cleaning process (i.e., the step SD2) ends. Furthermore, the first cleaning process may end in the state wherein the first cleaning liquid LC1 remains in at least part of the recovery passageway 19 and the spaces SP, SQ.

Furthermore, in the first cleaning process, the supply of the first cleaning liquid LC1 may be started in the state wherein the exposure liquid LQ remains in at least part of the recovery passageway 19 and the spaces SP, SQ.

Next, the first rinsing process (i.e., a step SD3) is started. The first rinsing process includes the supplying of the rinsing liquid LH to the recovery passageway 19. In the present embodiment, the supply of the rinsing liquid LH is started after the first cleaning liquid LC1 has been recovered from the recovery passageway 19 and the spaces SP, SQ. Furthermore, the supply of the rinsing liquid LH may be started in the state wherein at least some of the first cleaning liquid LC1 remains in the spaces SP, SQ.

In the present embodiment, the rinsing liquid LH is supplied via the recovery port 401, which belongs to the recovery member 400. The rinsing liquid LH supplied via the recovery port 401 is supplied to the recovery passageway 19 via the recovery ports 18.

The immersion space in the space SP is formed with the rinsing liquid LH by continuing to supply the rinsing liquid LH via the recovery port 401 and thereby supplying the rinsing liquid LH to the space SP. The rinsing liquid LH is held between the liquid immersion member 3 and the recovery member 400 on one side and the dummy substrate DP on the other side. The rinsing liquid LH held between the liquid immersion member 3 and the recovery member 400 on one side and the dummy substrate DP on the other side contacts at least part of the lower surface 14 of the liquid immersion member 3 and the lower surface 402 of the recovery member 400.

The control apparatus 4 negatively pressurizes the recovery passageway 19. The control apparatus 4 discharges the fluid from the recovery passageway 19 via the second discharge ports 22 by operating the second discharge apparatus 26. The second discharge ports 22 discharge at least the gas G from the recovery passageway 19. Thereby, the pressure in the recovery passageway 19 decreases to a pressure lower than the pressure (e.g., atmospheric pressure) in the space SP, which the lower surface 14 of the liquid immersion member 3 faces.

In the present embodiment, the rinsing liquid LH is supplied via the recovery port 401 in the state wherein the recovery passageway 19 has been negatively pressurized. The rinsing liquid LH in the space SP that was supplied via the recovery port 401 and that contacts the first member 28 of the liquid immersion member 3 flows into the recovery passageway 19 via the recovery ports 18. Thereby, the rinsing liquid LH that was supplied via the recovery port 401 is supplied via the recovery ports 18 to the recovery passageway 19.

At least some of the rinsing liquid LH contacts at least part of the surfaces of the first member 28. Namely, the rinsing liquid LH contacts at least part of the upper surface 28A, the inner surfaces of the holes 28H, and the lower surface 28B of the first member 28. Thereby, at least some of the first cleaning liquid LC1 remaining on the surfaces of the first member 28 is eliminated by the rinsing liquid LH.

In addition, at least some of the rinsing liquid LH contacts the inner surface of the recovery passageway 19. Thereby, at least some of the first cleaning liquid LC1 remaining on the inner surface of the recovery passageway 19 is eliminated by the rinsing liquid LH.

In addition, at least some of the rinsing liquid LH contacts at least part of the surfaces of the second members 27. Namely, the rinsing liquid LH contacts at least part of the upper surfaces 27A, the inner surfaces of the holes 27H, and the lower surfaces 27B of the second members 27. Thereby, at least some of the first cleaning liquid LC1 remaining on the surfaces of the second members 27 is eliminated by the rinsing liquid LH.

In the present embodiment, the control apparatus 4 performs the fluid discharge operation (i.e., the fluid recovery operation) via the first discharge ports 21 in parallel with at least part of the fluid discharge operation via the second discharge ports 22. Namely, the control apparatus 4 operates both the first discharge apparatus 24 and the second discharge apparatus 26. Thereby, at least some of the rinsing liquid LH that flows into the recovery passageway 19 via the recovery ports 18 is discharged (i.e., recovered) via the first discharge ports 21. In the present embodiment, substantially all of the rinsing liquid LH that flows into the recovery passageway 19 is discharged via the first discharge ports 21. Furthermore, at least some of the rinsing liquid LH may be discharged (i.e., recovered) from the recovery passageway 19 via the second discharge ports 22.

The rinsing liquid LH discharged via the first discharge ports 21 is recovered via a member that constitutes at least part of the exposure apparatus EX, for example, the passageway 23 and the like.

After the supply and recovery of the rinsing liquid LH have been performed for the prescribed time, the supply of the rinsing liquid LH via the recovery port 401 is stopped and the recovery of the rinsing liquid LH via the first discharge ports 21 or the second discharge ports 22, or both, is performed. Furthermore, after the supply of the rinsing liquid LH via the recovery port 401 is stopped, the rinsing liquid LH may be recovered from the recovery passageway 19 and the spaces SP, SQ via the recovery port 401. Thereby, the first rinsing process (i.e., the step SD3) ends. Furthermore, the first rinsing process may end in the state wherein the rinsing liquid LH remains in at least part of the recovery passageway 19 and the spaces SP, SQ.

Next, the second cleaning process (i.e., a step SD4) is started. The second cleaning process includes the supplying of the second cleaning liquid LC2 to the recovery passageway 19. In the present embodiment, the second cleaning liquid LC2 is supplied via the recovery port 401, which belongs to the recovery member 400. The second cleaning liquid LC2 supplied via the recovery port 401 of the recovery member 400 is supplied to the recovery passageway 19 via the recovery ports 18.

In the present embodiment, the second cleaning process (i.e., the step SD4) is performed in the same manner as the first cleaning process (i.e., the step SD2), and therefore a detailed explanation thereof is omitted.

In the second cleaning process, at least some of the second cleaning liquid LC2 contacts at least part of the surfaces of the first member 28. Namely, the second cleaning liquid LC2 contacts at least part of the upper surface 28A, the inner surfaces of the holes 28H, and the lower surface 28B of the first member 28. Thereby, the first member 28 is cleaned by the second cleaning liquid LC2.

In addition, in the second cleaning process, at least some of the second cleaning liquid LC2 contacts the inner surface of the recovery passageway 19. Thereby, at least part of the inner surface of the recovery passageway 19 is cleaned by the second cleaning liquid LC2.

In addition, in the second cleaning process, at least some of the second cleaning liquid LC2 contacts at least part of the surfaces of the second members 27. Namely, the second cleaning liquid LC2 contacts at least part of the upper surfaces 27A, the inner surfaces of the holes 27H, and the lower surfaces 27B of the second members 27, Thereby, the second members 27 are cleaned by the second cleaning liquid LC2.

After the supply and the recovery of the second cleaning liquid LC2 have been performed for the prescribed time, the second cleaning process (i.e., the step SD4) ends.

Next, the second rinsing process (i.e., a step SD5) is started. In the present embodiment, the rinsing liquid LH is supplied via the recovery port 401 of the recovery member 400, and that rinsing liquid LH is supplied to the recovery passageway 19 via the recovery ports 18. The second rinsing process includes the same sequence of steps as that of the first rinsing process discussed above. The explanation of the second rinsing process is omitted. The second rinsing process eliminates the second cleaning liquid LC2 remaining on at least part of the surfaces of the liquid immersion member 3.

Namely, at least some of the second cleaning liquid LC2 remaining on the surfaces of the first member 28 is eliminated by the rinsing liquid LH. In addition, at least some of the second cleaning liquid LC2 remaining on the inner surface of the recovery passageway 19 is eliminated by the rinsing liquid LH. In addition, at least some of the second cleaning liquid LC2 remaining on the surfaces of the second members 27 is eliminated by the rinsing liquid LH.

After the supply and the recovery of the rinsing liquid LH have been performed for the prescribed time, the second rinsing process (i.e., the step SD5) ends.

Furthermore, when the liquid is being supplied to the recovery passageway 19 via the recovery port 401 and the recovery ports 18 during the first cleaning process (i.e., the step SD2), the first rinsing process (i.e., the step SD3), the second cleaning process (i.e., the step SD4), or the second rinsing process (i.e., the step SD5), or any combination thereof, the fluid discharge operation may be performed by either just the first discharge ports 21 or just the second discharge ports 22.

In addition, the liquid does not have to be discharged from either the first discharge ports 21 or the second discharge ports 22 during the first cleaning process (i.e., the step SD2), the first rinsing process (i.e., the step SD3), the second cleaning process (i.e., the step SD4), or the second rinsing process (i.e., the step SD5), or any combination thereof. For example, the gas pressure in the recovery passageway 19 may be reduced by discharging the gas G from the recovery passageway 19 via the second discharge ports 22, the liquid may be supplied from the space SP to the recovery passageway 19, and, after a prescribed time has elapsed, the liquid may be discharged from the recovery passageway 19 to the space SP and recovered via the recovery port 401. In this case, a configuration may be adopted that promotes the supply of the gas via the second discharge ports 22 and the discharge of the liquid from the recovery passageway 19 to the space SP.

In addition, during the first cleaning process (i.e. the step SD2), the first rinsing process (i.e., the step SD3), the second cleaning process (i.e., the step SD4), or the second rinsing process (i.e., the step SD5), or any combination thereof, the recovery passageway 19 does not have to be negatively pressurized as long as the liquid supplied via the recovery port 401 can be supplied to the recovery passageway 19 via the recovery ports 18.

After the second rinsing process has ended, the control apparatus 4 starts the third rinsing process in the state wherein the liquid immersion member 3 and the dummy substrate DP are opposed (i.e., a step SD6). The third rinsing process includes the same sequence of steps as in the third rinsing process (i.e., the step SC6) explained in the first embodiment discussed above, and an explanation thereof is therefore omitted.

Furthermore, during at least part of the third rinsing process, the size of the rinsing liquid LH formed above the dummy substrate DP (i.e., the area of the surface of the dummy substrate DP covered by the rinsing liquid LH) may be varied by controlling the amount of the rinsing liquid LH supplied via the supply ports 17 or the amount of the rinsing liquid LH recovered via the recovery ports 18 (i.e., the first discharge ports 21 or the second discharge ports 22, or both), or both.

In addition, in the third rinsing process, at least some of the rinsing liquid LH may be recovered via the recovery port 401.

In addition, during at least part of the first cleaning process, the first rinsing process, the second cleaning process, the second rinsing process, or the third rinsing process, or any combination thereof, the dummy substrate DP may be moved within the XY plane by controlling the substrate stage 2P in the state wherein the immersion space is formed between the last optical element 8 and the liquid immersion member 3 on one side and the dummy substrate DP on the other side; furthermore, the dummy substrate DP does not have to be moved.

In addition, the recovery member 400 may be provided integrally with the liquid immersion member 3. In addition, the liquid immersion member 3 may have the recovery port 401.

The above step completes the cleaning sequence. After the cleaning sequence has ended, the exposure sequence discussed above, for example, may be started.

In the present embodiment, too, as explained above, the liquid immersion member 3 can be cleaned satisfactorily. Accordingly, it is possible to prevent exposure failures from occurring and defective devices from being produced.

In addition, in the present embodiment, too, at least part of the surfaces of the liquid immersion member 3—including the lower surface 14 of the liquid immersion member 3, the surfaces (i.e., the upper surface 28A, the lower surface 28B, or the inner surfaces of the holes 28H, or any combination thereof) of the first member 28, the inner surface of the recovery passageway 19, and the surfaces (i.e., the upper surfaces 27A, the lower surfaces 27B, or the inner surfaces of the holes 27H, or any combination thereof) of the second members 27—can be cleaned satisfactorily.

Furthermore, in the third embodiment, as in the first embodiment, the supply apparatus 241 is provided, and the first cleaning liquid LC1, the second cleaning liquid LC2, or the rinsing liquid LH, or any combination thereof, may be supplied via the first discharge ports 21. If the liquid is supplied via the first discharge ports 21, then that liquid may be recovered via the recovery port 401.

Furthermore, in the present embodiment, as in the second embodiment, the supply apparatus 261 is provided, and the first cleaning liquid LC1, the second cleaning liquid LC2, or the rinsing liquid LH, or any combination thereof, may be supplied via the second discharge ports 22. If the liquid is supplied via the second discharge ports 22, then that liquid may be recovered via the recovery port 401.

Furthermore, in the present embodiment, as in the third rinsing process, the first rinsing process may be performed with the rinsing liquid LH (i.e., the exposure liquid LQ) via the supply ports 17. In addition, in the present embodiment, the second rinsing process may be omitted and the third rinsing process may be performed instead. In addition, in the present embodiment, during the first rinsing process or the second rinsing process, or both, the rinsing liquid LH (i.e., the exposure liquid LQ) may be supplied via the supply ports 17 in parallel with the supply of the rinsing liquid LH via the recovery port 401.

### Fourth Embodiment

A fourth embodiment will now be explained. In the explanation below, constituent parts that are identical or equivalent to those in the embodiments discussed above are assigned identical symbols, and the explanations thereof are therefore abbreviated or omitted.

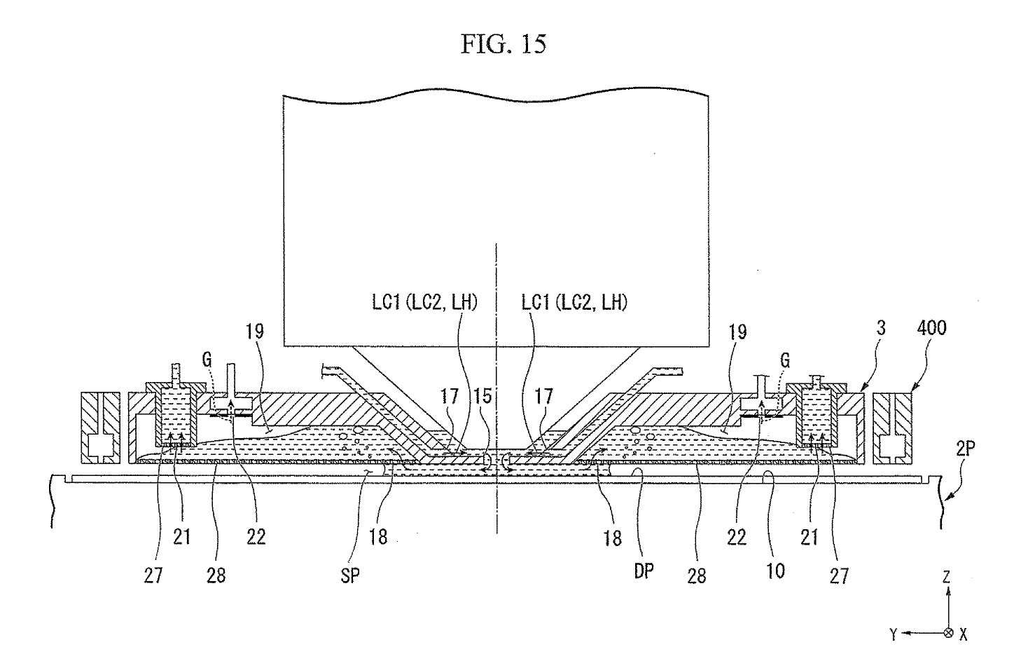

FIG. 15 is a schematic drawing that shows one example of the cleaning sequence according to the fourth embodiment. In the fourth embodiment, the first cleaning liquid LC1, the second cleaning liquid LC2, or the rinsing liquid LH, or any combination thereof, is supplied to the recovery passageway 19 via the supply ports 17 of the liquid immersion member 3, which supply the exposure liquid LQ during the exposure sequence.

Namely, in the present embodiment, during the cleaning sequence, the liquid (i.e., the first cleaning liquid LC1, the second cleaning liquid LC2, or the rinsing liquid LH, or any combination thereof) is supplied via the supply ports 17, which are disposed at positions that are nearer the optical path K than the recovery ports 18 (i.e., the recovery passageway 19) are. In other words, the liquid is supplied via the recovery port 401, which is disposed on the inner side of the recovery ports 18 (i.e., the recovery passageway 19) in the radial directions with respect to the optical path K.

For example, in first cleaning process, the first cleaning liquid LC1 is supplied via the supply ports 17. The first cleaning liquid LC1 supplied to the space SR via the supply ports 17 flows to the space SP via the opening 15. Thereby, as shown in FIG. 15, the first cleaning liquid LC1 is held between the liquid immersion member 3 and the dummy substrate DP.

At least some of the first cleaning liquid LC1 is recovered from the space SP via the recovery ports 18. The first cleaning liquid LC1 recovered via the recovery ports 18 flows through the recovery passageway 19. Thus, in the present embodiment, the first cleaning liquid LC1 is supplied to the recovery passageway 19 via the supply ports 17 and then via the space SP, which the recovery ports 18 face, and the recovery ports 18. Thereby, for example, the first member 28, the inner surface of the recovery passageway 19, or the second members 27, or any combination thereof, is cleaned by the first cleaning liquid LC1.

Likewise, the second cleaning liquid LC2 may be supplied via the supply ports 17 in the second cleaning process, and the rinsing liquid LH may be supplied via the supply ports 17 in the rinsing process. The liquid (i.e., the second cleaning liquid LC2 or the rinsing liquid LH, or both) supplied via the supply ports 17 is supplied to the recovery passageway 19 via the space SP and the recovery ports 18.

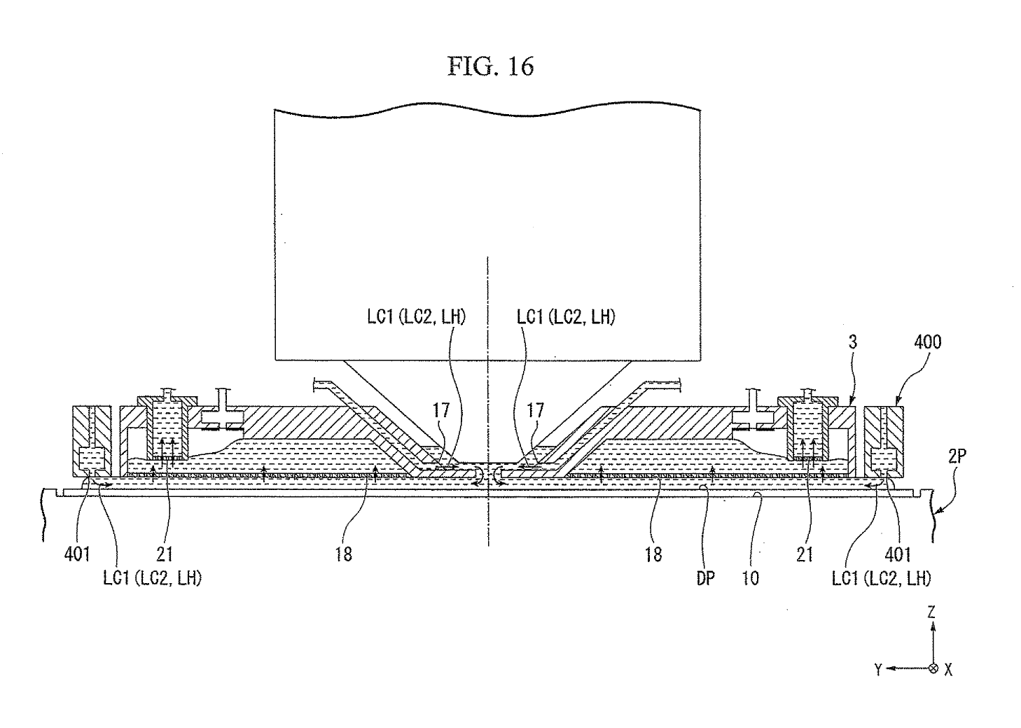

Furthermore, as shown in FIG. 16, the liquid (i.e., the first cleaning liquid LC1, the second cleaning liquid LC2, or the rinsing liquid LH, or any combination thereof) may be supplied via the supply ports 17 as well as the recovery port 401. By recovering the liquid via the recovery ports 18 in parallel with supplying that liquid via the supply ports 17 and the recovery port 401, at least some of the liquid supplied via the supply ports 17 and the recovery port 401 is supplied to the recovery passageway 19 via the space SP and the recovery ports 18.

Furthermore, for example, when the first cleaning liquid LC1 is being supplied via the supply ports 17 and the recovery port 401, the type of the first cleaning liquid LC1 supplied via the supply ports 17 and the type of the first cleaning liquid LC1 supplied via the recovery port 401 may be the same or different.

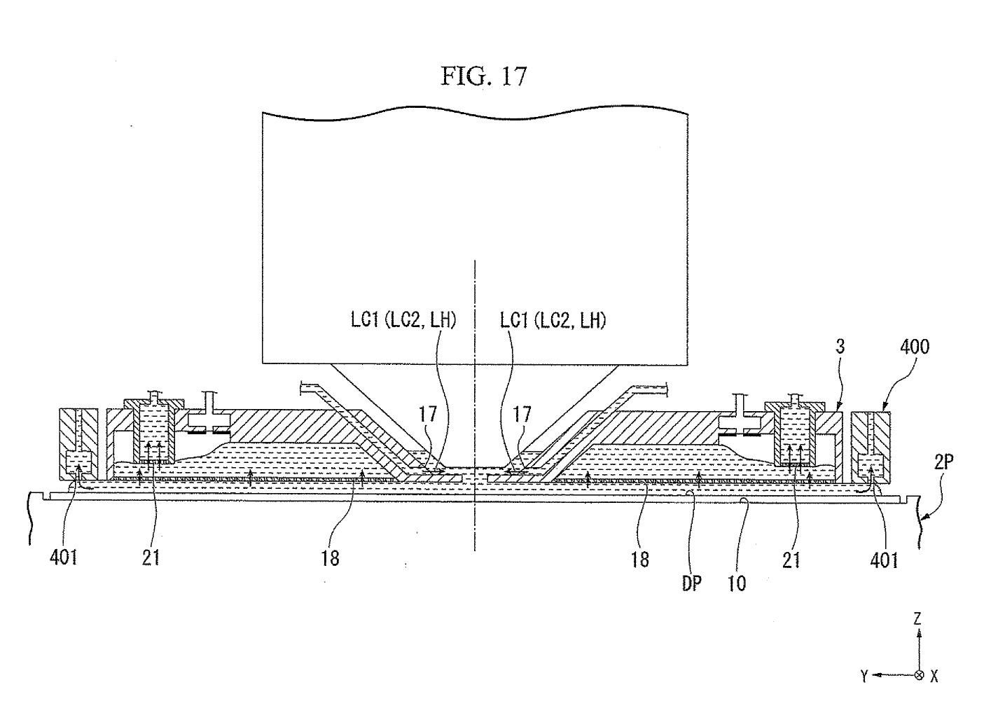

Furthermore, as shown in FIG. 17, the liquid (i.e., the first cleaning liquid LC1, the second cleaning liquid LC2, or the rinsing liquid LH, or any combination thereof) supplied via the supply ports 17 may be recovered via the recovery ports 18 and the recovery port 401.

Furthermore, in the embodiments shown in FIG. 15, FIG. 16, and FIG. 17, as in the first embodiment, the supply apparatus 241 is provided, and the first cleaning liquid LC1, the second cleaning liquid LC2, or the rinsing liquid LH, or any combination thereof, may be supplied via the first discharge ports 21. If the liquid is supplied via the first discharge ports 21, then that liquid may be recovered via the recovery port 401.

Furthermore, in the embodiments shown in FIG. 15, FIG. 16, and FIG. 17, as in the second embodiment, the supply apparatus 261 is provided, and the first cleaning liquid LC1, the second cleaning liquid LC2, or the rinsing liquid LH, or any combination thereof, may be supplied via the second discharge ports 22. If the liquid is supplied via the second discharge ports 22, then that liquid may be recovered via the recovery port 401.

Furthermore, in the first through fourth embodiments discussed above, the cleaning sequence is performed in the state wherein the recovery ports 18 and the dummy substrate DP are opposed; however, the second cleaning process or any one of the first through third rinsing processes, or any combination thereof, may be performed using a dummy substrate other than the dummy substrate DP used in the first cleaning process.

In addition, in the first through fourth embodiments discussed above, the cleaning sequence is performed in the state wherein the recovery ports 18 and the dummy substrate DP are opposed; however, for example, at least part of the cleaning sequence may be performed in the state wherein the recovery ports 18 and the upper surface 2PF of the substrate stage 2P are opposed; furthermore, at least part of the cleaning sequence may be performed in the state wherein the recovery ports 18 and the upper surface 2CF of the measurement stage 2C are opposed.

### Fifth Embodiment

A fifth embodiment will now be explained. In the explanation below, constituent parts that are identical or equivalent to those in the embodiments discussed above are assigned identical symbols, and the explanations thereof are therefore abbreviated or omitted.

In the embodiments discussed above, the liquid (i.e., the first cleaning liquid LC1, the second cleaning liquid LC2, or the rinsing liquid LH, or any combination thereof) supplied via the liquid supply ports (21, 22, 401, 17, etc.), which belong to the liquid immersion member 3 (or the recovery member 400), is supplied to the recovery passageway 19 in the cleaning sequence. In the fifth embodiment, at least some of the liquid supplied via liquid supply ports, which are provided to a movable member capable of moving to a position at which it opposes the recovery ports 18, is supplied to the recovery passageway 19. In the present embodiment, the movable member that is capable of moving to a position at which it opposes the recovery ports 18 may be the substrate stage 2P or the measurement stage 2C, or both. The text below explains an exemplary case wherein the movable member to which the liquid supply ports belong is the substrate stage 2P.

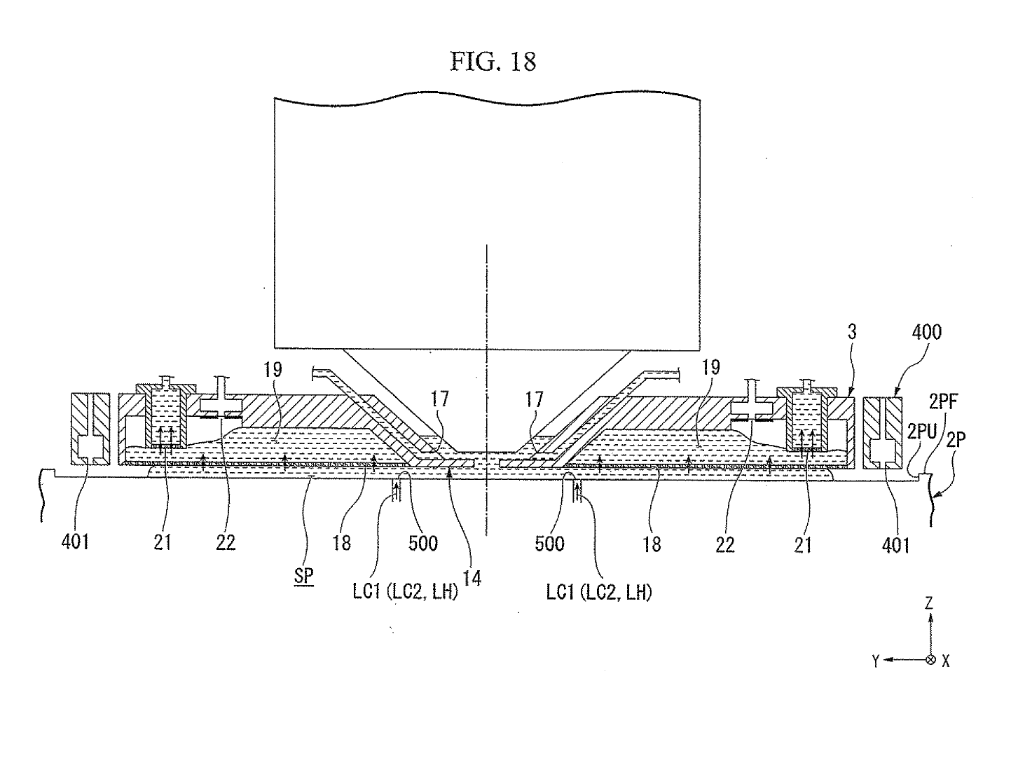

FIG. 18 is a partial schematic drawing of the exposure apparatus EX according to the fifth embodiment. In FIG. 18, at least part of the substrate stage 2P has liquid supply ports 500. In the present embodiment, the liquid supply ports 500 are disposed at least partly around the substrate holding part 10, which holds the substrate P. The liquid supply ports 500 face upward. The liquid supply ports 500 are capable of opposing the recovery ports 18. In the present embodiment, a recessed part 2PU is formed in at least part of the upper surface 2PF of the substrate stage 2P. The liquid supply ports 500 are disposed on the inner side of the recessed part 2PU. Within the XY plane, the recessed part 2PU is larger than the liquid immersion member 3. Furthermore, the upper surface 2PF does not have to have the recessed part 2PU.

For example, in the cleaning processes (i.e., the first and the second cleaning processes), the liquid supply ports 500 are disposed such that they oppose the lower surface 14 (i.e., the recovery ports 18) of the liquid immersion member 3. The control apparatus 4 supplies the cleaning liquids LC (LC1, LC2) via the liquid supply ports 500. Furthermore, the supply of the cleaning liquids LC may be started in the state wherein the exposure liquid LQ remains in the recovery passageway 19, the space SP, or the space SQ, or any combination thereof. The cleaning liquids LC supplied via the liquid supply ports 500 are held between the liquid immersion member 3 and the substrate stage 2P.

In the present embodiment, when the cleaning liquids LC are being supplied via the liquid supply ports 500, the recovery passageway 19 is negatively pressurized. Namely, in the present embodiment, the recovery of the cleaning liquids LC via the recovery ports 18 is performed in parallel with the supply of the cleaning liquids LC via the liquid supply ports 500. Thereby, at least some of the cleaning liquids LC supplied via the liquid supply ports 500 are supplied to the recovery passageway 19 via the recovery ports 18. At least some of the cleaning liquids LC that flows through the recovery passageway 19 are discharged via the first discharge ports 21. Furthermore, at least some of the cleaning liquids LC may be discharged from the recovery passageway 19 via the second discharge ports 22.

Furthermore, at least some of the cleaning liquids LC supplied via the liquid supply ports 500 may be recovered via the recovery port 401.

Furthermore, the supply of the cleaning liquids LC via the supply ports 17 may be performed in parallel with at least part of the supply of the cleaning liquids LC via the liquid supply ports 500; furthermore, the cleaning liquids LC may be supplied via the recovery port 401.

In parallel with at least part of the supply of the cleaning liquids LC via the liquid supply ports 500, the cleaning liquids LC may be supplied to the recovery passageway 19 via the first discharge ports 21, the cleaning liquids LC may be supplied via the second discharge ports 22, or the cleaning liquids LC may be supplied via a liquid discharge port, which is separate from the first and second discharge ports 21, 22 and disposed such that it faces the recovery passageway 19.

In addition, the first cleaning liquid LC1 or the second cleaning liquid LC2 may be supplied via the liquid supply ports 500 and the one not so supplied may be supplied via the supply ports 17, the recovery port 401, the first discharge ports 21, or the second discharge ports 22, or any combination thereof.

The text above explained an exemplary case wherein the cleaning liquids LC are supplied via the liquid supply ports 500. The sequence discussed above may be performed even if the rinsing liquid LH is supplied via the liquid supply ports 500. Furthermore, one or more of the liquids, namely, the first cleaning liquid LC1, the second cleaning liquid LC2, and the rinsing liquid LH (e.g., the cleaning liquids LC) may be supplied via the liquid supply ports 500, and the remainder (e.g., the rinsing liquid LH) may be supplied via the supply ports 17, the recovery port 401, the first discharge ports 21, or the second discharge ports 22, or any combination thereof.

Furthermore, in the present embodiment, the liquid supply ports 500 may be disposed in the measurement stage 2C. In addition, the liquid supply ports 500 may be disposed in the dummy substrate DP.

In addition, in the cleaning sequence of the present embodiment, the liquid supply ports 500 may move parallel to the XY plane. For example, when the liquid is being supplied via the liquid supply ports 500, the stage whereto the liquid supply ports 500 are provided may move parallel to the XY plane.

### Sixth Embodiment

A sixth embodiment will now be explained. In the explanation below, constituent parts that are identical or equivalent to those in the embodiments discussed above are assigned identical symbols, and the explanations thereof are therefore abbreviated or omitted.

In the embodiments discussed above, the liquid (i.e., the first cleaning liquid LC1, the second cleaning liquid LC2, or the rinsing liquid LH, or any combination thereof) is recovered from the recovery passageway 19 via the liquid recovery ports (21, 22, 401, etc.), which belong to the liquid immersion member 3 (or the recovery member 400), in the cleaning sequence. In the sixth embodiment, liquid recovery ports 510, which are provided to a movable member that is capable of moving to a position at which it opposes the recovery ports 18, recover the liquid from the recovery passageway 19 via the space SP. In the present embodiment, the movable member that is capable of moving to a position at which it opposes the recovery port 18 is the substrate stage 2P or the measurement stage 2C, or both. The text below explains an exemplary case wherein the movable member that has the liquid recovery ports 510 is the substrate stage 2P.

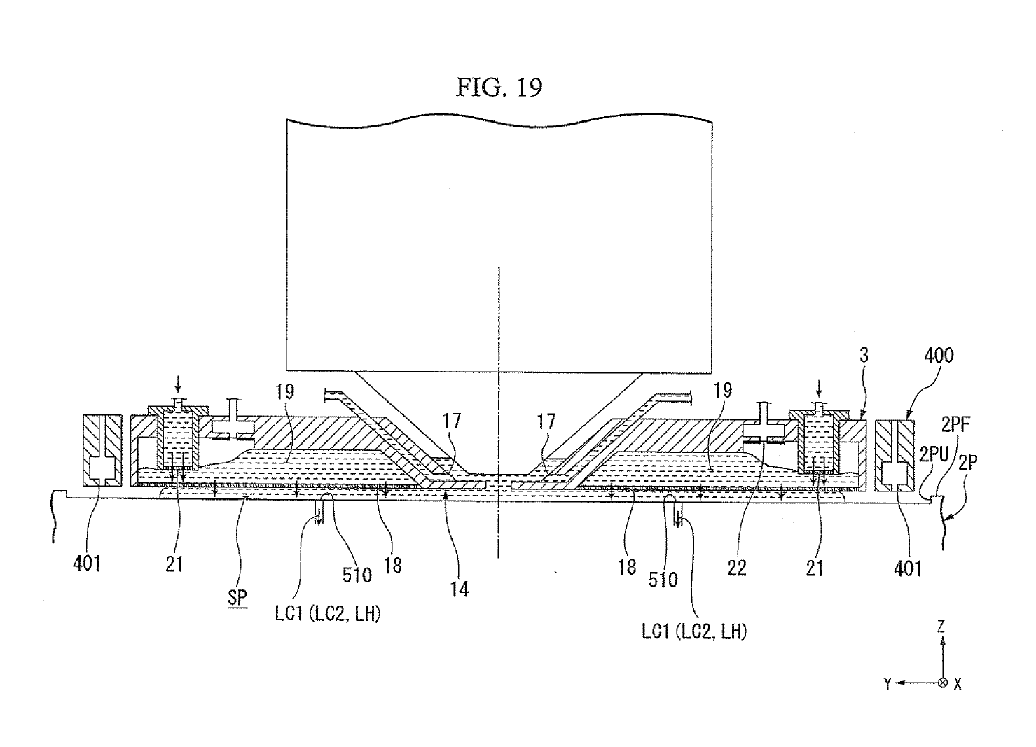

FIG. 19 is a partial schematic drawing of the exposure apparatus EX according to the sixth embodiment. In FIG. 19, at least part of the substrate stage 2P has the liquid recovery ports 510. In the present embodiment, the liquid recovery ports 510 are disposed at least partly around the substrate holding part 10, which holds the substrate P. The liquid recovery ports 510 face upward. The liquid recovery ports 510 are capable of opposing the recovery ports 18. In the present embodiment, the recessed part 2PU is formed in at least part of the upper surface 2PF of the substrate stage 2P. The liquid recovery ports 510 are disposed on the inner side of the recessed part 2PU. Within the XY plane, the recessed part 2PU is larger than the liquid immersion member 3. Furthermore, the upper surface 2PF does not have to have the recessed part 2PU.

For example, in the first cleaning process, the liquid recovery ports 510 are disposed such that they oppose the lower surface 14 (i.e., the recovery ports 18) of the liquid immersion member 3. As explained in each of the embodiments discussed above, the control apparatus 4 supplies the cleaning liquids LC (LC1, LC2) via, for example, the first discharge ports 21, the second discharge ports 22, the recovery port 401, or the supply ports 17, or any combination thereof.

In the present embodiment, the recovery of the cleaning liquids LC via the liquid recovery ports 510 is performed in parallel with the supply of the cleaning liquids LC.

Furthermore, the recovery of the cleaning liquids LC via the recovery port 401 may be performed in parallel with at least part of the recovery of the cleaning liquids LC from the space SP via the liquid recovery ports 510; furthermore, the recovery of the cleaning liquids LC may be performed via the first discharge ports 21 or the second discharge ports 22, or both.

Furthermore, the first cleaning liquid LC1 or the second cleaning liquid LC2 may be recovered via the liquid recovery ports 510 and the one not so recovered may be recovered via the recovery port 401, the first discharge ports 21, or the second discharge ports 22, or any combination thereof.

The text above explained an exemplary case wherein the cleaning liquids LC (LC1, LC2) are supplied via the liquid recovery ports 510. The sequence discussed above may be performed even if the rinsing liquid LH is recovered via the liquid recovery ports 510. Furthermore, one or more of the liquids, namely, the first cleaning liquid LC1, the second cleaning liquid LC2, and the rinsing liquid LH (e.g., the first cleaning liquid LC1 and the second cleaning liquid LC2) may be recovered via the liquid recovery ports 510, and the remainder (e.g., the rinsing liquid LH) may be recovered via the recovery port 401, the first discharge ports 21, or the second discharge ports 22, or any combination thereof.

Furthermore, in the present embodiment, the liquid recovery ports 510 may be disposed in the measurement stage 2C. In addition, the liquid recovery ports 510 may be disposed in the dummy substrate DP.

Furthermore, in the cleaning sequence of the present embodiment, the liquid recovery ports 510 may move parallel to the XY plane. For example, when the liquid is being supplied via the liquid supply ports 510, the stage whereto the liquid supply ports 510 are provided may move parallel to the XY plane.

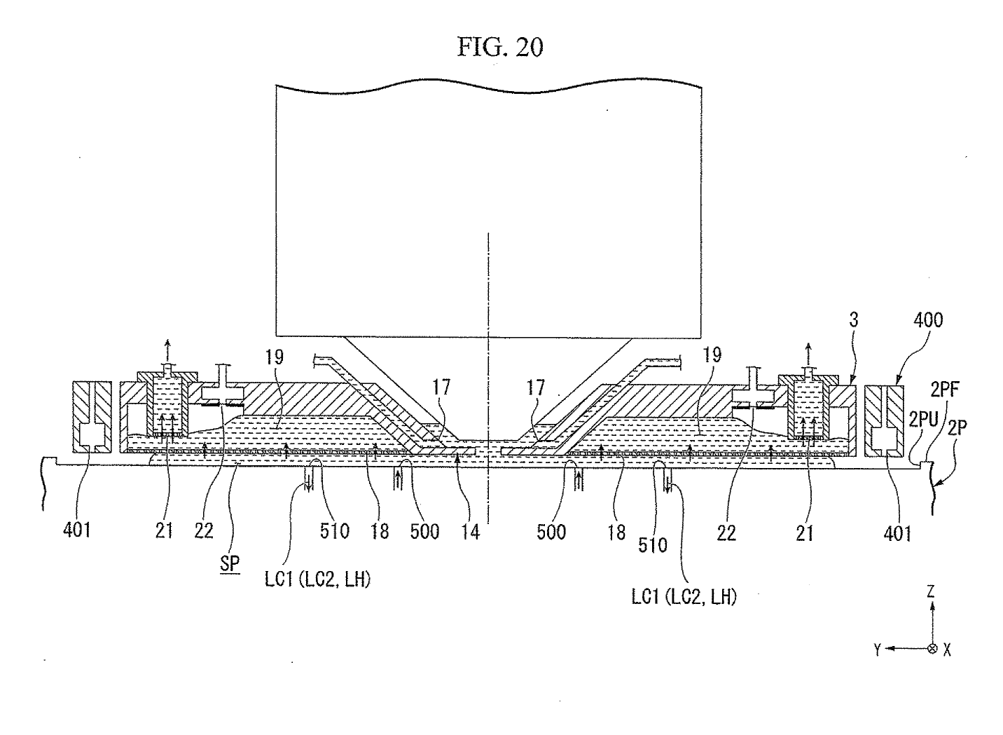

Furthermore, as shown in FIG. 20, the liquid supply ports 500 and the liquid recovery ports 510 may be disposed in the substrate stage 2P (or the measurement stage 2C). For example, the recovery of at least some of the liquid from the space SP via the recovery ports 18 together with the recovery of at least some of the liquid from the space SP via the liquid recovery ports 510 may be performed in parallel with the supply of the liquid to the space SP via the liquid supply ports 500, which are capable of supplying the first cleaning liquid LC1, the second cleaning liquid LC2, or the rinsing liquid LH, or any combination thereof. In parallel with these operations, the liquid may be supplied or recovered via the recovery port 401. In addition, in parallel with the operations discussed above, the liquid may be supplied via the supply ports 17. In addition, in parallel with the operations discussed above, the liquid may be supplied from one of the kinds of ports, namely, the first discharge ports 21 or the second discharge ports 22, and discharged from the other kind of ports.

### Seventh Embodiment

A seventh embodiment will now be explained. In the explanation below, constituent parts that are identical or equivalent to those in the embodiments discussed above are assigned identical symbols, and the explanations thereof are therefore abbreviated or omitted.

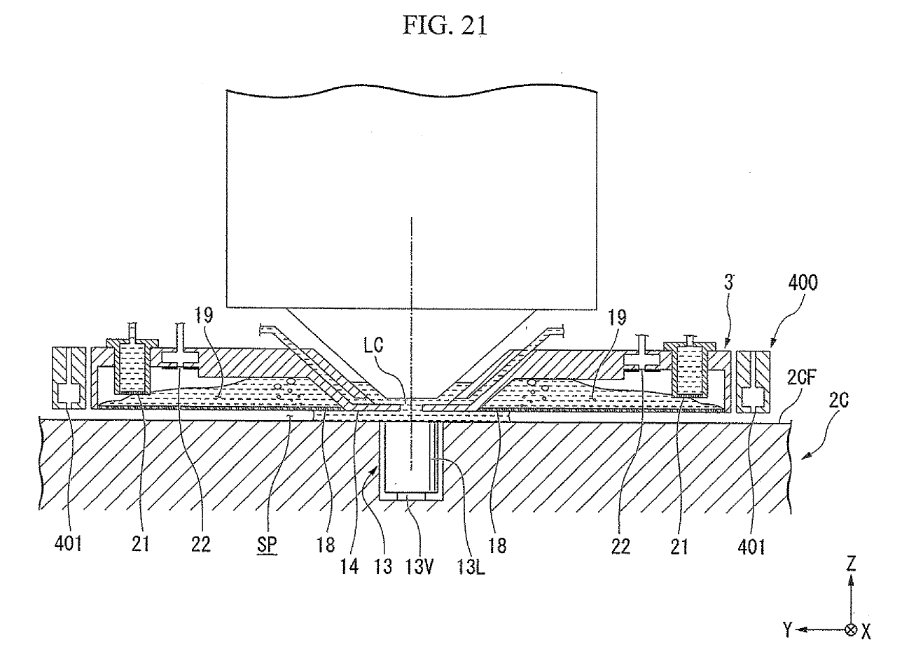

FIG. 21 is a schematic drawing that shows one example of the cleaning sequence according to the seventh embodiment. In the seventh embodiment, ultrasonic waves are imparted to the first cleaning liquid LC1, the second cleaning liquid LC2, or the rinsing liquid LH, or any combination thereof, and that liquid whereto the ultrasonic waves have been imparted is supplied to the recovery passageway 19.

As shown in FIG. 21, in the present embodiment, the ultrasonic wave generating apparatus 13 is disposed at a position at which it opposes the liquid immersion member 3. As discussed above, in the present embodiment, the ultrasonic wave generating apparatus 13 is provided to the measurement stage 2C. Furthermore, the ultrasonic wave generating apparatus 13 may be provided to the substrate stage 2P.

The ultrasonic wave generating apparatus 13 comprises a rod member 13L and an oscillator 13V, which vibrates the rod member 13L. The oscillator 13V is, for example, a piezoelectric device. The rod member 13L vibrates ultrasonically by the operation of the oscillator 13V. In the state wherein the rod member 13L contacts the liquid, the operation of the oscillator 13V imparts ultrasonic waves to that liquid that contacts the rod member 13L.

In the present embodiment, the liquid is held between the lower surface 14 of the liquid immersion member 3 and the upper surface 2CF of the measurement stage 2C, which includes the upper surface of the rod member 13L. Namely, the liquid is held in the space SP between the liquid immersion member 3 on one side and the rod member 13L and the measurement stage 2C on the other side. Furthermore, as explained in the embodiments discussed above, the liquid may be supplied to the space SP via, for example, the recovery port 401, the supply ports 17, or via the first discharge ports 21 and the recovery ports 18 (i.e., the holes 28H).

In the state wherein the liquid is held in the space SP, the oscillator 13V is operated. Thereby, ultrasonic waves are imparted to that liquid in the space SP that contacts the rod member 13L.

In the present embodiment, the liquid is recovered from the space SP via the recovery ports 18 in the state wherein the ultrasonic wave generating apparatus 13 is imparting ultrasonic waves to that liquid in the space SP. Thereby, the liquid to which the ultrasonic waves are imparted by the ultrasonic wave generating apparatus 13 is supplied to the recovery passageway 19 via the recovery ports 18.

In the present embodiment, the liquid is recovered from the space SP via the recovery ports 18 while being supplied to the space SP and while the ultrasonic wave generating apparatus 13 is imparting ultrasonic waves to that liquid in the space SR Thereby, the liquid to which ultrasonic waves are imparted is supplied from the space SP to the recovery passageway 19 via the recovery ports 18. The liquid supplied to the recovery passageway 19 is discharged, for example, via the first discharge ports 21.

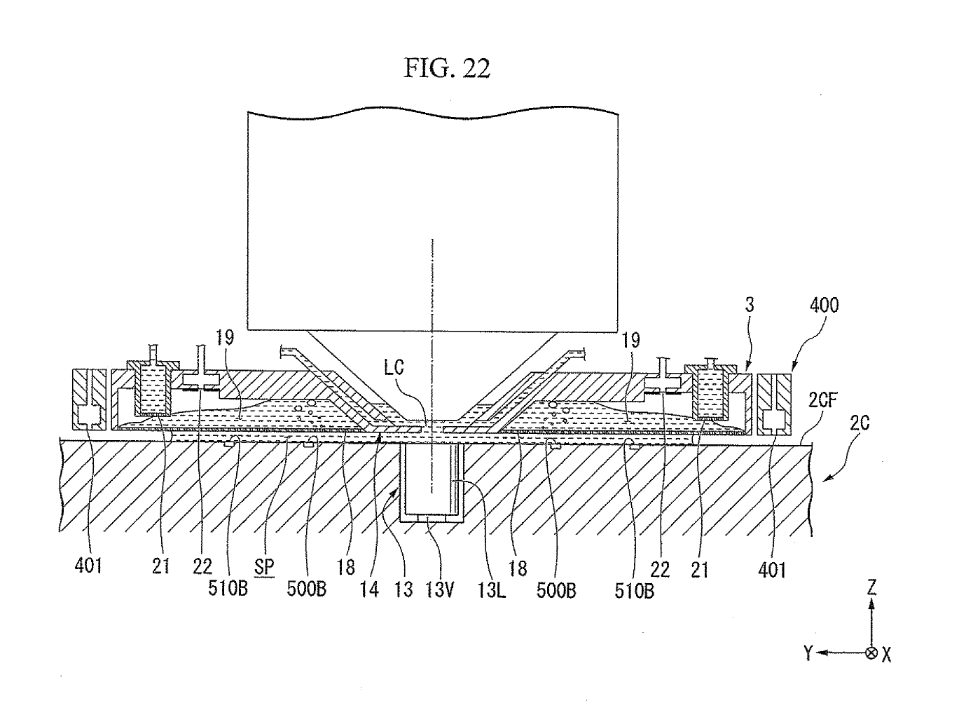

Furthermore, as shown in FIG. 22, liquid supply ports 500B, which are capable of supplying the first cleaning liquid LC1, the second cleaning liquid LC2, or the rinsing liquid LH, or any combination thereof, to the space SP may be disposed at least partly around the ultrasonic wave generating apparatus 13 (i.e., the rod member 13L), and liquid recovery ports 510B, which are capable of recovering the liquid from the space SP, may be disposed at least partly around the ultrasonic wave generating apparatus 13 (i.e., the rod member 13L). Furthermore, either just the liquid supply ports 500B or just the liquid recovery ports 510B may be disposed.

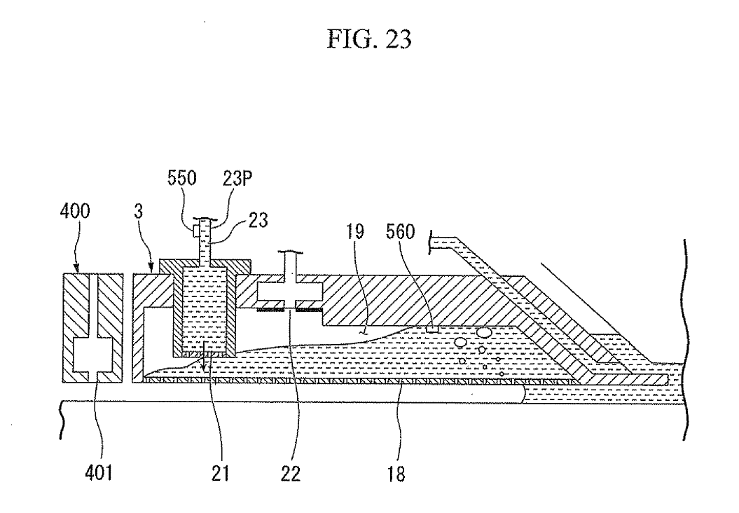

Furthermore, as shown in FIG. 23, an ultrasonic wave generating apparatus 550 that comprises an oscillator capable of generating ultrasonic vibration may be disposed, for example, in the passageway 23 (i.e., the piping member 23P). If the liquid (i.e., the first cleaning liquid LC1, the second cleaning liquid LC2, or the rinsing liquid LH, or any combination thereof) is supplied to the recovery passageway 19 via the first discharge ports 21, then the control apparatus 4 operates the ultrasonic wave generating apparatus 550. Thereby, ultrasonic waves are imparted to the liquid that is delivered from the supply apparatus 241 and flows through the passageway 23. The liquid in the passageway 23 to which ultrasonic waves are imparted by the ultrasonic wave generating apparatus 550 is supplied to the recovery passageway 19 via the first discharge ports 21.

Furthermore, as shown in FIG. 23, an ultrasonic wave generating apparatus 560, which comprises an oscillator capable of generating ultrasonic vibration, may be disposed in, for example, the recovery passageway 19. The ultrasonic wave generating apparatus 560 can impart ultrasonic waves to the liquid supplied to the recovery passageway 19 via, for example, the recovery ports 18, the recovery port 401, the first discharge ports 21, or the second discharge ports 22, or any combination thereof.

Furthermore, ultrasonic waves may be imparted by, for example, the ultrasonic wave generating apparatuses 13, 550 to the liquid supplied to the recovery passageway 19, and thereby ultrasonic waves may be imparted to the liquid supplied to the recovery passageway 19 without the ultrasonic wave generating apparatus 560 imparting ultrasonic waves.

A strong cleaning effect or a strong rinsing effect, or both, can be obtained by virtue of the cleaning liquid LC, or the rinsing liquid LH, or any combination thereof, to which the ultrasonic waves are imparted, contacting at least part of the liquid immersion member 3.

Furthermore, in the first through seventh embodiments discussed above, not all of the lower surface 14 of the liquid immersion member 3, the surfaces of the first member 28, the inner surface of the recovery passageway 19, and the surfaces of the second members 27 have to be cleaned. For example, at least part of the second members 27, which have the first discharge ports 21, do not have to be cleaned.

Furthermore, in each of the embodiments discussed above, the liquid immersion member 3 may be capable of moving with respect to the last optical element 8. For example, the liquid immersion member 3 may be capable of moving in the Z axial directions with respect to the last optical element 8. In addition, the liquid immersion member 3 may be capable of moving in the θX directions or the θY directions, or both, with respect to the last optical element 8. In other words, the liquid immersion member 3 may be capable of tilting. Of course, the liquid immersion member 3 may be capable of moving in the X axial directions, the Y axial directions, the θZ directions, or any combination thereof, with respect to the last optical element 8. Furthermore, the liquid immersion member 3 may be capable of moving by an actuator, such as a voice coil motor. In addition, the liquid immersion member 3 may be capable of moving by an elastic member that comprises, for example, a spring, or by being supported by a flexible member that comprises, for example, a bellows.

Furthermore, in each of the embodiments discussed above, the lower surface 28B of the first member 28 (i.e., the lower surface 14 of the liquid immersion member 3) and the lower surface 402 of the recovery member 400 are disposed at substantially the same position (i.e., height) in the Z axial directions; however, for example, the lower surface 402 may be disposed below (i.e., in the −Z direction of) or above (i.e., in the +Z direction of) the lower surface 28B. In other words, the distance between the lower surface 402 (i.e., the recovery port 401) of the recovery member 400 and the upper surface of the object (i.e., the front surface of the substrate P, the front surface of the dummy substrate DP, and the like) may be less than, or greater than, the distance between the lower surface 28B of the first member 28 and the upper surface of the object. In addition, if the lower surface 28B of the first member 28 is tilted, then just part of the lower surface 28B of the first member 28 may be lower than, or higher than, the lower surface 402 (i.e., the recovery port 401).

Furthermore, in the embodiments discussed above, the lower surface 402 (i.e., the recovery port 401) of the recovery member 400 is disposed below the emergent surface 7 of the last optical element 8, but it may be disposed thereabove or at substantially the same height.

Furthermore, if the emergent surface 7 is disposed above the lower surface 28B, then the lower surface 402 may be disposed between the emergent surface 7 and the lower surface 28B in the Z axial directions. In other words, the lower surface 402 may be disposed above the lower surface 28B and below the emergent surface 7.

Furthermore, in each of the embodiments discussed above, the recovery member 400 may be capable of moving with respect to the liquid immersion member 3. For example, the recovery member 400 may be capable of moving in the Z axial directions with respect to the liquid immersion member 3. In addition, the recovery member 400 may be capable of moving in the θX directions or the θY directions, or both, with respect to the liquid immersion member 3. In other words, the recovery member 400 may be capable of tilting. Of course, the recovery member 400 may be capable of moving in the X axial directions, the Y axial directions, the θZ directions, or any combination thereof, with respect to the liquid immersion member 3. Furthermore, the recovery member 400 may be capable of moving by an actuator, such as a voice coil motor. In addition, the recovery member 400 may be capable of moving by an elastic member that comprises, for example, a spring, or by being supported by a flexible member that comprises, for example, a bellows.

Furthermore, in each of the embodiments discussed above, the member (i.e., the liquid immersion member 3) that has the recovery ports 18 and the member (i.e., the recovery member 400) that has the recovery port 401 disposed at least partly around the recovery ports 18 are separate members; however, the recovery ports 18 and the recovery port 401 may be disposed in a single member (i.e., the liquid immersion member 3).

Furthermore, in each of the embodiments discussed above, the liquid immersion member 3 may be provided such that a liquid discharge port (i.e., a liquid recovery port) other than the first discharge ports 21 and the second discharge ports 22 faces the recovery passageway 19, and the liquid (i.e., the first cleaning liquid LC1, the second cleaning liquid LC2, or the rinsing liquid LH, or any combination thereof) supplied to the recovery passageway 19 may be discharged (i.e., recovered) via that liquid discharge port.

Furthermore, in each of the embodiments discussed above, the hindering part (40 and the like), which hinders contact between the second discharge ports 22 and the exposure liquid LQ, is provided, but it does not have to be provided.

Furthermore, in each of the embodiments discussed above, the cleaning sequence is performed using the first cleaning liquid LC1 and the second cleaning liquid LC2; however, the cleaning sequence may be performed using a single cleaning liquid or using three or more cleaning liquids.

Furthermore, in each of the embodiments discussed above, the rinsing processes that are performed after the cleaning processes wherein the cleaning liquids LC are used may be omitted. For example, the first rinsing process may be omitted.

Furthermore, in each of the embodiments discussed above, the third rinsing process (i.e., SC6 or SD6, or both) may be performed above the measurement stage 2C.

Furthermore, in each of the embodiments discussed above, the first member 28 comprises the first portion 281 and the second portion 282, which are provided such that their resistances to the inflow of the gas G are different; however, the first member 28 does not have to be provided with multiple portions that have different resistances to the inflow of the gas G.

Furthermore, in each of the embodiments discussed above, the upper surface 28A or the lower surface 28B, or both, of the first member 28 may be tilted with respect to the horizontal plane (i.e., the XY plane).

Furthermore, in each of the embodiments discussed above, the first discharge ports 21 or the second discharge ports 22, or both, do not have to oppose the upper surface 28A of the first member 28. For example, the first discharge ports 21 or the second discharge port 22, or both, may be disposed on the outer side of an outer side end part of the first member 28 in the radial directions with respect to the optical path K. Namely, the first discharge ports 21 or the second discharge port 22, or both, may be disposed farther from the optical path K in the radial directions with respect to the optical path K than the first member 28 is.

In addition, in each of the embodiments discussed above, too, the first discharge ports 21 may be disposed on the inner side of the second discharge ports 22 in radial directions with respect to the optical path K. Namely, the first discharge ports 21 may be nearer to the optical path K than the second discharge ports 22 are.

In addition, in each of the embodiments discussed above, the first discharge ports 21 face the −Z direction, but they may face a different direction. For example, they may face the +Z direction, or a direction parallel to the Y axial directions; furthermore, the third surfaces 27B of the second members 27 may be tilted with respect to the horizontal plane (i.e., the XY plane).

In addition, in each of the embodiments discussed above, the second discharge ports 22 face the −Z direction, but they may face a different direction. For example, they may face the +Z direction. Or they may face a direction parallel to the Y axial directions.

In addition, the direction in which the first discharge ports 21 face and the direction in which the second discharge ports 22 face may be different.

Furthermore, in each of the embodiments discussed above, the “radial directions with respect to the optical path K” may be regarded as the radial directions with respect to the optical axis AX of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and the external apparatus. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the exposure liquid LQ.

The program stored in the storage apparatus 5 may cause the control apparatus 4 to execute the following processes according to the embodiments discussed above: a process that forms the immersion space with the exposure liquid between the substrate and the liquid immersion member that has the recovery ports, which are capable of recovering at least some of the exposure liquid from the space above the substrate, the recovery passageway, wherethrough the exposure liquid recovered via the recovery ports flows, the first discharge ports, which are for discharging the exposure liquid from the recovery passageway, and the second discharge ports, which are for discharging the gas from the recovery passageway and hinder the discharge of the exposure liquid more than the first discharge ports do, such that the optical path of the exposure light between the substrate and the last optical element, wherefrom the exposure light can emerge, is filled with the exposure liquid; a process that exposes the substrate with the exposure light, which transits the exposure liquid in the immersion space; a process that recovers at least some of the exposure liquid from the space above the substrate via the recovery ports of the liquid immersion member; and a process that, when an exposure is not being performed, supplies the cleaning liquids to the recovery passageway.

In addition, the program stored in the storage apparatus 5 may cause the control apparatus 4 to execute the following processes according to the embodiments discussed above: a process that forms the immersion space with the exposure liquid between the substrate and the liquid immersion member that has the recovery ports, which are capable of recovering at least some of the exposure liquid from the space above the substrate, the recovery passageway, wherethrough the exposure liquid recovered via the recovery ports flows, the first discharge ports for discharging from the recovery passageway the fluid that includes the exposure liquid and that has a higher percentage of the exposure liquid than of the gas, and the second discharge ports for discharging from the recovery passageway the fluid that includes the gas and that has a lower percentage of the exposure liquid than of the gas, such that the optical path of the exposure light between the substrate and the last optical element, wherefrom the exposure light can emerge, is filled with the exposure liquid; a process that exposes the substrate with the exposure light, which transits the exposure liquid in the immersion space; a process that recovers at least some of the exposure liquid from the space above the substrate via the recovery ports of the liquid immersion member; and a process that, when an exposure is not being performed, supplies the cleaning liquids to the recovery passageway.

In addition, the program stored in the storage apparatus 5 may cause the control apparatus 4 to execute the following processes according to the embodiments discussed above: a process that forms the immersion space with the exposure liquid between the substrate and the liquid immersion member that has the recovery ports, which are capable of recovering at least some of the exposure liquid from the space above the substrate, the recovery passageway, wherethrough the exposure liquid recovered via the recovery ports flows, and the discharge parts, which separately discharge the exposure liquid and the gas from the recovery passageway and have the first discharge ports for discharging the exposure liquid from the recovery passageway and the second discharge ports for discharging the gas from the recovery passageway, such that the optical path of the exposure light between the substrate and the last optical element, wherefrom the exposure light can emerge, is filled with the exposure liquid; a process that exposes the substrate with the exposure light, which transits the exposure liquid in the immersion space; a process that recovers at least some of the exposure liquid from the space above the substrate via the recovery ports of the liquid immersion member; and a process that, when an exposure is not being performed, supplies the cleaning liquids to the recovery passageway.

The program stored in the storage apparatus 5 is read by the control apparatus 4, and thereby the various processes, such as the immersion exposure of the substrate P in the state wherein the immersion space LS is formed, are executed in cooperation with the various apparatuses of the exposure apparatus EX, such as the substrate stage 2P, the liquid immersion member 3, the liquid supply apparatus 35, the first discharge apparatus 24, and the second discharge apparatus 26.

Furthermore, in each of the embodiments discussed above, the optical path K on the emergent (i.e., the image plane) side of the last optical element 8 of the projection optical system PL is filled with the exposure liquid LQ; however, the projection optical system PL may be a projection optical system wherein the optical path K on the incident (i.e., the object plane) side of the last optical element 8 is also filled with the exposure liquid LQ, as disclosed in, for example, PCT International Publication No. WO2004/019128.

Furthermore, in each of the embodiments discussed above, the exposure liquid LQ is water but may be a liquid other than water. Preferably, the exposure liquid LQ is a liquid that is transparent with respect to the exposure light EL, has a high refractive index with respect to the exposure light EL, and is stable with respect to the projection optical system. PL or the film of, for example, the photosensitive material (i.e., the photoresist) that forms the front surface of the substrate P. For example, the exposure liquid LQ may be a fluorine-based liquid such as hydro-fluoro-ether (HFE), perfluorinated polyether (PFPE), or Fomblin® oil. In addition, the exposure liquid LQ may be any of various fluids, for example, a supercritical fluid.

Furthermore, the substrate P in each of the embodiments discussed above is a semiconductor wafer for fabricating semiconductor devices, but it may be, for example, a glass substrate for display devices, a ceramic wafer for thin film magnetic heads, or the original plate of a mask or a reticle (e.g., synthetic quartz or a silicon wafer) used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure apparatus EX may be, for example, a step-and-repeat type projection exposure apparatus (i.e., a stepper), which performs a full field exposure of the pattern of the mask M—with the mask M and the substrate P in a stationary state—and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system PL to transfer a reduced image of a first pattern onto the substrate P in a state wherein the first pattern and the substrate P are substantially stationary, after which the projection optical system PL is used to partially superpose a reduced image of a second pattern onto the first pattern in the state wherein the second pattern and the substrate P are substantially stationary. In addition, the stitching type exposure apparatus may be a step-and-stitch type exposure apparatus that successively transfers at least two patterns onto the substrate P such that they are partially superposed and steps the substrate P.

In addition, the exposure apparatus EX may be an exposure apparatus that combines on the substrate P the patterns of two masks through a projection optical system PL and double exposes, substantially simultaneously, a single shot region on the substrate P using a single scanning exposure, as disclosed in, for example, U.S. Pat. No. 6,611,316. In addition, the exposure apparatus EX may be a proximity type exposure apparatus, a mirror projection aligner, or the like.

Furthermore, the exposure apparatus EX does not have to comprise the measurement stage 2C.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, if the exposure apparatus EX comprises two of the substrate stages, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or any combination thereof.

In addition, the exposure apparatus EX may be an exposure apparatus that comprises a plurality of the substrate stages and the measurement stages.

The exposure apparatus EX may be a semiconductor device fabrication exposure apparatus that exposes the substrate P with the pattern of a semiconductor device, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks.

Furthermore, in each of the embodiments discussed above, the position of each of the stages is measured using the interferometer system 130, but the present invention is not limited thereto; for example, an encoder system that detects a scale (i.e., a diffraction grating) provided to each of the stages may be used, or the interferometer system 130 may be used in parallel with the encoder system.

Furthermore, in the embodiments discussed above, the optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

In each of the embodiments discussed above, the exposure apparatus EX comprises the projection optical system PL; however, the constituent elements explained in each of the embodiments discussed above may be adapted to an exposure apparatus and an exposing method that does not use the projection optical system PL. For example, the constituent elements explained in each of the embodiments discussed above may be adapted to an exposure apparatus EX and an exposing method wherein the immersion space LS is formed between the substrate P and an optical member such as a lens, and the exposure light EL is radiated to the substrate P via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the connection of mechanical components, the wiring and connection of electrical circuits, and the piping and connection of the pneumatic circuits among the various subsystems. Naturally, prior to performing the process of assembling the exposure apparatus EX from these various subsystems, there are also the processes of assembling each individual subsystem. After the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room, wherein the temperature, the cleanliness level, and the like are controlled.

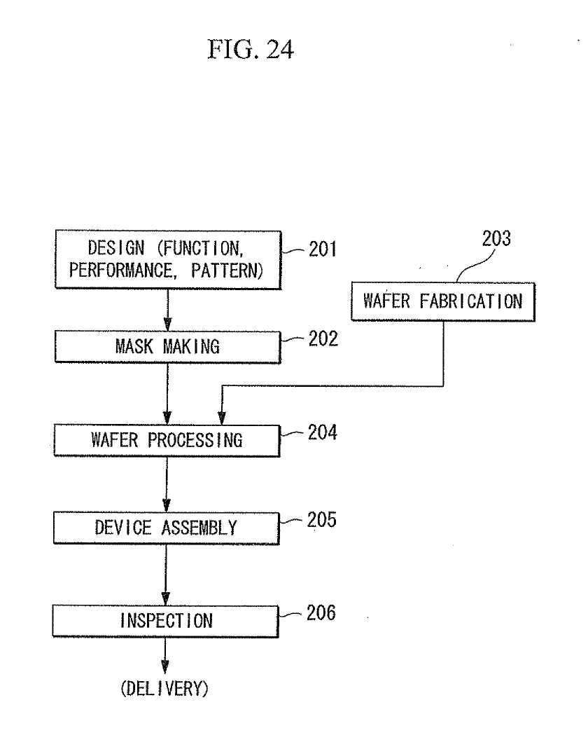

As shown in FIG. 24, a microdevice, such as a semiconductor device, is manufactured by: a step 201 that designs the functions and performance of the microdevice; a step 202 that fabricates the mask M (i.e., the reticle) based on this designing step; a step 203 that manufactures the substrate, P which is the base material of the device; a substrate processing step 204 that comprises a substrate process (i.e., an exposure process) that includes, in accordance with the embodiments discussed above, exposing the substrate P with the exposure light EL that emerges from the pattern of the mask M and developing the exposed substrate P; a device assembling step 205 (which includes fabrication processes such as dicing, bonding, and packaging processes); an inspecting step 206; and the like.

Furthermore, the features of each of the embodiments discussed above can be combined as appropriate. In addition, there are also cases wherein some of the constituent elements are not used. In addition, each disclosure of every Japanese published patent application and U.S. patent related to the exposure apparatus EX recited in each of the embodiments discussed above, the modified examples, and the like is hereby incorporated by reference in its entirety to the extent permitted by the national laws and regulations.

1. A method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, the method comprising:
supplying a cleaning liquid to a recovery passageway of the liquid immersion member, wherethrough the exposure liquid recovered via the first recovery port from a space, which the first recovery port faces, flows;
wherein,
the liquid immersion member has a first discharge port, which is for discharging the exposure liquid from the recovery passageway, and a second discharge port, which is for discharging a gas from the recovery passageway and hinders the discharge of the exposure liquid more than the first discharge port does.

2. A method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, the method comprising:
supplying a cleaning liquid to a recovery passageway of the liquid immersion member, wherethrough the exposure liquid recovered via the first recovery port from a space, which the first recovery port faces, flows;
wherein,
the liquid immersion member has a first discharge port, which is for discharging, from the recovery passageway, a fluid that includes the exposure liquid and that has a higher percentage of the exposure liquid than of a gas and a second discharge port, which is for discharging, from the recovery passageway, a fluid that includes the gas and that has a lower percentage of the exposure liquid than of the gas.

3. A method of cleaning a liquid immersion member in an immersion exposure apparatus, which exposes a substrate with exposure light which transits an exposure liquid, that has a first recovery port, which is capable of recovering the exposure liquid and that is disposed at least partly around an optical member and an optical path of the exposure light that passes through the exposure liquid between the optical member and the substrate, the method comprising:
supplying a cleaning liquid to a recovery passageway of the liquid immersion member, wherethrough the exposure liquid recovered via the first recovery port from a space, which the first recovery port faces, flows;
wherein,
the liquid immersion member comprises a discharge part, which separately discharges the exposure liquid and a gas from the recovery passageway; and
the discharge part has a first discharge port, which is for discharging the exposure liquid from the recovery passageway, and a second discharge port, which is for discharging the gas from the recovery passageway.

4. The cleaning method according to claim 1, wherein
the cleaning liquid is supplied to the recovery passageway via the first discharge port.

5. The cleaning method according to claim 1, wherein
the cleaning liquid is supplied to the recovery passageway via a supply port, which faces the recovery passageway.

6. The cleaning method according to claim 1, wherein
the cleaning liquid is supplied to the recovery passageway via the first recovery port and then via the space that the first recovery port faces.

7. The cleaning method according to claim 6, wherein
the cleaning liquid is supplied to the recovery passageway via a supply port of the liquid immersion member and then via the space and the first recovery port.

8. The cleaning method according to claim 7, wherein
during an exposure of the substrate, the exposure liquid is supplied via the supply port of the liquid immersion member.

9. The cleaning method according to claim 6, wherein
the cleaning liquid is supplied via the space in the state wherein the recovery passageway has been negatively pressurized.

10. The cleaning method according to claim 6, wherein
the immersion exposure apparatus comprises a movable member, which is capable of moving to a position at which it opposes the first recovery port; and
the cleaning liquid is supplied via a supply port, which is provided to the movable member.

11. The cleaning method according to claim 10, wherein
the movable member comprises a substrate holding part, which holds the substrate.

12. The cleaning method according to claim 10,
wherein
at least some of the cleaning liquid supplied to the recovery passageway is recovered via the space that the first recovery port faces and then via a second recovery port.

13. The cleaning method according to claim 10, wherein
the second recovery port is provided to the movable member.

14. The cleaning method according to claim 1, comprising:
recovering at least some of the cleaning liquid supplied to the recovery passageway via a second recovery port of the immersion exposure apparatus.

15. The cleaning method according to claim 14, wherein
the liquid immersion member has the second recovery port.

16. The cleaning method according to claim 14, wherein
the second recovery port is disposed such that it faces the recovery passageway.

17. The cleaning method according to claim 14, wherein
the second recovery port recovers at least some of the cleaning liquid supplied to the recovery passageway via the space that the first recovery port faces.

18. The cleaning method according to claim 17, wherein
the immersion exposure apparatus comprises a movable member, which is capable of moving to a position at which it opposes the first recovery port; and
the second recovery port is provided to the movable member.

19. The cleaning method according to claim 18, wherein
the movable member has a substrate holding part, which holds the substrate.

20. The cleaning method according to claim 1, further comprising:
recovering at least some of the cleaning liquid supplied to the recovery passageway via the first discharge port.

21. The cleaning method according to claim 1, wherein
the first discharge port includes a hole of a porous member.

22. The cleaning method according to claim 1, wherein
the first recovery port includes a hole of a porous member.

23. The cleaning method according to claim 1, comprising:
imparting ultrasonic waves to the cleaning liquid supplied to the recovery passageway.

24. The cleaning method according to claim 1, wherein
the cleaning liquid whereto the ultrasonic waves have been imparted is supplied to the recovery passageway.

25. The cleaning method according to claim 1, comprising:
cleaning a member that has the first discharge port with the cleaning liquid.

26. The cleaning method according to claim 1, wherein
at least part of the cleaning of the liquid immersion member is performed in the state wherein the first recovery port and an object are opposed.

27. A device fabricating method, comprising:
cleaning at least part of the liquid immersion member using the cleaning method according to claim 1;
exposing the substrate that transits the exposure liquid; and
developing the exposed substrate.

28. A liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, comprising:
a first recovery port, which is capable of recovering the exposure liquid;
a recovery passageway, wherethrough the exposure liquid recovered via the first recovery port from a space, which the first recovery port faces, flows;
a first discharge port, which is for discharging the exposure liquid from the recovery passageway;
a second discharge port, which is for discharging a gas from the recovery passageway and hinders the discharge of the exposure liquid more than the first discharge port does; and
a supply port, which supplies a cleaning liquid to the recovery passageway.

29. A liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, comprising:
a first recovery port, which is capable of recovering the exposure liquid;
a recovery passageway, wherethrough the exposure liquid recovered via the first recovery port from a space, which the first recovery port faces, flows;
a first discharge port, which is for discharging, from the recovery passageway, a fluid that includes the exposure liquid and that has a higher percentage of the exposure liquid than of a gas;
a second discharge port, which is for discharging, from the recovery passageway, a fluid that includes the gas and that has a lower percentage of the exposure liquid than of the gas; and
supply port, which supplies a cleaning liquid to the recovery passageway.

30. A liquid immersion member inside an immersion exposure apparatus, which exposes a substrate with exposure light which transits an exposure liquid, and that is disposed at least partly around an optical member and an optical path of exposure light that passes through the exposure liquid between the optical member and the substrate, comprising:
a first recovery port, which is capable of recovering the exposure liquid;
a recovery passageway, wherethrough the exposure liquid recovered via the first recovery port from a space, which the first recovery port faces, flows;
a discharge part, which has a first discharge port for discharging the exposure liquid from the recovery passageway and a second discharge port for discharging a gas from the recovery passageway, that separately discharges the exposure liquid and the gas from the recovery passageway; and
a supply port, which supplies a cleaning liquid to the recovery passageway.

31. The liquid immersion member according to claim 28, wherein
the supply port faces the recovery passageway.

32. The liquid immersion member according to claim 31, wherein
the supply port includes the first discharge port.

33. The liquid immersion member according to claim 28, wherein
the supply port supplies the cleaning liquid to the recovery passageway via the first recovery port and the space, which the first recovery port faces.

34. The liquid immersion member according to claim 33, wherein
the supply port is used in the supply of the exposure liquid.

35. The liquid immersion member according to claim 28, further comprising:
a second recovery port, which recovers the cleaning liquid supplied to the recovery passageway.

36. The liquid immersion member according to claim 35, wherein
the second recovery port faces the recovery passageway.

37. The liquid immersion member according to claim 35, wherein
the second recovery port recovers via the first recovery port and the space, which the first recovery port faces, the cleaning liquid supplied to the recovery passageway.

38. The liquid immersion member according to claim 28, wherein
the first discharge port includes a hole of a porous member.

39. The liquid immersion member according to claim 28, wherein
the first recovery port includes a hole of a porous member.

40. The liquid immersion member according to claim 28, comprising:
cleaning a member that has the first discharge port with the cleaning liquid.

41. An immersion exposure apparatus, which exposes a substrate with exposure light that transits an exposure liquid, comprising:
the liquid immersion member according to claim 28.

42. An immersion exposure apparatus, which exposes a substrate with exposure light that transits an exposure liquid, comprising:
an optical member, which has an emergent surface wherefrom the exposure light emerges;
a liquid immersion member that is disposed at least partly around an optical path of an exposure light which passes through the exposure liquid between the optical member and the substrate and that has a first recovery port, which is capable of recovering the exposure liquid, a recovery passageway, wherethrough the exposure liquid recovered via the first recovery port from a space that the first recovery port faces flows, a first discharge port, which is for discharging the exposure liquid from the recovery passageway, and a second discharge port, which is for discharging a gas from the recovery passageway and hinders the discharge of the exposure liquid more than the first discharge port does; and
a supply port, which supplies cleaning liquid to the recovery passageway.

43. An immersion exposure apparatus, which exposes a substrate with exposure light that transits an exposure liquid, comprising:
an optical member, which has an emergent surface wherefrom the exposure light emerges;
a liquid immersion member that is disposed at least partly around an optical path of an exposure light which passes through the exposure liquid between the optical member and the substrate and that has a first recovery port, which is capable of recovering the exposure liquid, a recovery passageway, wherethrough the exposure liquid recovered via the first recovery port from a space that the first recovery port faces flows, a first discharge port, which is for discharging, from the recovery passageway, a fluid that includes the exposure liquid and that has a higher percentage of the exposure liquid than of the gas, and a second discharge port, which is for discharging, from the recovery passageway, a fluid that includes the gas and that has a lower percentage of the exposure liquid than of the gas; and
a supply port, which supplies cleaning liquid to the recovery passageway.

44. An immersion exposure apparatus, which exposes a substrate with exposure light that transits an exposure liquid, comprising:
an optical member, which has an emergent surface wherefrom the exposure light emerges;
a liquid immersion member that is disposed at least partly around an optical path of an exposure light which passes through the exposure liquid between the optical member and the substrate and that has a first recovery port, which is capable of recovering the exposure liquid, a recovery passageway, wherethrough the exposure liquid recovered via the first recovery port from a space that the first recovery port faces flows, and a discharge part, which has a first discharge port for discharging the exposure liquid from the recovery passageway and a second discharge port for discharging a gas from the recovery passageway, that separately discharges the exposure liquid and the gas from the recovery passageway; and
a supply port, which supplies cleaning liquid to the recovery passageway.

45. The immersion exposure apparatus according to claim 42, wherein
the supply port faces the recovery passageway.

46. The immersion exposure apparatus according to claim 45, wherein
the supply port includes the first discharge port.

47. The immersion exposure apparatus according to claim 42, wherein
the supply port supplies the cleaning liquid to the recovery passageway via the first recovery port and the space, which the first recovery port faces.

48. The immersion exposure apparatus according to claim 47, wherein
the supply port is used in the supply of the exposure liquid.

49. The immersion exposure apparatus according to claim 47, further comprising:
a movable member, which is capable of moving to a position at which it opposes the first recovery port;
wherein,
the supply port is provided to the movable member.

50. The immersion exposure apparatus according to claim 49, wherein
the movable member comprises a substrate holding part, which holds the substrate.

51. The immersion exposure apparatus according to claim 49, further comprising:
a second recovery port, which recovers the cleaning liquid supplied to the recovery passageway.

52. The immersion exposure apparatus according to claim 42, further comprising:
a second recovery port, which recovers the cleaning liquid supplied to the recovery passageway.

53. The immersion exposure apparatus according to claim 52, wherein
the second recovery port faces the recovery passageway.

54. The immersion exposure apparatus according to claim 42, wherein
the second recovery port recovers the cleaning liquid supplied to the recovery passageway via the first recovery port and the space that the first recovery port faces.

55. The immersion exposure apparatus according to claim 54, further comprising:
the movable member, which is capable of moving to a position at which it opposes the first recovery port;
wherein,
the second recovery port is provided to the movable member.

56. The immersion exposure apparatus according to claim 55, wherein
the movable member has a substrate holding part, which holds the substrate.

57. The immersion exposure apparatus according to claim 42, wherein
the first discharge port includes a hole of a porous member.

58. The immersion exposure apparatus according to claim 42, wherein
the first recovery port includes a hole of a porous member.

59. The immersion exposure apparatus according to claim 42, comprising:
cleaning a member that has the first discharge port with the cleaning liquid.

60. The immersion exposure apparatus according to claim 42, further comprising:
an oscillator, which imparts ultrasonic waves to the cleaning liquid.

61. The immersion exposure apparatus according to claim 60, wherein
the oscillator imparts the ultrasonic waves to the cleaning liquid supplied to the recovery passageway.

62. The immersion exposure apparatus according to claim 60, wherein
the cleaning liquid, whereto the ultrasonic waves have been imparted by the oscillator, is supplied to the recovery passageway.

63. A device fabricating method, comprising:
exposing a substrate using the immersion exposure apparatus according to claim 41; and
developing the exposed substrate.

64. A program that causes a computer to control an immersion exposure apparatus, which exposes a substrate with exposure light that transits an exposure liquid, comprising the steps of:
forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, a first discharge port, which is for discharging the exposure liquid from the recovery passageway, and a second discharge port, which is for discharging a gas from the recovery passageway and hinders the discharge of the exposure liquid more than the first discharge port does, such that an optical path of the exposure light between the substrate and an optical member, wherefrom the exposure light can emerge, is filled with the exposure liquid;
exposing the substrate with the exposure light, which transits the exposure liquid in the immersion space;
recovering at least some of the exposure liquid from the space above the substrate via the first recovery port of the liquid immersion member; and
when an exposure is not being performed, supplying a cleaning liquid to the recovery passageway.

65. A program that causes a computer to control an immersion exposure apparatus, which exposes a substrate with exposure light that transits an exposure liquid, comprising the steps of:
forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, a first discharge port, which is for discharging, from the recovery passageway, a fluid that includes the exposure liquid and that has a higher percentage of the exposure liquid than of the gas, and a second discharge port, which is for discharging, from the recovery passageway, a fluid that includes the gas and that has a lower percentage of the exposure liquid than of the gas, such that an optical path of the exposure light between the substrate and an optical member, wherefrom the exposure light can emerge, is filled with the exposure liquid;
exposing the substrate with the exposure light, which transits the exposure liquid in the immersion space;
recovering at least some of the exposure liquid from the space above the substrate via the first recovery port of the liquid immersion member; and
when an exposure is not being performed, supplying a cleaning liquid to the recovery passageway.

66. A program that causes a computer to control an immersion exposure apparatus, which exposes a substrate with exposure light that transits an exposure liquid, comprising the steps of:
forming an immersion space with the exposure liquid between the substrate and a liquid immersion member that has a first recovery port, which is capable of recovering at least some of the exposure liquid from a space above the substrate, a recovery passageway, wherethrough the exposure liquid recovered via the first recovery port flows, and a discharge part, which has a first discharge port for discharging the exposure liquid from the recovery passageway and a second discharge port for discharging a gas from the recovery passageway, that separately discharges the exposure liquid and the gas from the recovery passageway, such that an optical path of the exposure light between the substrate and an optical member, wherefrom the exposure light can emerge, is filled with the exposure liquid;
exposing the substrate with the exposure light, which transits the exposure liquid in the immersion space;
recovering at least some of the exposure liquid from the space above the substrate via the first recovery port of the liquid immersion member; and
when an exposure is not being performed, supplying a cleaning liquid to the recovery passageway.

67. The computer readable storage medium whereon a program according to claim 64 is stored.
